(19) United States
(12) Patent Application Publication
(10) Pub. No.: US 2026/0368435 A1
(43) Pub. Date: Nov. 19, 2026

(54) Multimodal Alert Generation via Persistent Cognitive Machines Using Federated Latent Sensor Streams

(71) Applicant: AtomBeam Technologies Inc., Moraga, CA (US)

(72) Inventor: Brian Galvin, Silverdale, WA (US)

(21) Appl. No.: 19/466,222

(22) Filed: Jan. 30, 2026

Related U.S. Application Data
(63) Continuation-in-part of application No. 19/448,101, filed on Jan. 13, 2026, now Pat. No. 12,694,225.
Application No. 19/448,101 is a continuation-in-part of application No. 19/424,188, filed on Dec. 18, 2025, now Pat. No. 12,724,977.
Application No. 19/424,188 is a continuation-in-part of application No. 19/401,186, filed on Nov. 25, 2025.
Application No. 19/401,186 is a continuation-in-part of application No. 19/399,611, filed on Nov. 24, 2025.
Application No. 19/399,611 is a continuation-in-part of application No. 19/397,844, filed on Nov. 21, 2025.
Application No. 19/397,844 is a continuation-in-part of application No. 19/379,579, filed on Nov. 4, 2025.
Application No. 19/379,579 is a continuation-in-part of application No. 19/378,949, filed on Nov. 4, 2025.
Application No. 19/378,949 is a continuation-in-part of application No. 19/377,013, filed on Nov. 2, 2025.
Application No. 19/377,013 is a continuation-in-part of application No. 19/352,457, filed on Oct. 7, 2025.
Application No. 19/352,457 is a continuation-in-part of application No. 19/321,173, filed on Sep. 6, 2025, now Pat. No. 12,602,549.
Application No. 19/321,173 is a continuation-in-part of application No. 19/284,115, filed on Jul. 29, 2025.
Application No. 19/284,115 is a continuation of application No. 19/051,193, filed on Feb. 12, 2025, now Pat. No. 12,387,050.
Application No. 19/051,193 is a continuation-in-part of application No. 19/038,801, filed on Jan. 28, 2025.
Application No. 19/038,801 is a continuation of application No. 18/818,593, filed on Aug. 29, 2024, now Pat. No. 12,308,862.
Application No. 18/818,593 is a continuation-in-part of application No. 18/755,627, filed on Jun. 26, 2024, now Pat. No. 12,200,102.
Application No. 18/755,627 is a continuation-in-part of application No. 18/657,719, filed on May 7, 2024, now Pat. No. 12,166,506.
Application No. 18/657,719 is a continuation-in-part of application No. 18/423,287, filed on Jan. 25, 2024, now Pat. No. 12,218,696.
Application No. 18/423,287 is a continuation of application No. 18/501,987, filed on Nov. 4, 2023, now Pat. No. 11,967,974.
Application No. 18/501,987 is a continuation-in-part of application No. 18/190,044, filed on Mar. 24, 2023, now Pat. No. 11,831,343.
Application No. 18/190,044 is a continuation-in-part of application No. 17/875,201, filed on Jul. 27, 2022, now Pat. No. 11,700,013.
Application No. 17/875,201 is a continuation of application No. 17/514,913, filed on Oct. 29, 2021, now Pat. No. 11,424,760.
Application No. 17/514,913 is a continuation-in-part of application No. 17/404,699, filed on Aug. 17, 2021, now Pat. No. 11,385,794.
Application No. 17/875,201 is a continuation of application No. 17/458,747, filed on Aug. 27, 2021, now Pat. No. 11,422,978.
Application No. 17/458,747 is a continuation-in-part of application No. 16/923,039, filed on Jul. 7, 2020, now Pat. No. 11,232,076.
Application No. 16/923,039 is a continuation-in-part of application No. 17/727,913, filed on Apr. 25, 2022, now Pat. No. 11,620,051.
Application No. 17/727,913 is a continuation of application No. 17/404,699, filed on Aug. 17, 2021, now Pat. No. 11,385,794.
Application No. 18/657,719 is a continuation-in-part of application No. 18/410,980, filed on Jan. 11, 2024, now Pat. No. 12,068,761.
Application No. 18/410,980 is a continuation-in-part of application No. 18/537,728, filed on Dec. 12, 2023, now Pat. No. 12,058,333.
Application No. 18/818,593 is a continuation-in-part of application No. 18/657,683, filed on May 7, 2024, now Pat. No. 12,159,216.
Application No. 18/657,683 is a continuation-in-part of application No. 18/648,340, filed on Apr. 27, 2024, now Pat. No. 12,166,507.
Application No. 18/648,340 is a continuation-in-part of application No. 18/427,716, filed on Jan. 30, 2024, now Pat. No. 12,093,972.
Application No. 18/427,716 is a continuation-in-part of application No. 18/410,980, filed on Jan. 11, 2024, now Pat. No. 12,068,761.
Application No. 19/377,013 is a continuation-in-part of application No. 19/326,730, filed on Sep. 12, 2025, now Pat. No. 12,608,555.
Application No. 19/326,730 is a continuation-in-part of application No. 19/321,173, filed on Sep. 6, 2025, now Pat. No. 12,602,549.
Application No. 19/321,173 is a continuation-in-part of application No. 19/245,366, filed on Jun. 22, 2025, now Pat. No. 12,418,680.
Application No. 19/245,366 is a continuation-in-part of application No. 19/204,525, filed on May 10, 2025, now Pat. No. 12,699,883.
Application No. 19/204,525 is a continuation-in-part of application No. 19/192,215, filed on Apr. 28, 2025.
Application No. 19/192,215 is a continuation-in-part of application No. 18/972,797, filed on Dec. 6, 2024, now Pat. No. 12,294,392.
Application No. 18/972,797 is a continuation-in-part of application No. 18/648,340, filed on Apr. 27, 2024, now Pat. No. 12,166,507.
Application No. 19/378,949 is a continuation-in-part of application No. 19/328,094, filed on Sep. 12, 2025, now Pat. No. 12,632,663.
Application No. 19/328,094 is a continuation-in-part of application No. 19/321,173, filed on Sep. 6, 2025, now Pat. No. 12,602,549.
Application No. 19/379,579 is a continuation-in-part of application No. 19/363,675, filed on Oct. 21, 2025.
Application No. 19/363,675 is a continuation-in-part of application No. 19/351,286, filed on Oct. 6, 2025, now Pat. No. 12,724,976.
Application No. 19/351,286 is a continuation-in-part of application No. 19/321,173, filed on Sep. 6, 2025, now Pat. No. 12,602,549.
Application No. 19/397,844 is a continuation-in-part of application No. 19/329,330, filed on Sep. 15, 2025, now Pat. No. 12,730,975.
Application No. 19/329,330 is a continuation-in-part of application No. 19/328,094, filed on Sep. 12, 2025, now Pat. No. 12,632,663.
Application No. 19/397,844 is a continuation-in-part of application No. 19/003,258, filed on Dec. 27, 2024.
Application No. 19/003,258 is a continuation of application No. 18/822,203, filed on Sep. 1, 2024, now Pat. No. 12,229,679.
Application No. 18/822,203 is a continuation-in-part of application No. 18/427,716, filed on Jan. 30, 2024, now Pat. No. 12,093,972.
Application No. 19/399,611 is a continuation-in-part of application No. 19/315,849, filed on Sep. 1, 2025, now Pat. No. 12,572,830.
Application No. 19/315,849 is a continuation-in-part of application No. 19/294,125, filed on Aug. 7, 2025, now Pat. No. 12,579,437.
Application No. 19/294,125 is a continuation-in-part of application No. 19/203,069, filed on Jun. 3, 2025, now Pat. No. 12,481,688.
Application No. 19/203,069 is a continuation-in-part of application No. 19/205,960, filed on May 12, 2025.
Application No. 19/205,960 is a continuation-in-part of application No. 19/060,794, filed on Feb. 24, 2025.
Application No. 19/060,794 is a continuation-in-part of application No. 19/044,546, filed on Feb. 3, 2025.
Application No. 19/044,546 is a continuation-in-part of application No. 19/026,276, filed on Jan. 16, 2025.
Application No. 19/026,276 is a continuation-in-part of application No. 18/928,022, filed on Oct. 26, 2024.
Application No. 18/928,022 is a continuation-in-part of application No. 18/919,417, filed on Oct. 17, 2024, now Pat. No. 12,602,586.
Application No. 18/919,417 is a continuation-in-part of application No. 18/918,077, filed on Oct. 17, 2024.
Application No. 18/918,077 is a continuation-in-part of application No. 18/737,906, filed on Jun. 7, 2024.
Application No. 18/737,906 is a continuation-in-part of application No. 18/736,498, filed on Jun. 6, 2024.
Application No. 19/294,125 is a continuation-in-part of application No. 19/178,873, filed on Apr. 15, 2025, now Pat. No. 12,608,631.
Application No. 19/178,873 is a continuation-in-part of application No. 19/177,611, filed on Apr. 13, 2025, now Pat. No. 12,572,471.
Application No. 19/177,611 is a continuation-in-part of application No. 19/051,193, filed on Feb. 12, 2025, now Pat. No. 12,387,050.
Application No. 19/424,188 is a continuation-in-part of application No. 18/887,424, filed on Sep. 17, 2024.
Application No. 18/887,424 is a continuation of application No. 18/648,340, filed on Apr. 27, 2024, now Pat. No. 12,166,507.
Application No. 19/424,188 is a continuation-in-part of application No. 18/810,505, filed on Aug. 21, 2024.
Application No. 18/810,505 is a continuation of application No. 18/657,683, filed on May 7, 2024, now Pat. No. 12,159,216.
(60) Provisional application No. 63/027,166, filed on May 19, 2020.
(60) Provisional application No. 63/388,411, filed on Jul. 12, 2022.
(60) Provisional application No. 63/651,359, filed on May 23, 2024.
(60) Provisional application No. 63/847,082, filed on Jul. 19, 2025.
(60) Provisional application No. 63/847,091, filed on Jul. 19, 2025.
(60) Provisional application No. 63/847,096, filed on Jul. 19, 2025.
(60) Provisional application No. 63/847,101, filed on Jul. 19, 2025.
(60) Provisional application No. 63/847,969, filed on Jul. 21, 2025.
(60) Provisional application No. 63/847,889, filed on Jul. 21, 2025.

(51) Int. Cl. G06F 40/30; G06F 16/332; G06F 16/3329

(52) U.S. Cl. CPC G06F 40/30; G06F 16/3325; G06F 16/3329

(57) ABSTRACT

A system and method for multimodal alert generation and triage transforms heterogeneous sensor streams from multiple modalities into latent embeddings within a geometric manifold representation. An alert detector generates alerts based on geometric divergence of the latent embeddings from baseline patterns. A triage processor estimates mitigation success probability by fusing multiple independent probability estimates including a geometric estimate based on manifold structure, a simulation-based estimate, and a historical precedent estimate. The triage processor generates a posterior probability distribution representing uncertainty and routes alerts to different disposition pathways based on the posterior probability distribution. The system enables intelligent alert management by automatically handling high-confidence alerts, escalating moderate-confidence alerts to human operators, and prioritizing low-confidence alerts for immediate expert attention, thereby reducing operator burden while maintaining appropriate oversight for complex or uncertain situations.

### CROSS-REFERENCE TO RELATED APPLICATIONS

Priority is claimed in the application data sheet to the following patents or patent applications, each of which is expressly incorporated herein by reference in its entirety:
Ser. No. 19/448,101
Ser. No. 19/424,188
Ser. No. 19/401,186
Ser. No. 19/399,611
Ser. No. 19/397,844
Ser. No. 19/379,579
Ser. No. 19/378,949
Ser. No. 19/377,013
Ser. No. 19/352,457
Ser. No. 19/321,173
Ser. No. 19/284,115
Ser. No. 19/051,193
Ser. No. 63/847,082
Ser. No. 63/847,091
Ser. No. 63/847,096
Ser. No. 63/847,101
Ser. No. 63/847,969
Ser. No. 19/038,801
Ser. No. 18/818,593
Ser. No. 18/755,627
Ser. No. 18/657,719
Ser. No. 18/423,287
Ser. No. 18/501,987
Ser. No. 18/190,044
Ser. No. 17/875,201
Ser. No. 17/514,913
Ser. No. 17/404,699
Ser. No. 17/458,747
Ser. No. 16/923,039
Ser. No. 63/027,166
Ser. No. 63/388,411
Ser. No. 17/727,913
Ser. No. 18/410,980
Ser. No. 18/537,728
Ser. No. 18/657,683
Ser. No. 18/648,340
Ser. No. 18/427,716
Ser. No. 19/326,730
Ser. No. 63/847,889
Ser. No. 19/245,366
Ser. No. 19/204,525
Ser. No. 19/192,215
Ser. No. 18/972,797
Ser. No. 19/328,094
Ser. No. 19/363,675
Ser. No. 19/351,286
Ser. No. 19/329,330
Ser. No. 19/003,258
Ser. No. 18/822,203
Ser. No. 19/315,849
Ser. No. 19/294,125
Ser. No. 19/203,069
Ser. No. 19/205,960
Ser. No. 19/060,794
Ser. No. 19/044,546
Ser. No. 19/026,276
Ser. No. 18/928,022
Ser. No. 18/919,417
Ser. No. 18/918,077
Ser. No. 18/737,906
Ser. No. 18/736,498
Ser. No. 63/651,359
Ser. No. 19/178,873
Ser. No. 19/177,611
Ser. No. 18/929,938
Ser. No. 18/627,451
Ser. No. 18/887,424
Ser. No. 18/810,505

### BACKGROUND OF THE INVENTION

### Field of the Art

The present invention relates to the field of machine learning and artificial intelligence, particularly to systems for memory-augmented reasoning and long-term cognitive processing.

### Discussion of the State of the Art

Modern infrastructures and defense systems are saturated with heterogeneous telemetry: acoustic, optical, thermal, seismic, and cyber channels all produce high-volume, asynchronous streams. Existing monitoring architectures typically process such data in siloed pipelines, reducing them to threshold alarms or model-specific anomaly detectors. These methods fail in three critical respects.

First, they assume that anomalies are definable as fixed deviations from baseline values. In practice, novelty, adversarial deception, and environmental shifts produce conditions in which no stable baseline exists. Second, they flood human operators with low-value alerts: each modality generates its own triggers, which lack semantic fusion and often conflict. Third, they lack predictive mitigation: alerts are treated as ex post notifications rather than precursors to preventable events.

The result is operator overload, delayed response, and brittle situational awareness. Alert systems become noise generators rather than cognitive aids, undermining mission-critical decision-making in industrial, defense, and cyber domains.

What is needed is a system and method for multimodal alert generation via federated latent sensor streams within a Personal Cognitive Machine (PCM) architecture.

### SUMMARY OF THE INVENTION

Accordingly, the inventor has conceived and reduced to practice, a system and method for multimodal alert generation and triage transforms heterogeneous sensor streams from multiple modalities into latent embeddings within a geometric manifold representation. An alert detector generates alerts based on geometric divergence of the latent embeddings from baseline patterns. A triage processor estimates mitigation success probability by fusing multiple independent probability estimates including a geometric estimate based on manifold structure, a simulation-based estimate, and a historical precedent estimate. The triage processor generates a posterior probability distribution representing uncertainty and routes alerts to different disposition pathways based on the posterior probability distribution. The system enables intelligent alert management by automatically handling high-confidence alerts, escalating moderate-confidence alerts to human operators, and prioritizing low-confidence alerts for immediate expert attention, thereby reducing operator burden while maintaining appropriate oversight for complex or uncertain situations.

According to a preferred embodiment, a computing system for multimodal alert generation and triage is disclosed, comprising: a processor; a memory operatively connected to the processor; a plurality of encoders configured to transform heterogeneous sensor streams into latent embeddings within a geometric manifold representation; an alert detector operatively connected to the plurality of encoders and configured to generate alerts based on geometric divergence of the latent embeddings from baseline patterns within the geometric manifold representation; a triage processor operatively connected to the alert detector and configured to: estimate a mitigation success probability by fusing multiple independent probability estimates comprising at least a geometric estimate based on manifold structure, a simulation-based estimate, and a historical precedent estimate; generate a posterior probability distribution representing uncertainty in the mitigation success probability; and route alerts to different disposition pathways based on the posterior probability distribution.

According to another preferred embodiment, a computer-implemented method for multimodal alert generation and triage is disclosed, comprising the steps of: transforming, by a plurality of encoders, heterogeneous sensor streams into latent embeddings within a geometric manifold representation; generating, by an alert detector operatively connected to the plurality of encoders, alerts based on geometric divergence of the latent embeddings from baseline patterns within the geometric manifold representation; estimating, by a triage processor operatively connected to the alert detector, a mitigation success probability by fusing multiple independent probability estimates comprising at least a geometric estimate based on manifold structure, a simulation-based estimate, and a historical precedent estimate; generating, by the triage processor, a posterior probability distribution representing uncertainty in the mitigation success probability; and routing, by the triage processor, alerts to different disposition pathways based on the posterior probability distribution.

According to a further aspect, the method comprises heterogeneous sensor streams comprising at least two sensor modalities selected from the group consisting of: acoustic sensors, optical sensors, thermal sensors, seismic sensors, vibration sensors, and cyber sensors.

According to a further aspect, the method comprises computing, by each encoder, a quality-of-evidence score for the latent embedding based on at least one of reconstruction error, signal-to-noise ratio, and temporal consistency.

According to a further aspect, the method comprises generating alerts comprising computing the geometric divergence as a geodesic distance between a trajectory of the latent embeddings and a nearest baseline attractor.

According to a further aspect, the method comprises computing the geometric estimate based on policy-aligned geodesic distance, path curvature penalty, and compression cost within the geometric manifold representation.

According to a further aspect, the method comprises generating the simulation-based estimate by executing stochastic rollout simulations incorporating adversarial perturbations to estimate trajectory success rates.

According to a further aspect, the method comprises fusing the multiple independent probability estimates comprising applying Bayesian inference with Beta-Bernoulli conjugate updating.

According to a further aspect, the method comprises routing alerts by: routing alerts to an auto-mitigation pathway when the alerts exceed a first confidence threshold; routing alerts to a human escalation pathway when the alerts are between the first confidence threshold and a second confidence threshold; and routing alerts to an immediate escalation pathway when the alerts are below the second confidence threshold.

According to a further aspect, the method comprises comprising projecting, by a submersion operator, alerts from a fast manifold to a mesoscale manifold and enriching alerts with contextual tags, provenance metadata, and reasoning pathways.

According to a further aspect, the method further comprises the steps of: recording, by an archive processor, alert lifecycle data; and triggering recalibration of alert thresholds when performance metrics deviate from target values.

### BRIEF DESCRIPTION OF THE DRAWING FIGURES

FIG. 1 is a block diagram illustrating an exemplary system architecture for a sensor normalization and latent projection pipeline for multimodal alert generation within a Persistent Cognitive Machine architecture, according to an embodiment.

FIG. 2 is a block diagram illustrating exemplary proto-alert clustering within a fast manifold, demonstrating how latent trajectories are monitored for divergence from baseline attractors and how proto-alerts are generated when predefined thresholds are exceeded.

FIG. 3 is a block diagram illustrating an exemplary system architecture for projecting proto-alerts from the fast manifold to the mesoscale manifold, according to an embodiment.

FIG. 4 is a block diagram illustrating an exemplary system architecture for prediction-driven triage, according to an embodiment.

FIG. 5 is a flow diagram illustrating an exemplary gating logic method that routes alerts to one of three disposition regimes based on posterior probability thresholds, according to an embodiment.

FIG. 6A is a block diagram illustrating an exemplary high-level federated PCM architecture and deployment topology, according to an embodiment.

FIG. 6B is a block diagram illustrating some detailed mechanisms of federated PCM fabric coordination, according to an embodiment.

FIG. 7 is a flow diagram illustrating an exemplary method for implementing sleep-state recalibration of alert thresholds and priors through replay of archived alert trajectories, compression pressure analysis, and schema consolidation steps.

FIG. 8 is a diagram illustrating an exemplary human-facing alert card with probability bars, credible intervals, provenance traces, and counterfactual explainability, according to an embodiment.

FIG. 9 is a flow diagram illustrating an exemplary method for end-to-end multimodal alert generation, triage, and resolution through federated latent sensor streams within a Persistent Cognitive Machine architecture, according to an embodiment.

FIG. 10 illustrates an exemplary computing environment on which an embodiment described herein may be implemented.

### DETAILED DESCRIPTION OF THE INVENTION

The inventor has conceived, and reduced to practice, a system and method for multimodal alert generation via federated latent sensor streams within PCM architecture.

The multimodal alert generation architecture is realized as a layered extension of the Persistent Cognitive Machine fabric. It comprises sensor-level latent encoders, proto-alert clustering kernels, hierarchical projection operators, and federated synchronization protocols.

Each component is formally defined to ensure that alerts are not merely threshold crossings, but structured objects embedded in manifold geometry.

Let {sᵢ(t)} denote heterogeneous sensor streams (e.g., acoustic, optical, thermal, seismic, cyber, etc.). Each stream is mapped into a latent vector zᵢ(t)∈R^{d} via encoder Eᵢ: Sᵢ→R^{d}, trained to preserve cross-modal correlation structures. For a set of encoders {Eᵢ}, the joint latent representation at fast timescale (M1) is

$$Z ( t ) = {\{ {z}_{i} ( t ) , {q}_{i} ( t ) \}}_{i = 1}^{N} ,$$

where qᵢ(t)∈[0,1] denotes a quality-of-evidence score derived from encoder reconstruction error, signal-to-noise ratio, and temporal consistency. This weighting ensures that low fidelity inputs contribute proportionally less to downstream proto-alert formation.

Within the fast manifold M₁, latent embeddings Z(t) are aggregated into trajectories γ(t)⊂M₁. A proto-alert is defined as a cluster of trajectories that diverge significantly from a baseline attractor set B⊂M₁. Formally, let

$$δ ( γ , B ) = min {d}_{M 1} ( γ , b ) ,$$

$$b ∈ B$$

where d_{M1} is the geodesic distance induced by the local metric g₁. A proto-alert Aₚ is instantiated if

$$δ ( γ , B ) > θ + λ \cdot {σ}_{B} ,$$

where θ is a static threshold, σ_{B} the dispersion of the baseline, and λ a tunable multiplier controlling sensitivity. The proto-alert kernel thus transforms raw novelty into manifold geometric divergence.

Proto-alerts are projected upward into the mesoscale manifold M₂ through a submersion operator

$$π 1 \to 2 : M 1 \to M 2 , Ap 7 \to A m ,$$

where Aₘ is an enriched alert object. Each Aₘ carries attributes {C,P,Φ}: C: contextual tags derived from doctrinal ontologies (e.g., safety, adversary, environmental, etc.). P: provenance metadata linking Aₘ to the originating proto-alert cluster, encoders, and evidence scores. Φ: reasoning pathways in M₂, including counterfactual expansions and divergence indices. This projection ensures that alerts are semantically contextualized and cognitively tractable.

When mesoscale cognition yields a recommended action π*, the decision is immersed back into M₁ via

$${ι}_{2 \to 1} : {M}_{2} \to {M}_{1} , {π}^{*} ( {A}_{m} ) \to 7 {u}_{π} * ( t ) ,$$

where u_{π}*(t) is a control field defined on the fast manifold. Immersion ensures that all actuation remains bounded by sensor-level evidence and autonomy envelopes, preventing overreach or hallucinated responses.

In distributed deployments, multiple PCMs exchange proto-alert structures without sharing raw sensor data. Let

$${M}_{1}^{i} and {M}_{1}^{j}$$

denote fast manifolds of PCM instances i and j. A fiber map

$${F}_{ij} : {M}_{1}^{j} \to {M}_{1}^{i}$$

transports proto-alert structures across instances, aligning them via correlation-preserving embeddings. The divergence index

$${D}_{ij} ( {A}_{p} ) = {‖ {F}_{ij} ( {A}_{p}^{j} ) - {A}_{p}^{i} ‖}_{{g}_{1}}$$

quantifies semantic drift between federated alerts. Autonomy envelopes define tolerances on Dᵢⱼ; alerts exceeding envelope bounds trigger escalation to mesoscale reasoning for reconciliation.

All proto-alerts, projections, and mitigations may be persisted in a landmark graph G=(V,E), where vertices v∈V represent cached alert states, and edges (v,w)∈E are annotated with geodesic distance, curvature penalties, and compression costs. During sleep cycles, the PCM replays alert trajectories, pruning redundant proto-alerts, adjusting θ and λ parameters, and updating landmark weights. This process ensures that alert sensitivity adapts over time while preserving coherence.

A central novelty of the disclosed system is that alerts are not treated as terminal events, but as precursors whose trajectories can be predicted, mitigated, or suppressed before human escalation. The triage process fuses geometric feasibility, stochastic rollouts, and historical archives into a Bayesian posterior that governs alert disposition.

Let M₂ denote the mesoscale manifold containing alert objects Aₘ. For current state x₀∈M₂ and a candidate mitigation policy π, define the control field

$${u}_{π} : {M}_{2} \to {TM}_{2} .$$

A success basin S⊂M₂ represents resolution of the alert (e.g., restored stability), while failure basins {Fₖ} correspond to escalation conditions. The policy-aligned geodesic distance is

$${d}_{π} ( {x}_{0} , S ) = {min}_{γ ∈ Γ ( {x}_{0} , S )} {\int }_{0}^{1} \frac{{〈 \dot{γ} ( t ) , {u}_{π} ( γ ( t ) ) 〉}_{{g}_{2}}}{{‖ \dot{γ} ( t ) ‖}_{{g}_{2}}}$$

where Γ(x₀,S) is the set of smooth curves from x₀ to S. Misalignment penalties are introduced via curvature κ_{π}(γ) and compression cost C(x):

$${κ}_{π} ( γ ) = {\int }_{0}^{1} {‖ {∇}_{\dot{γ} ( t )} \dot{γ} ( t ) ‖}_{{g}_{2}} dt , C ( x ) = {div}_{{g}_{2}} ( {\sum }_{j} \frac{{\dot{x}}_{j}}{‖ {\dot{x}}_{j} ‖} ) .$$

A geometric feasibility prior is then defined by a logistic mapping

$${ϕ}_{π} ( {x}_{0} ) = σ ( - α {d}_{π} ( {x}_{0} , S ) - β {κ}_{π} ( γ ) - γ C ( {x}_{0} ) ) ,$$

with tunable weights (α,β,γ) and σ(z)=(1+e^{-z})⁻¹.

Short-horizon stochastic simulations are performed within M₂:

$$xt + Δ t = xt + Δ tF \hat{} ( xt , u π ( xt ) ) + η t ,$$

where F\hat{ } is a transition operator projected from fast-manifold dynamics, and ηₜ~N(μ(xₜ), Σ(xₜ)) represents perturbations. Adversarial counterflows a(x) bias μ(xₜ) toward failure basins, ensuring robustness. Each rollout terminates in S (success) or {Fₖ} (failure), yielding Bernoulli outcomes {Yᵢ} with importance weights wᵢ=p(ηᵢ)/q(ηᵢ).

A self-play archive A={(xᵢ, πᵢ, yᵢ)} stores prior alert trajectories and outcomes. Similarity kernels

$$K ( {x}_{0} , {x}_{i} ) = exp ( - \frac{{{d}_{{M}_{2}} ( {x}_{0} , {x}_{i} )}^{2}}{2 {σ}^{2}} ) , \\ S ( π , {π}_{i} ) = exp ( - \frac{1}{τ} {\int }_{U ( {x}_{0} )} {‖ {u}_{π} ( x ) - {u}_{{π}_{i}} ( x ) ‖}_{g 2}^{2} dx ) ,$$

weight past evidence. The empirical success rate

$${\hat{p}}_{π}^{hist} ( {x}_{0} ) = \frac{{\sum }_{i} K ( {x}_{0} , {x}_{i} ) S ( π , {π}_{i} ) {y}_{i}}{{\sum }_{i} K ( {x}_{0} , {x}_{i} ) S ( π , {π}_{i} )}$$

provides a data-driven likelihood of mitigation success.

All estimators may be fused into a Beta-Bernoulli posterior:

$${p}_{π} ( {x}_{0} ) ∼ Beta ( α , β ) ,$$

with initialization

$${α}_{0} = k \cdot {ϕ}_{π} ( {x}_{0} ) , {β}_{0} = k \cdot ( 1 - {ϕ}_{π} ( {x}_{0} ) ) ,$$

rollout updates

$$α ← α + {}^{X} {w}_{i} {Y}_{i} , β ← β + {}^{X} {w}_{i} ( 1 - {Y}_{i} )$$

and historical adjustment

$$α ← α + λ {\hat{p}}_{π}^{hist} ( {x}_{0} ) , β ← β + λ ( 1 - {\hat{p}}_{π}^{hist} ( {x}_{0} ) ) ,$$

where λ tunes archive influence. The posterior mean \hat{ }p_{π}(x₀)=α/(α+β) quantifies mitigation likelihood, while Beta quantiles furnish credible intervals.

Alerts may be triaged by thresholds wherein options for intervention can comprise auto-mitigation and suppressing an alert, human escalation with credible band display, and immediate escalation with possible fail-safe actuation, with policy envelopes ensuring doctrinal compliance. This gating minimizes operator burden while preserving accountability.

In multi-PCM deployments, alert semantics must remain coherent across federated fabrics of manifolds. Unlike raw telemetry exchange, which is bandwidth-intensive and privacy-sensitive, the present system federates alert objects through fiber maps and divergence indices, ensuring doctrinal consistency and bounded autonomy.

Let

$${M}_{2}^{i} and {M}_{2}^{j}$$

denote mesoscale manifolds of PCM instances i and j, each hosting alert objects

$${A}_{m}^{i} and {A}_{m}^{j} .$$

A fiber map

$${F}_{ij} : {M}_{2}^{j} \to {M}_{2}^{i}$$

transports the structure of alerts between instances. Given an alert

$${A}_{m}^{j}$$

instantiated in PCM j, its federated image in PCM i is

$${F}_{ij} ( {A}_{m}^{j} ) .$$

This projection preserves geodesic relations, doctrinal tags, and provenance metadata, while discarding modality-specific raw inputs. Thus, federation occurs at the semantic level of manifold structure rather than at the data level.

To assess coherence across federated alerts, the divergence index is defined as

$${D}_{ij} ( A ) = {d}_{{M}_{2}^{i}} ( {F}_{ij} ( {A}_{m}^{j} ) , {A}_{m}^{i} ) ,$$

where

$${d}_{{M}_{2}^{i}}$$

is the geodesic distance in

$${M}_{2}^{i} .$$

Divergence reflects structural disagreement in alert semantics across nodes.

Autonomy envelopes are specified as bounds ϵᵢⱼ such that

$${D}_{ij} ( A ) \leq {ϵ}_{ij} local autonomy preserved ,$$

while violations Dᵢⱼ(A)>ϵᵢⱼ trigger reconciliation mechanisms at supervisory or federated levels. This ensures that local PCM instances can act independently within tolerance, but escalate disagreements beyond bounds.

Federated governance is achieved by minimizing a collective divergence functional

$${C}_{fed} = {\sum }_{( i , j )} {w}_{ij} {D}_{ij} ( {A}^{2} )$$

where wᵢⱼ are fiber weights representing trust, topology, or doctrinal priority between PCM instances. Minimization of C_{fed} aligns alert semantics across the federation, producing a consensus structure for distributed cognition. The minimization is performed not by centralized optimization but by distributed update rules at each PCM node:

$${A}_{m}^{i} ← {A}_{m}^{i} - η {∇}_{{A}_{m}^{i}} {C}_{fed} ,$$

where η is a step-size parameter. This ensures governance operates in a scalable, peer-to-peer manner.

In cases where divergence persists, doctrinal reconciliation is triggered at supervisory manifolds M₃ (slow scale). Let D denote a doctrinal schema, e.g., “safety overrides mission” or “human-in-the-loop required for lethal escalation.” Reconciliation is achieved by embedding D as a constraint manifold C⊂M₂, such that alert trajectories are projected into C:

$${A}_{m}^{*} = π 𝒸 ( {A}_{m} ) ,$$

with π_{c} a projection operator enforcing doctrinal compliance. This guarantees that federated alerts remain not only geometrically consistent but also legally and ethically constrained.

Adversarial perturbations at one PCM instance may bias alert trajectories across the federation. A hostile counterflow a(x) in

$${M}_{2}^{j}$$

induces increased divergence Dᵢⱼ(A) for connected PCMs. The system models this as an adversarial field propagating along fibers, deforming the global federated manifold Mₙₑₜ. Governance mechanisms therefore adjust autonomy envelopes dynamically when cross-asset counterflows are detected, tightening thresholds to prevent alert cascades.

According to an implementation of an embodiment, federated governance can be realized through: compressed exchange wherein only alert posterior parameters (e.g., α, β), doctrinal tags, and divergence metrics are exchanged, not raw embeddings. Distributed synchronization wherein each PCM executes lightweight gradient updates for Cfed, ensuring sublinear communication overhead. Latency budgets wherein divergence indices are computed using landmark graphs, enabling rapid federation (e.g., cycles<200 ms) even at scale. Through these mechanisms, the system embeds alert governance directly into PCM fabrics: alerts propagate as manifold objects, divergence is bounded by autonomy envelopes, and doctrinal reconciliation ensures consistent, lawful, and explainable alert management across distributed infrastructures.

The Persistent Cognitive Machine does not treat alert parameters as static. Instead, thresholds, priors, and schemas evolve through nightly or scheduled sleep cycles in which archived alert trajectories are replayed, compressed, and generalized. This process ensures that alert sensitivity adapts to long-term operational context without collapsing into incoherence.

Let A={(xₜ, Aₘ,y)} denote the archive of alert events, where xₜ∈M₂ is the alert state at time t, Aₘ the alert object, and y∈{0, 1} the resolution outcome (success/failure). During sleep, trajectories {xₜ} are replayed in compressed latent space using manifold geodesics:

$$γ ( t ) = {arg}_{γϵ} {min}_{Γ ( {x}_{0} , {x}_{T} )} {\int }_{0}^{1} {‖ γ ( t ) ‖}_{g 2} dt ,$$

where Γ(x₀,x_{T}) is the set of curves from alert onset x₀ to resolution x_{T}. Replay condenses alert dynamics into geodesically minimal summaries.

Alert onset thresholds are recalibrated by compression pressure. For a region U∈M₂, compression cost is

$$C ( U ) = {\int }_{U} {div}_{g 2} ( {\sum }_{j} \frac{{\dot{x}}_{j}}{‖ {\dot{x}}_{j} ‖} ) d μ ,$$

where μ is the measure induced by manifold volume. Regions with excessive compression (high C(U)) indicate over-triggering of alerts; thresholds ρ_{crit} and Δₐₗₑᵣₜ are raised locally. Conversely, under-triggered regions (low density but high curvature) lower thresholds to improve sensitivity.

Posterior parameters (α,β) for alert triage are updated incrementally using archived outcomes:

$$α ← α + {\sum }_{( x , A , y ) ϵ A} w ( x , A ) \cdot y , β ← β + {\sum }_{( x , A , y ) ϵ A} w ( x , A ) \cdot ( 1 - y ) ,$$

where weights w(x,A) are derived from geodesic similarity to current operational contexts. Sleep updates ensure that posterior distributions capture long-run frequencies and adapt to evolving environments.

At the slow manifold scale M₃, recurrent alert motifs are consolidated into doctrinal schemas. For example, repeated proto-alerts involving combined acoustic and vibration anomalies consolidate into a schema Σ corresponding to “incipient pump cavitation.” Formally,

$$\sum = {\int }_{A} K ( x , {x}^{′} ) d μ ( {x}^{′} ) ,$$

where K is a kernel weighting structurally similar alert trajectories. This schema formation stabilizes long-term cognition and informs doctrinal reconciliation in federated deployments.

According to an embodiment, tecalibration operates on landmark graphs nearest-neighbor replay, GPU-accelerated geodesic approximations, and federated exchange of posterior deltas (α,β). Sleep cycles may be scheduled adaptively, triggered by compression pressure spikes or operator demand, ensuring responsiveness to both gradual drift and abrupt shifts.

According to an embodiment, proto-alert clustering leverages approximate nearest-neighbor queries on the landmark graph.

According to an embodiment, projection and immersion operators are implemented as sparse matrix multiplications, enabling GPU acceleration.

According to an embodiment, federated synchronization exchanges posterior parameters (α,β) of alert probability distributions rather than raw embeddings, reducing bandwidth and preserving privacy.

According to an embodiment, federated latent sensor encoding is implemented wherein each heterogeneous sensor stream is projected into a latent manifold representation at the fast timescale (M1). Encoders preserve crossmodal correlation, and federated synchronization aligns latent embeddings across multiple PCMs, enabling early anomaly fusion without raw data exchange.

According to an embodiment, hierarchical projection of alerts is implemented wherein latent proto-alerts, defined as coherent clusters of anomalous embeddings in M1, are projected upward to the mesoscale manifold (M2) via submersion maps. In M2, proto-alerts are transformed into full alert objects, enriched with doctrinal policy tags, provenance metadata, and reasoning pathways. Immersion back into M1 constrains actuation to sensor-level evidence.

According to an embodiment, prediction-driven triage is implemented wherein rather than treating alerts as terminal events, the system applies geometric reachability priors, short-horizon stochastic rollouts, and historical kernel estimators to quantify the probability that a proto-alert will escalate into a mission-critical event. These estimators are fused in a Bayesian framework:

$${p}_{π} ( {x}_{0} ) \sim Beta ( α , β ) ,$$

where π is the mitigation policy, x₀ the current latent state, and (α,β) pseudo-counts initialized by geometric feasibility, updated by rollout evidence, and refined by historical analogs. Alerts with high predicted mitigation success are resolved automatically, suppressing operator burden, while low-confidence cases escalate to humans with explicit credible intervals.

According to an embodiment, federated alert governance is implemented wherein in multi-PCM deployments, alerts are exchanged not as raw triggers but as manifold-anchored objects aligned via fibers. Divergence indices, autonomy envelopes, and federated minimization criteria ensure that alert semantics remain coherent, privacy-preserving, and policy-compliant across distributed nodes.

According to an embodiment, an exemplary practical implementation comprises real-time performance, the system employs landmark graph structures for O(log n) nearest-neighbor proto-alert formation, GPU-accelerated rollout engines for parallel probability estimation, and federated synchronization protocols for posterior parameter exchange. These mechanisms fit within latency budgets<100 ms per alert cycle, ensuring proactive and interpretable cognition at operational scale.

Through these mechanisms, the disclosed system transforms multimodal alerting from a static, reactive notification model into a proactive cognitive substrate. Alerts are no longer noise: they become structured objects in a federated manifold, governed by geometry, enriched by prediction, and constrained by doctrine. The result is resilient, explainable, and scalable alert management for industrial, defense, and cyber infrastructures.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### DEFINITIONS

As used herein, “thought” refers to a discrete unit of reasoning or analysis generated by a large language model or multimodal inference engine during its processing of an input prompt. A thought represents the model's intermediate reasoning steps, contextual interpretation, or internal deliberation that contributes to a final output. Thoughts may be atomic (e.g., a factual claim), structured (e.g., an inference chain), or multimodal (e.g., a fused representation of text and video). Unlike raw tokens or embeddings, thoughts encapsulate processed cognition and are suitable for caching, recombination, and reuse across future interactions. Thoughts may be stored explicitly or synthesized during recall and may evolve through compression or generalization.

As used herein, “thought cache” refers to a structured memory layer configured to store and retrieve thoughts based on semantic similarity, contextual alignment, or system policy. The cache may include multiple tiers, such as session caches for short-term interaction, long-term caches for persistent knowledge, and shared or federated caches across devices or agents. Cached thoughts are indexed in latent space and may be retrieved using vector similarity, trajectory proximity, or geodesic alignment. Cached thoughts may be compressed or abstracted over time to reduce redundancy and support scalable reuse.

As used herein, “generalization” refers to the process of synthesizing a new thought from one or more cached thoughts by identifying shared structure, meaning, or trajectory. Generalized thoughts replace specific exemplars with compressed representations that maintain core semantic content while enabling reuse across a wider range of prompts or tasks. Generalization may occur explicitly during reasoning or asynchronously during background curation or dreaming.

As used herein, “latent manifold” refers to a differentiable subspace within a high-dimensional latent hyperspace in which thoughts and thought trajectories are embedded. The manifold may be defined at a given time and is associated with a metric tensor that governs local distance, curvature, and motion. The manifold forms dynamically through the reuse, compression, and interaction of thoughts and supports operations such as geodesic traversal, memory recall, and structural recombination.

As used herein, “geodesic attention” refers to a formulation of attention in which focus or inference is achieved by computing or approximating a minimal-energy path through the latent manifold. A geodesic attention path minimizes a cognitive action functional that may include kinetic energy, compression pressure, and goal potential. Unlike traditional attention mechanisms that reweight tokens in flat space, geodesic attention produces smooth, structure-respecting flows of reasoning across latent memory.

As used herein, “compression pressure” refers to a scalar field over the latent manifold that encodes semantic density, memory reuse, or representational redundancy. The pressure at a point may be derived from geometric properties such as Ricci curvature and reflects the cost of traversal or storage in that region. High compression pressure indicates overused or ambiguous areas where pruning, generalization, or reorganization may be necessary. Compression pressure influences cache management, memory shaping, and geodesic routing.

As used herein, “goal potential field” refers to a scalar utility function defined over the latent manifold that represents the relevance, desirability, or task-alignment of different regions of thought space. The gradient of this field defines an intent vector field, which biases cognitive traversal toward goal-aligned areas. Goal potential may be determined by user prompts, task specifications, or emergent system objectives, and modulates attention, memory retrieval, and trajectory formation.

As used herein, “intent vector field” refers to a directional field over the latent manifold that encodes cognitive drive or utility gradients. It governs the direction and magnitude of traversal for operations such as memory reentry, inference, or exploration. The intent field may be computed from the gradient of a goal potential, derived from user input, or learned from system experience, and is used to align cognitive motion with target outcomes.

As used herein, “cognitive dynamics engine” or “CDE” refers to an architectural module configured to maintain and evolve the geometry of the latent manifold. The CDE is responsible for computing geodesic paths, estimating curvature, applying compression pressure, and performing structural reorganization, including during background operations such as dreaming. The CDE may expose interfaces for traversal, memory updates, compression, and control feedback, and functions as a substrate-layer system supporting high-level cognition.

As used herein, “dreaming” refers to a background process in which cached thoughts, trajectories, or bundles are perturbed, recombined, or abstracted or otherwise manipulated to improve manifold coherence and memory efficiency. Dreaming may operate during idle cycles or low-load periods and is driven by curvature smoothing, compression pressure, and generalization gain. The process supports the emergence of new thoughts, refinement of existing structures, and long-term memory consolidation.

As used herein, “reinstantiation” refers to the act of reconstructing a prior thought trajectory within the current latent manifold geometry. Due to compression or manifold deformation, original paths may no longer exist in exact form; reinstantiation generates an approximate or adapted version guided by curvature, cached data, and intent fields.

Reinstantiation supports memory recall, simulation, and introspective review in systems with dynamic cognitive substrates.

As used herein, “memory basin” or “basin of recurrence” refers to a region of the latent manifold associated with a previously reinforced or frequently reused trajectory. Such basins exhibit high local curvature and geodesic convergence and serve as attractors for memory reentry. Traversal into a basin may trigger reinstantiation, memory reinforcement, or adaptive reuse, depending on system configuration and goal conditions.

As used herein, “typed latent entity” refers to a thought or substructure in the manifold labeled with a semantic or functional type, such as but not limited to fact, opinion, concept, trajectory, affect, cluster, or anchor. Typed entities impose constraints on valid operations such as recombination, interpolation, or pruning. Type-aware computation supports lawful memory manipulation, structured reasoning, and generalization without semantic distortion.

As used herein, “attention vector field” refers to a distributed, time-dependent field defined over the latent manifold that governs the instantaneous direction and magnitude of attentional flow. The field may evolve according to partial differential equations that incorporate compression pressure and goal potential gradients. This dynamic attention formulation enables real-time flow modeling, inference stabilization, and explainability through traceable vector paths.

As used herein, “latent subspace” or “thought bundle” refers to a localized, compressible region of the manifold that contains structurally similar or semantically aligned thoughts. Bundles may form naturally through repeated traversal, co-activation, or recombination, and act as low-energy attractors or semantic zones. Subspaces may support generalization, analogical reasoning, and efficient memory access.

As used herein, “latent recombinator” refers to a functional component or method configured to merge or blend similar thoughts, trajectories, or bundles in the latent manifold to form new abstractions. The recombinator may use geometric proximity, semantic alignment, or reuse statistics to determine legal recombinations, subject to type constraints and curvature continuity. It serves as a key mechanism for memory scaling, abstraction, and thought generation.

As used herein, “structured memory” refers to a persistent, geometry-aware memory architecture in which thoughts are stored not as flat vectors but as positions or paths within an evolving manifold. Structured memory supports context-sensitive access, memory reinforcement through traversal, lawful pruning, and dynamic generalization. It provides a substrate for long-term cognition, introspection, and identity continuity in systems with persistent reasoning capability.

As used herein, “Lorentzian autoencoder” refers to a neural architecture designed to encode spatiotemporal or perceptual input-such as video-into a latent manifold with Lorentzian signature, where one or more dimensions represent time-like directions. The latent structure supports temporally coherent geodesics, semantic compression, and causal continuity. Lorentzian autoencoders enable operations such as zooming, projection, and visual memory traversal.

### Conceptual Architecture

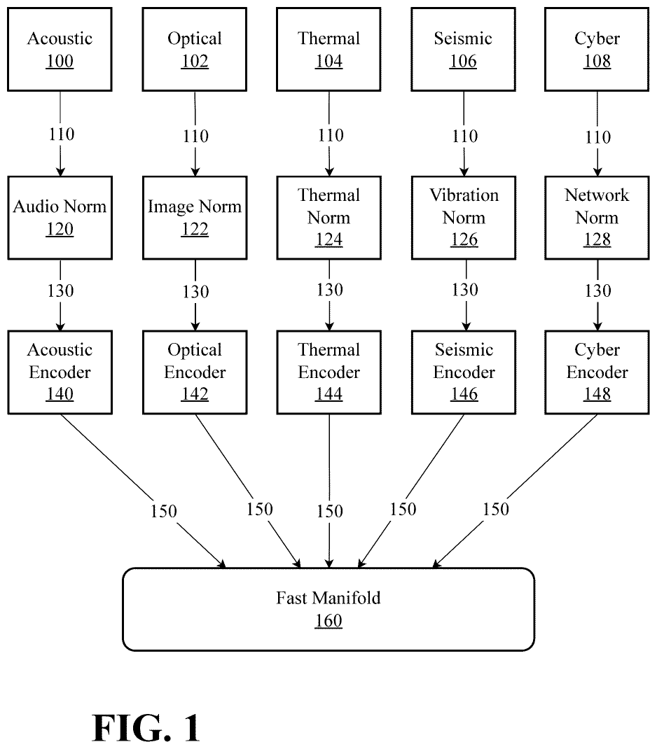

FIG. 1 is a block diagram illustrating an exemplary system architecture for a sensor normalization and latent projection pipeline for multimodal alert generation within a Persistent Cognitive Machine architecture, according to an embodiment. The embodiment demonstrates the transformation of heterogeneous sensor streams into a unified geometric substrate suitable for proto-alert formation and federated cognitive processing.

According to the embodiment, the pipeline comprises a plurality of heterogeneous sensor streams 100-108 representing diverse environmental monitoring modalities. Acoustic sensor 100 captures audio signals s₁(t), optical sensor 102 processes visual data s₂(t) as image frames or video streams, thermal sensor 104 monitors temperature variations s₃(t) with variable temporal resolution, seismic sensor 106 detects vibrational patterns s₄(t) across various frequency ranges, and cyber sensor 108 analyzes network traffic, log entries, and/or digital event streams s₅(t) with variable temporal characteristics. Each sensor operates according to its native sampling protocol, creating temporally and dimensionally disparate data streams requiring systematic integration.

Connection pathways 110 direct raw sensor outputs to stream normalization adapters 120-128, which implement modality-specific preprocessing algorithms. In one embodiment, audio normalizer 120 applies digital signal processing including bandpass filtering (e.g., 100 Hz to 8 kHz for acoustic monitoring), amplitude normalization to unit variance, and windowing functions such as Hamming or Hann windows for spectral analysis. The normalization transformation may be expressed as \tilde{s}₁ (t)=W(t)·[s₁(t)−μ₁]/σ₁, where W(t) is a window function, μ₁ and σ₁ are rolling mean and standard deviation computed over sliding time windows of 1-10 seconds.

Image normalizer 122 performs spatial and intensity standardization including pixel value normalization to [0,1] or [−1,1] ranges, spatial resizing to common dimensions (e.g., 224×224 or 256×256 pixels), and optional color space conversion. Thermal normalizer 124 implements temperature scaling using calibration curves specific to sensor characteristics and environmental compensation, typically expressed as \tilde{s}₃(t)=(s₃(t)−T_offset)/T_scale where offset and scale parameters are determined during system calibration.

Vibration normalizer 126 applies time-domain preprocessing including detrending via high-pass filtering (typically 0.1-1 Hz cutoff), amplitude scaling, and optional resampling to common temporal resolution. Network normalizer 128 standardizes digital events through packet size normalization, timestamp alignment, and feature extraction producing fixed-dimension vectors representing network state characteristics.

Normalized streams flow through connection pathways 130 to latent encoders 140-148, each implementing the transformation Eᵢ: \tilde{s}ᵢ(t)→zᵢ(t)∈ [symbol] ^{d} where d can be an number of dimensions (e.g., 64-512 dimensions). In a preferred embodiment, each encoder comprises a neural network architecture selected for the specific modality characteristics.

Acoustic encoder 140 may implement a convolutional neural network operating on spectrograms, with architecture including 1D or 2D convolutional layers (kernel sizes 3-7), batch normalization, ReLU activation functions, and fully connected output layers. A representative architecture may comprise 3-5 convolutional layers with channel dimensions [32, 64, 128, 256], followed by global average pooling and dense layers producing d-dimensional output vectors z₁(t).

Optical encoder 142 can be configured to employ convolutional architectures such as ResNet, EfficientNet, or custom CNN designs, with typical layer sequences including initial convolution (7×7 or 3×3 kernels), residual blocks or inverted residual blocks, and global average pooling. Pre-trained weights from ImageNet or domain-specific datasets may be employed with fine-tuning for the specific monitoring application.

The encoders preserve cross-modal correlation through joint training procedures. In one implementation, a correlation preservation loss can be added to individual reconstruction losses:

$${L}_{total} = {Σ}_{i} {‖ {s}_{i} - {D}_{i} ( {z}_{i} ) ‖}^{2} + λ \cdot {L}_{correlation}$$

where Dᵢ represents decoder networks and L_{correlation} enforces semantic alignment between modalities. The correlation loss may be implemented as canonical correlation analysis (CCA) loss, contrastive learning objectives, or mutual information maximization. For example, a contrastive correlation loss takes the form:

$${L}_{correlation} = - log ( exp ( sim ( {z}_{1} , {z}_{2} ) / τ ) / {Σ}_{j} exp ( sim ( {z}_{1} , {z}_{j} ) / τ ) )$$

where sim (·, ·) is cosine similarity, t is a temperature parameter (typically 0.1-1.0), and the denominator includes negative samples from temporally distant or semantically unrelated sensor readings.

Each encoder produces quality indicators qᵢ representing evidence reliability. In some aspects, quality scores may be computed as weighted combinations of multiple factors:

$${q}_{i} ( t ) = α \cdot {SNR}_{score} ( t ) + β \cdot ( 1 - {reconstruction}_{error} ( t ) ) + γ \cdot {temporal}_{consistency} ( t )$$

where weights α, β, γ sum to unity. The signal-to-noise ratio score SNR_{score}(t)=tanh (SNR_{dB}(t)/20) normalizes decibel measurements. Reconstruction error is computed as reconstructionₑᵣᵣₒᵣ(t)=∥\tilde{s}ᵢ(t)−Dᵢ(zᵢ(t))∥²/∥\tilde{s}ᵢ(t)∥². Temporal consistency measures the stability of latent representations over short time windows: temporal_{consistency}(t)=1−∥zᵢ(t)−zᵢ(t−Δt)∥/∥zᵢ(t)∥ for time lag Δt typically ranging from 100 ms to 1 second.

Connection pathways 150 aggregate individual latent streams into fast manifold M₁ 160 through geometric embedding procedures. The manifold structure is established by computing local metric tensors that encode semantic relationships. In one implementation, the metric tensor gᵢⱼ(x) at manifold point x is derived from local correlation matrices of embedded vectors:

$${g}_{ij} ( x ) = {Σ}_{k} {w}_{k} ( x ) \cdot {C}_{ij} ( k )$$

where wₖ(x) are distance-based weights for k-nearest neighbors and Cᵢⱼ(k) are empirical correlation coefficients between latent dimensions i and j computed over local neighborhoods.

Alternatively, the metric may be learned through neural approaches where a metric network Mₙₑₜ (x) predicts local metric properties based on manifold position x. The network architecture can be configured to include 2-4 fully connected layers with dimensions [d, 2d, d, d(d+1)/2] to output symmetric metric tensor components.

Within fast manifold M₁ 160, proto-alert detection employs density-based clustering algorithms operating on the multimodal latent bundle Z(t)={zᵢ(t), qᵢ(t)}ᵢ₌₁^{N}, according to an embodiment. Baseline attractors B⊂M₁ are established during system initialization through clustering normal operational data using algorithms such as DBSCAN, k-means++, or Gaussian mixture models. In one embodiment, baseline attractors are defined as cluster centroids μₖ with associated covariance matrices Σₖ computed during model training.

Proto-alert formation occurs when current latent trajectories γ(t) exhibit geodesic distance from baseline attractors exceeding, for example, adaptive thresholds:

$$δ ( γ , B ) = {min}_{β} ∈ B {dM}_{1} ( γ , b ) > θ + λ \cdot σ B$$

where dM₁ represents geodesic distance under the learned metric, θ is a base threshold (e.g., 2-5 standard deviations), λ is a sensitivity multiplier (0.5-2.0), and σB represents baseline dispersion. Geodesic distances can be computed using approximate shortest path algorithms on k-nearest neighbor graphs (e.g., k=10-50) or through learned distance functions implemented as neural networks.

The architecture supports real-time operation through optimized implementations. Normalization adapters may operate as streaming processors with circular buffers maintaining 1-10 seconds of recent data. Latent encoders may employ model quantization (INT8 or FP16) and batch processing where feasible. Manifold operations can be configured to utilize landmark graphs with nearest-neighbor queries implemented through approximate algorithms such as locality-sensitive hashing or learned indices.

The system includes validation mechanisms ensuring continued accuracy. Cross-modal alignment may be monitored through correlation coefficients between encoder outputs, with values below some threshold value (e.g., 0.3-0.7) triggering retraining procedures. Proto-alert false positive rates are tracked, with adaptive threshold adjustment when rates exceed, for example. 0.1-0.5 per hour. Quality score distributions can be monitored for drift, with encoder recalibration initiated when score means deviate by more than some threshold value (e.g., 0.1-0.2) from baseline values.

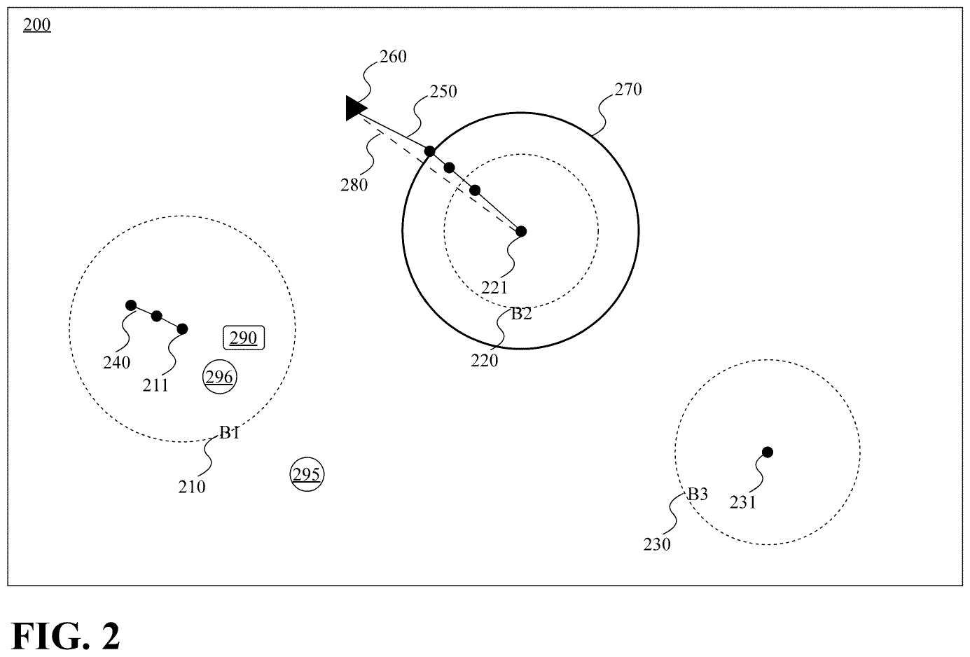

FIG. 2 is a block diagram illustrating exemplary proto-alert clustering within a fast manifold, demonstrating how latent trajectories are monitored for divergence from baseline attractors and how proto-alerts are generated when predefined thresholds are exceeded.

According to an embodiment, a fast manifold M₁ 200 represents a simplified (for sake of illustration) two-dimensional projection of the high-dimensional latent space, with axes corresponding to latent dimensions z₁ and z₂. While the actual manifold typically exists in 64-512 (or more) dimensions, this projection illustrates the fundamental geometric relationships and clustering behaviors that occur within the full latent space. The manifold exhibits non-uniform curvature, with regions of varying semantic density and compression pressure that influence how trajectories evolve and how distances are measured.

Three baseline attractors are illustrated within the manifold space, each representing a distinct normal operational state established during system training and calibration. Baseline attractor B₁ 210 corresponds to normal operations and appears as the largest basin, reflecting the most frequently observed operational regime. This attractor encompasses typical sensor patterns during standard monitoring conditions, including nominal acoustic levels, expected thermal profiles, regular seismic background, and normal network traffic patterns.

Baseline attractor B₂ 220 represents an idle state characterized by reduced activity across multiple sensor modalities. This basin captures the latent signatures of periods when monitored systems are in standby or low-activity modes. The smaller extent of this attractor reflects the tighter clustering of sensor patterns during idle conditions compared to the broader variability present during active operations.

Baseline attractor B₃ 230 corresponds to low load operational states, representing conditions intermediate between idle and normal operations. This attractor encompasses scenarios where systems are active but operating at reduced capacity or with limited subsystem engagement.

Each baseline attractor is characterized by a centroid point representing the mean latent position. Centroid μ₁ 211 marks the center of baseline attractor B₁, centroid μ₂ 221 marks the center of B₂, and centroid μ₃ 231 marks the center of B₃. These centroids can be computed during training as the mean vectors of latent embeddings that cluster within each operational regime. The boundaries of each attractor basin are determined by covariance analysis, typically set at two to three standard deviations from the centroid to encompass the majority of normal operational variability.

Latent trajectories represent the time evolution of sensor embeddings as they move through the manifold space. Normal trajectory γₙₒᵣₘₐₗ(t) 240 illustrates typical latent evolution during standard operations. This trajectory originates near the boundary of baseline attractor B₁ and flows smoothly toward centroid μ₁, exhibiting gradual directional changes consistent with normal sensor correlation patterns. The trajectory comprises multiple discrete points corresponding to successive time samples, with spacing between points reflecting the temporal dynamics of the underlying sensor streams.

The smooth curvature of normal trajectory 240 indicates coherent evolution within the learned manifold structure. The trajectory respects local metric properties, following paths of minimal resistance through regions of appropriate compression pressure. As the trajectory approaches the attractor centroid, velocity decreases reflecting convergence toward a stable operational state.

Anomalous trajectory γ_{anomalγ}(t) 250 demonstrates latent evolution exhibiting significant divergence from baseline attractors. This trajectory originates within baseline attractor B₂ during an idle state but rapidly deviates toward a region of the manifold outside any established baseline basin. The trajectory exhibits sharper curvature and higher velocity compared to normal trajectories, reflecting abrupt changes in multimodal sensor patterns inconsistent with trained operational regimes.

Proto-alert Aₚ 260 is instantiated at the terminal point of anomalous trajectory 250, marked by a triangular symbol indicating detected anomaly. The proto-alert generation can be configured to occur when the trajectory endpoint satisfies the divergence criterion: the geodesic distance from the current position to the nearest baseline attractor exceeds an adaptive threshold combining a base threshold θ and a sensitivity term λ·σB where σB represents baseline dispersion.

Divergence threshold boundary 270 illustrates this adaptive threshold as a circular contour surrounding baseline attractor B₂. Trajectories terminating within this boundary are classified as normal variations within expected operational range, while trajectories extending beyond the boundary trigger proto-alert formation. The threshold boundary accounts for both geometric distance and local manifold properties including curvature and compression pressure.

Geodesic distance measurement 280 illustrates the computation of distance δ(γ, B₂) between anomalous trajectory terminal point and centroid μ₂. This distance is represented by a dashed line indicating the minimal-length path through the curved manifold space. Unlike Euclidean distance in flat space, geodesic distance accounts for the manifold's curvature, following paths that respect the learned semantic structure. The measurement incorporates local metric tensor properties, with distance increments weighted by the local metric coefficients at each point along the path.

Local metric indicators 290 denote regions where the metric tensor exhibits characteristic properties. Near attractor centroids, the metric typically shows higher curvature reflecting dense semantic clustering. The curved dashed lines illustrate geodesic paths between nearby points, demonstrating how the metric structure influences optimal paths through the manifold.

Compression pressure annotations indicate the varying semantic density across the manifold. High compression pressure region 296 near the center of baseline attractor B₁ reflects the dense clustering of frequently observed patterns in this operational regime. Navigation through high-pressure regions requires greater cognitive effort and is associated with slower trajectory evolution. Low compression pressure region 295 in the inter-attractor space represents areas of lower semantic density where trajectories can evolve more rapidly and with less geometric constraint.

According to various embodiments, the divergence threshold adapts based on multiple factors including, but not limited to, baseline dispersion σB computed from historical trajectory distributions within each attractor basin. Attractors with tighter clustering exhibit smaller dispersion values and correspondingly smaller threshold radii, reflecting greater confidence in defining normal operational boundaries. Attractors with broader variability maintain larger threshold radii to accommodate legitimate operational diversity without generating excessive false alerts.

A sensitivity multiplier λ provides tunable control over alert generation rates. For instances, values below unity (λ<1.0) increase sensitivity, generating proto-alerts for smaller deviations from baselines, suitable for high-security or safety-critical applications. Values above unity (λ>1.0) decrease sensitivity, requiring larger divergences before proto-alert generation, appropriate for environments with high natural variability or when false alert suppression is prioritized.

To illustrate the proto-alert formation process, consider a practical industrial monitoring scenario. A manufacturing facility deploys the system to monitor pump operations using acoustic, vibration, thermal, and flow sensors. During normal operations, sensor patterns cluster within baseline attractor B₁ 210, corresponding to healthy pump performance with characteristic acoustic signatures around 1-2 kHz, vibration amplitudes below 5 mm/s, bearing temperatures of 60-70 °C, and steady flow rates.

The system observes normal trajectory 240 as sensor readings evolve smoothly within this baseline region. Minor fluctuations in load, ambient temperature, or process demands cause the latent representation to move within the attractor basin, but these variations remain well within the divergence threshold 270.

At time t₀, operators notice unusual sounds from the pump but readings remain within individual sensor alarm limits. An acoustic encoder 140 detects elevated high-frequency components around 8-10 kHz, while vibration encoder 146 identifies increased amplitude at the bearing frequency. Thermal encoder 144 registers a gradual temperature rise to 75 °C, still below the 80 °C alarm threshold. Flow encoder maintains normal readings.

These multimodal changes, while individually subtle, combine in the latent manifold to produce anomalous trajectory 250. The trajectory originates within baseline attractor B₂ 220 (idle state, as the pump had recently restarted) but rapidly diverges as the cross-modal pattern fails to match any trained operational regime. The combination of elevated acoustics, increased vibration at specific frequencies, and rising temperature creates a latent signature in an unexplored manifold region.

The trajectory terminal point falls outside divergence threshold 270, with geodesic distance 280 measuring δ(γ, B₂)=4.2 σB, significantly exceeding the threshold of θ+λ·σB=2.5 σB (with θ=2.0 σB and λ=0.5). This triggers proto-alert Aₚ 260 for “potential bearing degradation” based on the geometric position in latent space and its proximity to historical trajectories associated with incipient bearing failures during training.

The proto-alert is generated 45 minutes before any individual sensor exceeds its alarm threshold and 3 hours before the pump experiences a bearing seizure that would have caused production downtime and equipment damage. The early warning provided by multimodal geometric analysis enables maintenance crews to schedule orderly shutdown and bearing replacement, preventing catastrophic failure.

This example demonstrates how proto-alert clustering leverages the geometric structure of the latent manifold to detect subtle multimodal anomalies that would be missed by traditional single-sensor threshold monitoring. The baseline attractors encode learned operational regimes, divergence thresholds provide adaptive sensitivity, and geodesic distance measurements respect the semantic structure of the sensor correlation space, enabling early and reliable anomaly detection.

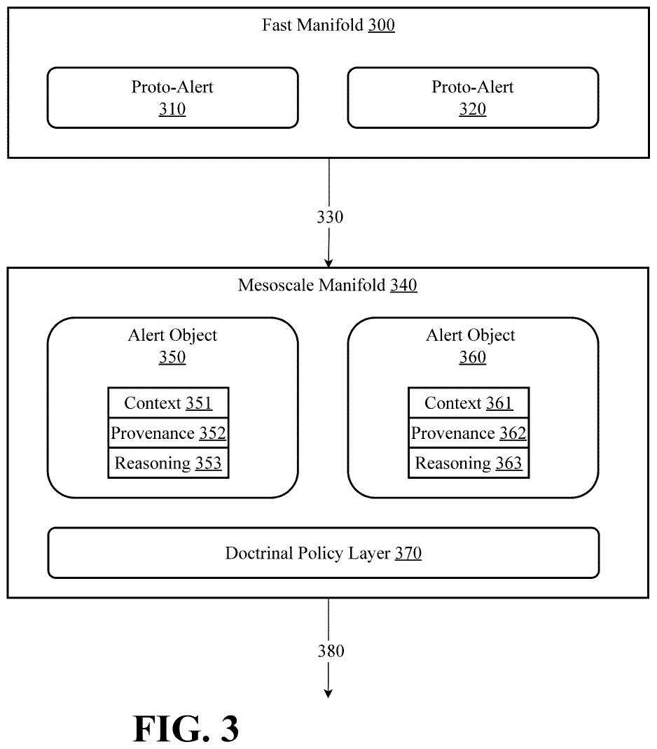

FIG. 3 is a block diagram illustrating an exemplary system architecture for projecting proto-alerts from the fast manifold M₁ to the mesoscale manifold M₂, demonstrating an enrichment process that transforms sparse latent anomalies into structured alert objects containing contextual tags, provenance metadata, reasoning pathways, and doctrinal policy associations.

According to an embodiment, a fast manifold M₁ 300 represents the sensor-timescale latent space where proto-alerts are initially detected through geometric divergence from baseline attractors. This manifold operates at the temporal resolution of sensor sampling, typically processing updates every 100 milliseconds to several seconds, for example, depending on modality characteristics. Proto-alerts at this level may comprise minimal structured information, primarily comprising latent position vectors, divergence metrics, quality scores, and temporal markers.

Proto-alert Ap1 310 exemplifies a mechanical anomaly detection scenario. The proto-alert maintains a latent position vector z with coordinates in the high-dimensional embedding space, such as z=[0.23, −0.45, 0.78, . . . ] extending across 64-512 (or more) dimensions. The divergence measure δ=4.2 σB indicates that the trajectory has deviated 4.2 standard deviations beyond the nearest baseline attractor, significantly exceeding typical threshold values of 2.0-3.0 σB and thereby triggering proto-alert instantiation. Quality scores from contributing sensors are preserved as a vector {q₁=0.92, q₂=0.85, q₃=0.78}, reflecting high confidence in acoustic encoder output (q₁=0.92), good thermal encoder reliability (q₂=0.85), and adequate seismic encoder performance (q₃=0.78). The timestamp to marks the precise moment of proto-alert generation, while the list of contributing sensors (Acoustic, Thermal, Seismic) identifies which modalities participated in the anomalous pattern detection.

Proto-alert Ap2 320 represents a cybersecurity anomaly with distinct characteristics. Its latent position z=[−0.61, 0.34, −0.22, . . . ] occupies a different region of the manifold, reflecting the unique multimodal signature of network-based threats. The divergence δ=3.8 σB, while slightly lower than Ap1, still substantially exceeds detection thresholds. Quality scores {q₄=0.88, q₅=0.91} indicate high confidence from cyber encoder (q₄=0.88) and optical encoder (q₅=0.91), suggesting correlated anomalies across network traffic analysis and visual monitoring systems. The timestamp t₀+15s indicates this proto-alert was generated 15 seconds after Ap1, demonstrating the system's ability to detect multiple concurrent or temporally related anomalies. Contributing sensors (Cyber, Optical) identify the cross-modal nature of the detection.

According to an embodiment, a submersion operator π₁→₂ 330 implements the mathematical transformation that projects proto-alerts from the fast manifold M₁ into the mesoscale manifold M₂. This operator performs several critical functions. The submersion process evaluates the geometric context of each proto-alert, including local curvature properties, proximity to other recent proto-alerts, and trajectory characteristics leading to the anomaly. These geometric features inform the enrichment process and help determine appropriate contextual classifications.

The submersion operator interfaces with multiple knowledge bases and ontological schemas to enable semantic enrichment. For each proto-alert, the operator queries doctrinal databases to identify applicable policy frameworks, accesses historical archives to find similar past events, and retrieves domain-specific knowledge to support hypothesis generation. The projection preserves essential geometric information from M₁ while adding higher-level semantic structures appropriate for cognitive processing at slower timescales.

The operator implements fiber-preserving mappings that maintain consistency across multiple simultaneous projections. When multiple proto-alerts are projected concurrently, their relative geometric relationships are preserved in M₂, enabling detection of coordinated or causally related anomalies. The submersion process typically completes within e.g., 50-200 milliseconds per proto-alert, ensuring that enrichment does not introduce unacceptable latency in the alert generation pipeline.

The mesoscale manifold M₂ 340 operates at cognitive timescales spanning seconds to minutes, providing sufficient temporal extent for reasoning, hypothesis evaluation, and decision-making processes. Unlike the rapidly evolving fast manifold, M₂ maintains more stable structures that support deliberative processing and policy application. The manifold geometry at this scale reflects semantic relationships between alert types, mitigation strategies, and operational contexts rather than raw sensor correlations.

Alert object Am1 350 represents the fully enriched transformation of proto-alert Ap1, now structured as a comprehensive cognitive artifact suitable for human interpretation and automated reasoning. The alert object contains three primary attribute categories that collectively enable effective response.

Contextual tags C 351 provide semantic classification through a controlled vocabulary of descriptors. The tag “SAFETY-CRITICAL” indicates that the alert involves potential threats to personnel safety or equipment integrity, triggering specific escalation protocols and response time requirements. The “MECHANICAL” tag identifies the domain of the anomaly, enabling routing to appropriate subject matter experts and selection of relevant mitigation strategies. The “DEGRADATION” tag characterizes the anomaly as a gradual process rather than an abrupt failure, suggesting that intervention windows exist before catastrophic outcomes. The

“PREVENTIVE” tag indicates that timely response can prevent more severe consequences, informing priority assignment and resource allocation decisions.

Provenance metadata P 352 maintains complete traceability from raw sensor inputs through the enrichment pipeline. The provenance chain explicitly identifies proto-alert Ap1 as the source object from manifold M₁, providing a direct link to the geometric anomaly detection. The origin specification {Encoder-140, Encoder-144, Encoder-146} references the acoustic, thermal, and seismic encoders respectively, enabling operators to examine raw sensor data if detailed investigation is required. The mean quality score q̅=0.85 summarizes overall evidence confidence, computed as the weighted average of individual encoder quality metrics. The baseline reference “B₁ (Normal Operations)” indicates which operational regime was active when the anomaly occurred, providing operational context. The divergence path γanomaly(t₀:t₀+45s) preserves the complete 45-second trajectory through latent space from anomaly onset to proto-alert generation, enabling retrospective analysis and trajectory visualization.

Reasoning pathways Φ 353 present multiple interpretive hypotheses with associated probabilities and supporting evidence. The primary hypothesis identifies bearing degradation with 73% confidence (p=0.73), supported by three lines of evidence: acoustic signatures matching early-stage bearing wear patterns learned during training, thermal rise consistent with increased friction at bearing surfaces, and seismic harmonics detected at the bearing frequency (twice the rotational speed). This multi-evidence reasoning demonstrates how cross-modal fusion strengthens diagnostic confidence beyond what any single sensor could provide.

A counterfactual reasoning pathway explores an alternative scenario: “If acoustic threshold only (p=0.12).” This pathway calculates that relying solely on acoustic sensor thresholds would delay detection until divergence reached δ=8.1 σB at t₀+180 minutes, approximately 3 hours after the actual detection time. The pathway highlights the risk of catastrophic bearing seizure occurring before single-modality detection, quantifying the value of multimodal geometric analysis.

An alternative hypothesis considers cavitation onset with 15% probability (p=0.15). This hypothesis recognizes that some acoustic and thermal characteristics could indicate fluid dynamics issues rather than mechanical wear. However, the pathway notes that definitive cavitation diagnosis requires corroboration from flow sensors (quality score q₂), and that the observed divergence trajectory is geometrically inconsistent with fluid dynamics signatures observed in training data. This reasoning demonstrates the system's ability to consider multiple explanations while appropriately weighting them based on available evidence.

Alert object Am2 360 represents the enriched transformation of proto-alert Ap2, addressing a cybersecurity scenario with different doctrinal and operational implications.

Contextual tags C 361 reflect the security-focused nature of this alert. The “SECURITY” tag routes the alert to cybersecurity personnel and activates threat-specific protocols. The “ADVERSARIAL-POSSIBLE” tag indicates that the anomaly pattern is consistent with intentional hostile activity rather than benign system malfunction, elevating threat assessment and triggering investigation procedures. The “NETWORK” tag identifies the primary domain of the anomaly. The “IMMEDIATE” tag designates highest priority response, overriding normal queue processing and potentially authorizing automated defensive actions.

Provenance metadata P 362 traces the alert to proto-alert Ap2 originating from cyber encoder (Encoder-148) and optical encoder (Encoder-142). The high quality score q̅=0.90 indicates strong evidence confidence. The baseline reference “B₂ (Idle State)” provides context that the anomaly occurred during a period of low legitimate activity, when reconnaissance attempts are more readily distinguished from normal traffic. The divergence path spanning 15 seconds (t₀+15s:t₀+30s) captures the rapid evolution of the network intrusion attempt.

Reasoning pathways Φ 363 present reconnaissance activity as the primary hypothesis with 68% confidence (p=0.68). Supporting evidence includes network traffic patterns matching port scanning techniques, optical sensor detection of unauthorized camera activation suggesting physical intrusion coordination, and cross-modal correlation indicating these events are part of a coordinated intrusion attempt rather than independent incidents. The cross-modal correlation is particularly significant, as it suggests adversarial actors are simultaneously probing cyber defenses and conducting physical surveillance, a pattern that would be missed by security systems monitoring only a single domain.

A doctrinal policy layer D 370 implements governance rules that constrain and guide alert handling based on organizational requirements, regulatory mandates, and operational doctrine. This layer ensures that automated and human responses comply with established policies regardless of specific alert content.

As an example, rule 1 specifies that any alert tagged “SAFETY-CRITICAL” requires human escalation, prohibiting fully automated resolution even when mitigation confidence is high. This rule reflects organizational risk tolerance and regulatory requirements mandating human oversight for safety-related decisions. Rule 2 authorizes auto-mitigation for alerts tagged both “SECURITY” and “IMMEDIATE,” recognizing that cyber threats may require response speeds exceeding human reaction times. This rule enables the system to automatically isolate compromised network segments or activate defensive countermeasures while simultaneously notifying security personnel.

An exemplary rule 3 implements a conservative escalation policy for alerts with mean quality scores below 0.6, acknowledging that low-confidence detections require human judgment despite potentially generating false alerts. This rule balances the competing objectives of minimizing operator burden and ensuring that genuine threats receive appropriate attention. Rule 4 requires federated notification for any alert tagged “ADVERSARIAL-POSSIBLE,” triggering information sharing with connected PCM instances that may be monitoring related infrastructure or detecting coordinated attack patterns.

An immersion operator ι₂→₁ 380 implements the reverse transformation that projects mitigation decisions from mesoscale manifold M₂ back to fast manifold M₁ where they can be executed as control actions on physical systems. This operator ensures that high-level cognitive decisions respect sensor-level constraints and evidence bounds, preventing overreach or hallucinated responses.

When a mitigation strategy is selected in M₂, the immersion operator translates it into specific control fields defined on M₁. For alert Am1 involving bearing degradation, approved mitigation may include gradual load reduction, increased cooling, and maintenance scheduling. The immersion operator maps these high-level actions to specific control trajectories in latent space, which are then decoded into concrete actuator commands: reducing pump speed by 15%, activating auxiliary cooling, and generating maintenance work orders. The operator verifies that all control actions remain within autonomy envelopes defined by sensor evidence quality and geometric confidence bounds.

For alert Am2 involving cyber intrusion, authorized auto-mitigation translates to network isolation commands. The immersion operator projects this decision into specific control actions: blocking suspicious IP addresses, disabling compromised camera feeds, and elevating authentication requirements. These actions are bounded by the quality scores and provenance chains preserved from the original proto-alert, ensuring that automated responses scale appropriately with evidence confidence.

To illustrate the projection and enrichment process, consider an example wherein a maritime port facility deploying the system to monitor cargo handling equipment and security infrastructure. The facility operates multiple crane systems, each instrumented with acoustic sensors monitoring motor operation, thermal sensors tracking bearing temperatures, vibration sensors measuring structural dynamics, optical cameras providing visual surveillance, and network monitors analyzing control system traffic.

During normal nighttime operations with minimal cargo activity, proto-alert Ap1 310 is generated at t₀=02:17:23 when crane #3's sensor signatures diverge from baseline attractor B₁. The latent position reflects an unusual combination: acoustic encoder detects elevated frequency content around 8 kHz inconsistent with normal motor harmonics, thermal encoder registers bearing temperature rising from 65 °C to 72 °C over 15 minutes, and seismic encoder identifies increased vibration amplitude at twice the motor rotation frequency. No single sensor exceeds its individual alarm threshold, but the geometric combination in M₁ produces divergence δ=4.2 σB, well above the threshold of 2.5 σB.

The submersion operator π₁→₂ 330 projects this proto-alert to M₂, initiating enrichment. The operator queries the facility's maintenance database and identifies that crane #3 underwent bearing replacement 8 months prior, approaching the typical 12-month service interval. Historical similarity search finds 7 previous instances where this sensor combination preceded bearing failures, with a median lead time of 3.2 hours before mechanical breakdown. The operator accesses the facility's safety doctrine and identifies that crane failures pose worker safety risks due to potential load drops and require immediate attention.

The resulting alert object Am1 350 is instantiated with contextual tags including “SAFETY-CRITICAL” (due to personnel risk), “MECHANICAL” (identifying the domain), “DEGRADATION” (characterizing the progressive failure mode), and “PREVENTIVE” (indicating intervention opportunity). Provenance metadata P 352 preserves the complete chain from encoders 140, 144, and 146 through proto-alert generation, with aggregated quality scoreq=0.85 indicating high confidence. Reasoning pathways @ 353 present bearing degradation as the primary hypothesis (p=0.73) with supporting cross-modal evidence.

The doctrinal policy layer 370 evaluates the alert against facility rules. Rule 1 triggers human escalation due to the “SAFETY-CRITICAL” tag, routing the alert to the maintenance supervisor's interface with priority display. Rule 3 is satisfied as q̅=0.85 exceeds the 0.6 confidence threshold. The maintenance supervisor reviews the alert object, examines the reasoning pathways including the counterfactual showing 3-hour delayed detection if relying on single-sensor thresholds, and authorizes immediate crane shutdown for bearing inspection.

The supervisor's decision is projected back through immersion operator ι₂→₁ 380, translating the high-level “shutdown crane #3” command into specific control actions: gradual load lowering at reduced speed to prevent sudden releases, motor deceleration following optimal trajectory to minimize stress, and position locking using brake systems. These control fields are generated in M₁ respecting geometric constraints derived from current sensor states, ensuring safe execution.

Inspection confirms early-stage bearing race spalling exactly matching the alert hypothesis. Replacement occurs during scheduled maintenance window rather than emergency breakdown, avoiding 6-hour cargo handling interruption and eliminating worker exposure to sudden crane failure risks. Post-incident analysis shows the multimodal geometric detection provided 3 hours and 12 minutes of advanced warning compared to when the thermal sensor would have exceeded its 80 °C alarm threshold, and 6 hours before catastrophic seizure would have occurred.

Simultaneously, at t₀+15ₛ=02:17:38, proto-alert Ap2 320 is generated when network and optical sensors detect correlated anomalies. Cyber encoder identifies port scanning activity targeting the crane control network from an unfamiliar IP address, while optical encoder detects camera #7 activating during the idle period despite being scheduled for standby mode. The latent combination suggests coordinated reconnaissance consistent with adversarial probing rather than independent benign events.

Submersion operator 330 projects this proto-alert to M₂ where it is enriched as alert object Am2 360. Contextual tags include “SECURITY”, “ADVERSARIAL-POSSIBLE”, “NETWORK”, and “IMMEDIATE”. The reasoning pathway hypothesizes reconnaissance activity (p=0.68) preparing for potential sabotage or theft, supported by the temporal correlation between network probing and unauthorized camera access.

Doctrinal policy layer 370 evaluates Am2 against security rules. Rule 2 authorizes auto-mitigation for “SECURITY”+ “IMMEDIATE” tagged alerts. Rule 4 triggers federated notification due to “ADVERSARIAL-POSSIBLE” tag, alerting the regional port security coordination center. The system executes automated response: blocking the suspicious IP address at the facility firewall, disabling camera #7 and triggering security personnel dispatch, and elevating authentication requirements for all control system access. These actions occur within 8 seconds of proto-alert generation, before human security staff could initiate response.

Subsequent investigation reveals the IP address belongs to a known threat actor group, and camera #7 was compromised through exploitation of a firmware vulnerability. The facility's rapid automated response prevented the attackers from progressing beyond reconnaissance to actual control system penetration. Federated notification enables three other regional ports to detect similar reconnaissance patterns in their networks, leading to coordinated defensive measures.

This example demonstrates how the projection from M₁ to M₂ transforms sparse geometric anomalies into actionable intelligence, how enrichment with contextual tags, provenance, and reasoning pathways enables effective decision-making, how doctrinal policies ensure responses comply with organizational requirements, and how the immersion operator translates cognitive decisions into bounded physical actions. The hierarchical architecture enables the system to handle both mechanical failures requiring human oversight and cyber threats requiring automated rapid response, all within a unified geometric framework that maintains semantic coherence and policy compliance.

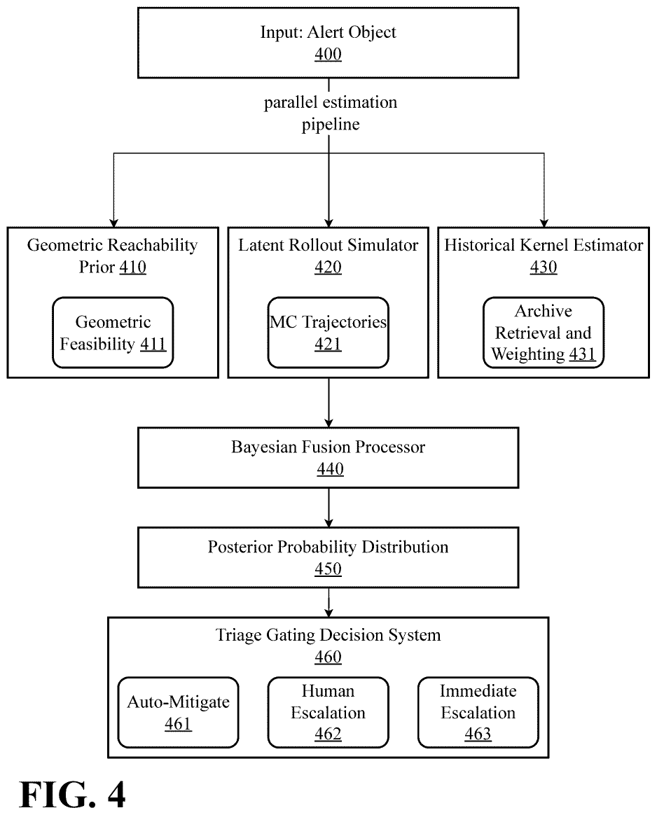

FIG. 4 is a block diagram illustrating an exemplary system architecture for prediction-driven triage, demonstrating how geometric feasibility priors, stochastic rollout simulations, and historical kernel estimates are fused through Bayesian inference to produce probabilistic predictions of mitigation success, enabling intelligent alert disposition without overwhelming human operators.

According to the embodiment, an alert input 400 represents an alert object Am currently positioned at state x₀ within mesoscale manifold M₂. This alert has been enriched through the projection process described in FIG. 3 containing contextual tags, provenance metadata, and reasoning pathways. The triage system must evaluate a candidate mitigation policy π that prescribes specific control actions intended to resolve the alert condition. The fundamental question addressed by the prediction system is: what is the probability that applying policy π from current state x₀ will successfully guide the system to a success basin S while avoiding failure basins {Fk}.

The success basin S represents manifold regions corresponding to resolved alert conditions, such as restored normal operations, eliminated security threats, or stabilized mechanical systems. Failure basins {Fk} represent manifold regions corresponding to escalated problems, such as equipment damage, security breaches, or safety incidents. The goal of prediction-driven triage is to estimate the probability pπ(x₀) that following policy π will result in trajectory termination within S rather than any Fk, and to use this probability to make intelligent decisions about whether to execute the mitigation automatically, escalate to human operators, or trigger immediate emergency response.

A geometric reachability prior estimator 410 computes the first probability estimate based purely on the geometric structure of the mesoscale manifold, without executing any forward simulations. This estimator leverages the learned manifold geometry to assess whether the proposed mitigation policy π can feasibly reach the success basin from current position x₀ given the constraints imposed by curvature, compression pressure, and geometric distance.

Step 1 computes the policy-aligned geodesic distance dπ(x₀, S) representing the minimal effort required to reach success basin S while following policy π. Unlike simple Euclidean distance, this computation accounts for the control field uπ defined by the policy, measuring how well the intended direction of motion aligns with the natural geodesic paths through the curved manifold. The distance is computed as an integral over the set of smooth curves Γ(x₀, S) connecting x₀ to S, selecting the curve that minimizes the functional integrating the dot product of path tangent vectors with the policy control field, normalized by path velocity. Paths that align well with policy π accumulate less distance, while paths requiring motion against the policy direction incur greater distance penalties.

Step 2 calculates the curvature penalty κπ(γ) along the optimal policy-aligned path. High curvature indicates that the path must make sharp directional changes to reach the success basin, suggesting that maintaining the trajectory will require precise control and may be vulnerable to perturbations. The curvature penalty is computed by integrating the covariant derivative of the path tangent vector along itself, which measures how much the tangent direction must change to follow the path while remaining parallel-transported according to the manifold's connection structure. Policies requiring navigation through high-curvature regions receive higher penalty values, indicating reduced geometric feasibility.

Step 3 assesses the compression cost C(x₀) at the current alert state and along the trajectory to the success basin. Compression pressure, derived from the divergence of the normalized attention flow field, indicates semantic density and the cognitive effort required to navigate through specific manifold regions. High compression pressure regions correspond to areas where many concepts converge, creating challenging navigation that may require complex reasoning or precise control. The compression cost quantifies the total cognitive burden of executing the mitigation policy, with higher costs indicating reduced feasibility due to semantic complexity.

The feasibility visualization 411 illustrates these geometric computations in a simplified two-dimensional projection of the mesoscale manifold. The current alert state x₀ is marked at the left, while the success basin S appears as a dashed oval region on the right. The curved trajectory between x₀ and S represents the computed policy-aligned geodesic path, with curvature visible in the path's deviation from a straight line. Regions of varying shading would indicate compression pressure fields in a more detailed rendering, though the simplified visualization focuses on path geometry.

The geometric feasibility prior φπ(x₀) may be computed as a logistic function σ of a weighted combination of the three geometric factors. The weights α, β, and γ are tunable parameters that determine the relative importance of distance, curvature, and compression in assessing feasibility. Typical weight values might be α=1.0 for distance, β=0.5 for curvature, and γ=0.3 for compression, though these can be adjusted based on domain characteristics and empirical performance. The logistic function σ(z)=1/(1+e\hat{ }(−z)) transforms the weighted sum into a probability value between 0 and 1, with negative weighted sums mapping to low feasibility probabilities and positive weighted sums indicating high geometric feasibility.

Typical geometric feasibility values range from 0.4 to 0.8 for realistic mitigation policies. Values below 0.4 suggest that the geometric structure of the manifold makes the mitigation extremely difficult, while values above 0.8 indicate that the policy is well-aligned with natural flow patterns through the manifold. These prior probabilities can be computed efficiently using precomputed landmark graphs and approximate geodesic algorithms.

A latent rollout simulator 420 implements the second probability estimation method through Monte Carlo simulation of possible future trajectories under the proposed mitigation policy. Rather than relying solely on geometric analysis, the rollout simulator executes forward predictions to observe how the alert state evolves when subjected to the control actions prescribed by policy π and perturbed by realistic noise and adversarial influences.

A rollout dynamics equation describes how alert states evolve through discrete time steps. At each time increment Δt, the state advances according to the predicted transition operator \hat{F} (xt, uπ), which approximates the true manifold dynamics and has been learned from historical data or projected from fast manifold M₁ dynamics. The control field uπ(xt) evaluates the policy at the current state to determine the intended direction and magnitude of motion. Stochastic perturbations ηt are added to represent uncertainty in dynamics, sensor noise, environmental variability, and modeling errors. These perturbations are drawn from Gaussian distributions with state-dependent mean μ(xt) and covariance Σ(xt), capturing the observation that uncertainty characteristics vary across the manifold.

An adversarial bias modification μ(xt)←μ(xt)+a(xt) implements a critical robustness feature. Rather than assuming benign perturbations centered at zero, the rollout simulator biases the noise distribution toward failure basins through the adversarial counterflow field a (xt). This counterflow is computed using gradient information pointing from current position toward the nearest failure basin, with magnitude proportional to failure severity and distance. By biasing perturbations adversarially, the simulator tests whether the mitigation policy can succeed even under hostile conditions or worst-case disturbances. This conservative approach ensures that high rollout success probabilities reflect genuine robustness rather than optimistic assumptions about benign environments.

A Monte Carlo (MC) trajectory visualization 421 can be used to illustrate the parallel execution of N rollout trajectories, typically ranging from 100 to 1000 depending on computational budget and required statistical precision. Each trajectory begins at the current alert state x₀ (solid circle at left) and evolves forward according to the rollout dynamics with independent random perturbations. The visualization shows several trajectories reaching the success basin S (solid circle on right) while one trajectory, shown as a dashed line, terminates in a failure basin F. The actual rollout process executes hundreds of such trajectories in parallel on GPU hardware, with each thread simulating one complete trajectory from x₀ until it reaches either S or some Fk or exceeds a maximum horizon time.

In some aspects, each rollout produces a Bernoulli outcome Yi∈{0, 1} indicating failure (0) or success (1), along with an importance weight wi that corrects for the adversarial bias in the perturbation distribution. The importance weight wi=p(ηi)/q(ηi) is the ratio of the true perturbation probability p to the adversarial sampling distribution q, ensuring that the biased sampling does not introduce systematic errors in probability estimates. Trajectories that succeed despite strong adversarial bias receive higher importance weights, appropriately increasing their influence on the final probability estimate.

A rollout probability estimate formula may be implemented which computes the weighted success rate as \hat{p}ᵣₒₗₗₒᵤₜ=(ΣwiYi)/(Σwi), which provides an unbiased estimate of the true success probability despite the adversarial perturbation distribution. The parameter box indicates that this rollout estimate falls in the range [0, 1], representing the empirical success fraction over the ensemble of simulated trajectories. Rollout estimates with many samples (N≥1000) achieve statistical precision of ±0.02-0.05 with 95% confidence, providing reliable evidence about mitigation success likelihood.

A GPU-accelerated implementation enables completion of 1000s rapid rollouts, making this method practical for real-time triage despite its computational intensity. Each GPU thread independently executes one complete trajectory simulation, with warp-level synchronization used only for final aggregation of success counts and importance weights.

A historical kernel estimator 430 provides the third probability estimate by leveraging archived data from past alert instances to predict whether the current mitigation policy will succeed. This estimator implements memory-based reasoning, recognizing that similar alert conditions in similar manifold regions with similar mitigation policies should yield similar outcomes. The archive A comprises tuples (xi, πi, yi) recording historical alert states, the policies applied, and the binary outcomes (1 for successful resolution, 0 for failure).

An archive query step retrieves the complete collection of historical records available to the system. In mature deployments, this archive may contain thousands to millions of past alert instances spanning months or years of operational history. The archive is indexed by manifold position to enable efficient retrieval of cases near the current alert state x₀. Advanced implementations may maintain multiple specialized archives for different alert types, operational regimes, or environmental conditions, with the query step automatically selecting the most relevant archive based on current context.

A geometric similarity kernel K(x₀, xi) quantifies how close historical state xi is to current state x₀ within the curved geometry of manifold M₂. The exponential kernel K(x₀, xi)=exp(−d²M₂(x₀, xi)/2σ²) assigns high weights (approaching 1.0) to historical states that are geodesically close to x₀, while states far from x₀ receive exponentially decreasing weights approaching zero. The bandwidth parameter σ controls the spatial extent of the kernel, with smaller σ focusing on very similar cases and larger σ including more distant historical data. Typical bandwidth values range from 0.5 to 2.0 manifold units, calibrated such that approximately 50-200 historical cases receive non-negligible weights.

A policy similarity measure S(π, πi) evaluates how closely historical policy πi matches current policy π. While geometric similarity focuses on where the alert occurred, policy similarity captures whether the same type of mitigation is being attempted. The similarity is computed by integrating the squared difference between control fields uπ(x) and uπi(x) over a neighborhood U(x₀) around the current alert state, then transforming this distance through an exponential kernel with temperature parameter τ. Policies that prescribe nearly identical control actions receive similarity scores near 1.0, while policies recommending opposite actions receive scores near 0.0. This policy similarity is essential because the same alert condition may have multiple valid mitigation approaches with different success rates; the estimator must focus on historical cases that attempted similar interventions.

The archive retrieval visualization 431 can be configured to present how historical cases are retrieved and weighted. Four exemplar cases (x₁ through x₄) may be listed with their geometric distances d, policy similarities S, historical outcomes y, and resulting weights w=K·S. Case x₁ with moderate distance (d=0.8) and high policy similarity (S=0.9) that succeeded (y=1) receives high weight w=0.85. Case x₂ is more distant (d=1.2) with lower policy similarity (S=0.7) but also succeeded, receiving moderate weight w=0.42. Case x₃ is very close (d=0.5) with excellent policy match (S=0.95) but failed (y=0), receiving the highest weight w=0.91; this case strongly suggests the current mitigation may fail since an almost identical situation in an almost identical location with an almost identical policy did fail. Case x₄ is quite distant (d=2.1) with poor policy match (S=0.3) and thus receives negligible weightw=0.08 regardless of outcome. The visualization indicates that 47 similar cases were retrieved from the archive with non-negligible weights, providing substantial historical evidence.

A historical probability estimate formula may be utilized which computes a weighted average of outcomes from all retrieved cases, with weights determined by the product of geometric and policy similarity kernels. The numerator sums the products K·S·yi over all historical cases, accumulating evidence from successful outcomes weighted by relevance. The denominator normalizes by the sum of weights K·S, ensuring the estimate remains a valid probability. The parameter box indicates that \hat{p}ₕᵢₛₜ∈[0, 1] represents the historical success rate among similar cases, providing data-driven evidence about mitigation effectiveness.

Historical estimates are particularly valuable when the archive contains high-quality data from well-instrumented systems with comprehensive outcome tracking. Systems that have operated for extended periods accumulate substantial historical evidence, enabling accurate predictions for routine alerts. However, for novel alert types or unprecedented manifold regions with little historical data, the historical estimate may be unreliable or uninformative, reducing to neutral values near 0.5 when no similar cases exist.

A Bayesian fusion processor 440 synthesizes the three independent probability estimates into a coherent posterior distribution that quantifies both the expected success probability and the uncertainty surrounding that estimate. Rather than arbitrarily averaging the three estimates or selecting one as authoritative, the fusion processor implements principled Bayesian inference using the Beta-Bernoulli conjugate family, which enables closed-form updates and intuitive interpretation.

The initialization from geometric prior establishes the starting point for Bayesian updating by converting the geometric feasibility prior φπ(x₀) into parameters of a Beta distribution. The Beta distribution Beta(α, β) is a continuous probability distribution on [0, 1] commonly used to represent beliefs about unknown probabilities. The initialization sets α₀=k·φπ(x₀) and β₀=k·(1−φπ(x₀)), where k represents the strength of the prior expressed as pseudo-counts. Higher k values (e.g., k=100) indicate strong confidence in the geometric prior, making it difficult for subsequent evidence to substantially shift the posterior. Lower k values (e.g., k=10) express weaker prior confidence, allowing evidence to have greater influence. The choice of k balances the reliability of geometric analysis against the informativeness of simulation and historical data. For systems with well-calibrated geometric models, k=50 is typical. For systems with less certain geometry, k=20 allows evidence to dominate. The mean of the initialized prior is α₀/(α₀+β₀)=φπ(x₀), exactly matching the geometric feasibility estimate.

The rollout evidence update incorporates results from the stochastic simulation by treating each rollout as providing fractional observations weighted by importance. Rather than incrementing α and β by integer counts of successes and failures, the update adds the importance-weighted sum of success indicators Σ wiYi to α and the importance-weighted sum of failure indicators Σ wi(1−Yi) to β. This weighted update correctly accounts for the adversarial bias in the rollout distribution, ensuring that trajectories sampled from biased distributions contribute appropriately to the posterior. If 1000 rollouts were executed with 730 successes and total importance weights summing to 850, the update would add approximately 620 to α and 230 to β, shifting the posterior toward higher success probability.

The historical adjustment incorporates the historical kernel estimate as additional pseudo-observations with strength controlled by parameter λ. The adjustment adds λ·\hat{p}ₕᵢₛₜ to α and λ·(1−\hat{p}ₕᵢₛₜ) to β, treating the historical estimate as equivalent to λ observations worth of data. The parameter λ determines how much influence the historical archive has relative to geometric analysis and rollouts. Typical λ values range from 10 to 100. When historical data quality is high and the archive contains many relevant cases, larger λ values appropriately increase historical influence. When the archive is sparse or contains primarily outdated data, smaller λ values prevent unreliable historical estimates from dominating the posterior. Some implementations adapt λ dynamically based on the number of similar historical cases retrieved and their average similarity weights, automatically reducing historical influence when few relevant cases exist.

The final posterior 444 emerges from these sequential updates as pπ(x₀)~Beta(α, β), where α and β have been incremented through geometric initialization, rollout evidence, and historical adjustment. The Beta distribution provides a complete probabilistic description of beliefs about mitigation success probability, not just a point estimate. This distribution enables computation of credible intervals, hypothesis tests, and risk-sensitive decision making that accounts for uncertainty.

The posterior statistics formula 445 extracts key summary measures from the Beta posterior. The posterior mean \hat{p}π(x₀)=α/(α+β) provides the expected success probability, which serves as the primary metric for triage decisions. The variance Var=(α·β)/((α+β)²(α+β+1)) quantifies uncertainty, with lower variance indicating higher confidence. Credible intervals are computed using Beta quantile functions, with the 90% interval [Beta_{0.05}(α,β), Beta_{0.95}(α,β)] providing the range within which the true success probability lies with 90% confidence. The effective sample size α+β indicates the total amount of evidence incorporated, with larger values producing tighter distributions and smaller credible intervals.

The posterior probability distribution display 450 enables visualization of the result of Bayesian fusion for operator interpretation and decision support. For example, it may present a posterior with parameters α=73 and β=27, yielding posterior mean \hat{p}_{π}=0.73. This indicates that after integrating geometric analysis, rollout simulations, and historical data, the system estimates a 73% probability that the mitigation policy will successfully resolve the alert.

A probability bar can provide intuitive visualization of this estimate using a gradient from white (certain failure) through gray to black (certain success). The posterior mean can be marked by a vertical line at the 73% position, clearly indicating the expected success probability. The credible interval [0.65, 0.81] is shown as a shaded region beneath the probability bar, indicating that despite the point estimate of 73%, there remains uncertainty such that the true success probability could plausibly range from 65% to 81% with 90% confidence. The 16-percentage-point width of this interval reflects moderate uncertainty due to limited evidence; had thousands of rollouts and extensive historical data been available, the interval would be narrower.

Various confidence metrics provide quantitative details about the posterior distribution. The posterior mean of 0.73 is restated with interpretive context (73% success probability). The 90% credible interval [0.65, 0.81] may be explicitly shown with bounds. The effective sample size α+β=100 indicates that the posterior is based on evidence equivalent to 100 observations, providing reasonable statistical precision. The uncertainty σ=0.044 is the posterior standard deviation, indicating a relatively tight distribution where the bulk of probability mass lies within ±0.088 (two standard deviations) of the mean.

A triage gating decision system 460 implements the final step of prediction-driven triage by routing alerts to one of three disposition paths based on posterior probability thresholds and doctrinal policies. This gating logic embodies the core value proposition of the prediction system: automatically resolving high-confidence cases to reduce operator burden while escalating uncertain or low-confidence cases to ensure appropriate human oversight.

The auto-mitigation path 461 is selected when the posterior mean \hat{p}_{π} exceeds the auto-mitigation threshold θₐᵤₜₒ, typically set around 0.85. This threshold reflects the organizational risk tolerance for automated decision-making. A threshold of 0.85 means the system will only execute mitigations autonomously when estimated success probability exceeds 85%, providing a substantial safety margin above pure uncertainty (e.g., 50%). When this path is selected, the system executes mitigation policy π, applying the prescribed control actions to resolve the alert without operator involvement. The alert is suppressed from operator displays to avoid notification fatigue, though the decision and subsequent outcome are logged for system learning and audit purposes. Auto-mitigation is particularly valuable for routine alerts that occur frequently and have well-understood resolution procedures, such as minor network anomalies, transient sensor errors, or benign mechanical vibrations. By handling these cases automatically, the system dramatically reduces operator workload, enabling humans to focus on genuinely ambiguous or critical situations.

The human escalation path 462 is selected when the posterior mean falls in the intermediate range θₕᵤₘₐₙ≤\hat{p}_{π}≤θₐᵤₜₒ, typically 0.5 to 0.85. This range represents cases where mitigation success is plausible but not sufficiently certain to warrant automatic execution. Alerts following this path are presented to operators through alert cards displaying the full posterior distribution including mean estimate, credible intervals, contributing evidence from geometry/rollouts/history, reasoning pathways explaining why success is uncertain, and recommended mitigation policy with caveats. The operator reviews this information and makes the final decision about whether to execute the recommended mitigation, attempt an alternative approach, or escalate further. This human-in-the-loop mode preserves operator agency for moderately difficult cases while providing substantial decision support through quantified uncertainty and traceable reasoning. For the example with \hat{p}π=0.73, this alert would follow the human escalation path, presenting the operator with a clear indication that the mitigation is likely to succeed (e.g., 73%) but carries non-trivial failure risk (27%), along with the credible interval showing the range of plausible outcomes.

The immediate escalation path 463 is selected when the posterior mean \hat{p}π falls below the human escalation threshold θₕᵤₘₐₙ, typically 0.5. This indicates that available evidence suggests the recommended mitigation is more likely to fail than succeed, or at best offers coin-flip odds. Such cases receive priority escalation to ensure rapid human attention, potentially triggering multi-operator review for high-stakes situations, consideration of fail-safe actions that prevent escalation even if mitigation fails, and emergency protocols if the alert involves safety-critical systems or security threats. Immediate escalation ensures that genuinely difficult or dangerous situations receive appropriate resources and oversight rather than automated responses that are likely to prove ineffective or counterproductive.

To illustrate how the prediction-driven triage system works in practice, imagine a water treatment facility monitoring pump health across multiple stations. The system detects unusual vibration and temperature patterns from Pump #7, generating an alert. The facility has three options: automatically reduce pump speed (the standard fix), call a technician to decide, or immediately shut down the pump. The question is which option makes the most sense given the available information.

The system evaluates whether the standard fix will work by checking three different sources of information simultaneously. The geometric reachability estimator examines where the pump currently sits in the alert space and asks whether there is a reasonable path from the current state to a fixed state. Think of this like looking at a map and seeing if you can get from your current location to your destination. For Pump #7, the system sees that the current vibration and temperature combination is in a tricky part of the map. Getting from unusual vibration plus rising temperature to normal operation requires navigating through an area where small changes can cause big problems. It's like trying to drive through a narrow mountain pass—technically possible, but risky. Based purely on the map geometry, the system gives this about a 45% chance of working.

The rollout simulator is like running the scenario 1000 times in a video game to see what happens. The system creates 1000 virtual versions of Pump #7, applies the speed reduction to each one, and adds realistic random variations such as sensor noise, slight temperature fluctuations, and minor electrical variations. It even deliberately adds worst-case scenarios—what if the temperature spikes right as we reduce speed? What if vibration temporarily increases during the transition? Out of 1000 simulations, 680 end up with the pump running normally, while 320 end up worse, resulting in either pump failure or emergency shutdown. This gives a 68% success rate from the simulations, which is better than the geometric estimate suggested.

The historical estimator searches the facility's memory for similar situations. It finds 38 times in the past three years when pumps showed similar patterns. In those 38 cases, 24 times the speed reduction worked fine, while 14 times it did not work and the pump either failed during the reduction or had to be shut down anyway. The closest match was Pump #3 last summer, which had almost identical symptoms. That time, reducing speed did fix the problem, and the pump ran for another eight months before scheduled maintenance.

The system now has three opinions: geometry says 45% chance of success, simulations say 68% chance of success, and history says 63% chance of success. Rather than just averaging these numbers, which would give 59%, the system uses Bayesian fusion to weigh them intelligently. The geometric estimate gets less weight because it's more theoretical. The simulations get substantial weight because they tested specific scenarios. History gets good weight because it reflects real-world outcomes. After weighing everything, the system settles on a 65% success probability with a confidence range of 58-72%. In plain English: this fix will probably work, but there's a meaningful chance it won't.

The triage gating logic then applies simple rules. If the probability is greater than 85%, the system automatically fixes the problem without bothering the operator. If the probability is between 50% and 85%, it shows the alert to a human operator with all the details. If the probability is less than 50%, it triggers immediate escalation to senior staff. At 65%, this alert falls in the middle zone. The system displays an alert card to the operator showing the recommended action to reduce speed to 80%, the success probability of 65% indicating likely but uncertain outcome, and the confidence range of 58-72%. The card explains why this estimate was reached: simulations showed 68% success based on 680 out of 1000 trials, past cases showed 63% success based on 24 out of 38 similar events, and geometry suggested only 45% due to a tricky transition path. The most similar past case was Pump #3 in July 2024 with the same symptoms where speed reduction was successful. The card also notes that if the mitigation fails, the consequences would be pump seizure, a 4-hour production stop, and approximately $12,000 in repair costs.

The operator sees this information and makes an informed choice. She decides to try the speed reduction because it probably works (65% is decent odds), the similar case with Pump #3 worked, the consequences of failure aren't catastrophic, and immediate shutdown would definitely stop production. She approves the automatic speed reduction. The system executes it, gradually lowering pump speed over 5 minutes while monitoring vibration. The vibration decreases, temperature stabilizes, and the pump continues running normally, resulting in a successful outcome.

Compare this to a different scenario that occurs the same day. Alert #2 appears for Reactor Vessel B showing unusual pressure patterns. The system runs the same three checks and arrives at very different conclusions. Geometry suggests only 12% success because there is a very difficult path through dangerous territory. Simulations show 31% success because most simulations end in failure. History indicates 28% success because only 9 of 32 similar cases succeeded in the past. The combined estimate is 27% success probability with a range of 22-33%.

This falls below the 50% threshold, triggering immediate escalation. The system displays a priority alert noting that the recommended action of gradual feed reduction has only a 27% success probability, likely to fail. The card includes a prominent warning that this is a low confidence situation likely to result in failure. The explanation shows why this estimate was reached: simulations produced only 31% success with just 310 out of 1000 trials succeeding, past cases showed 28% success with only 9 out of 32 attempts succeeding, and geometry indicated just 12% due to a very difficult transition. The most similar past case was Reactor B in January 2024 with the same symptoms, where gradual reduction failed and required emergency shutdown resulting in 12 hours of downtime. The risk assessment notes that if this mitigation fails, there is potential for vessel damage, safety hazards, and 18 hours of shutdown.

The senior supervisor sees this alert and immediately recognizes this is not a routine situation. With only 27% success odds and a very similar past failure on record, she decides to skip the risky gradual approach and execute a controlled emergency shutdown following safe procedures. This decision accepts the production loss but avoids the 73% chance of a worse outcome that could involve equipment damage or safety incidents.

The key benefit of this prediction system becomes clear when comparing these two scenarios. Without prediction-driven triage, both alerts would look similar—just abnormal readings detected. Operators might treat them the same way, or make decisions based on gut feel or incomplete information. The prediction-driven triage system automatically handles the easy cases where success probability exceeds 85%, provides clear guidance for medium cases where success probability falls between 50% and 85%, escalates the dangerous cases where success probability is below 50%, shows its reasoning so humans can make informed decisions, and learns from every outcome to improve future predictions. The mathematical computations happening behind the scenes enable these capabilities, but from the operator's perspective, it's simply a system that says “this will probably work” or “this will probably fail” with clear supporting evidence, turning confusing alerts into actionable intelligence. The operator doesn't need to understand Beta distributions or geodesic distances; they see probability estimates, confidence ranges, similar past cases, and clear risk assessments that enable sound decision-making under uncertainty.

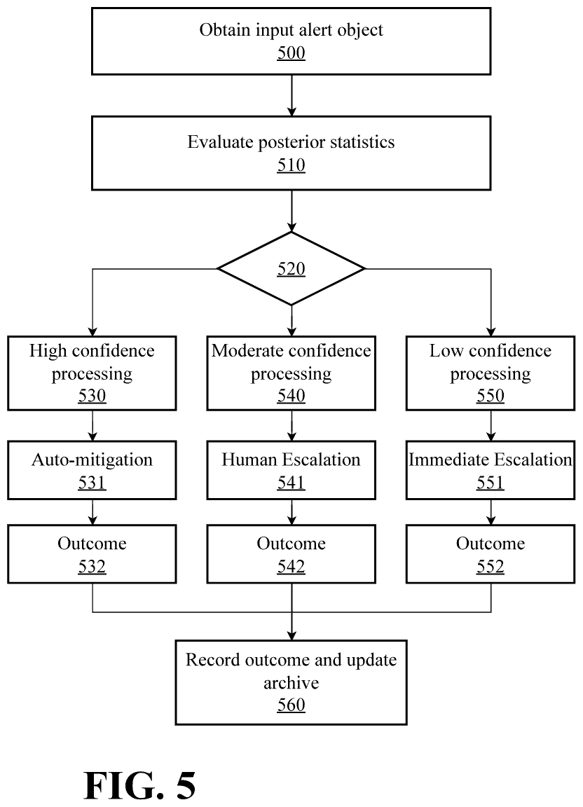

FIG. 5 is a flow diagram illustrating an exemplary gating logic method that routes alerts to one of three disposition regimes based on posterior probability thresholds, enabling suppression of high-confidence cases through automatic mitigation, human escalation for moderate-confidence cases requiring operator judgment, and immediate escalation for low-confidence cases presenting significant risk.

An alert input is obtained at step 500 which represents an enriched alert object Am from mesoscale manifold M₂ that has completed the prediction-driven triage analysis described herein. This alert may comprise the posterior probability distribution pπ(x₀)~Beta(α,β) quantifying the estimated likelihood that applying mitigation policy π from current state x₀ will successfully resolve the alert condition. The input also includes all contextual tags, provenance metadata, reasoning pathways, and credible interval bounds generated during the fusion process.

The posterior evaluation process at step 510 extracts key statistical measures from the Beta distribution to support gating decisions. The processor computes the posterior mean \hat{p}π(x₀)=α/(α+β), which serves as the primary metric for threshold comparison. This mean represents the expected success probability and provides a single scalar value summarizing the system's confidence in mitigation effectiveness. The processor also computes the credible interval using Beta quantiles, typically the 90% interval [Beta_{0.05}(α,β), Beta_{0.95}(α,β)], which bounds the plausible range of true success probabilities. The width of this interval indicates the degree of uncertainty, with narrow intervals suggesting high confidence in the estimate and wide intervals indicating substantial uncertainty requiring more cautious handling.

The evaluation processor assesses overall confidence through the posterior standard deviation σ=√(αβ/((α+β)²(α+β+1))), which quantifies distributional spread. Lower standard deviation values indicate tighter agreement among the geometric, rollout, and historical evidence sources, while higher values suggest conflicting evidence or sparse data requiring careful review. The processor also checks doctrinal constraints defined in the policy layer (FIG. 3), verifying that any automated actions comply with organizational rules regardless of statistical confidence. For example, alerts tagged as “SAFETY-CRITICAL” may be subject to mandatory human review even if posterior probabilities exceed normal auto-mitigation thresholds, ensuring that safety-related decisions always receive appropriate oversight.

The threshold comparison decision point 520 represents the central branching logic where alerts are routed to one of three disposition paths. This decision is implemented as a simple comparison operation evaluating the posterior mean \hat{p}π(x₀) against two configurable thresholds: θₕᵤₘₐₙ defining the minimum confidence for human escalation versus immediate priority escalation, and θₐᵤₜₒ defining the minimum confidence for automatic mitigation versus human escalation. The decision point employs a diamond-shaped flowchart symbol indicating branching logic with three possible outcomes corresponding to the three confidence regimes.

The threshold values are not fixed constants but configurable parameters that organizations adjust based on operational requirements, risk tolerance, regulatory constraints, and domain characteristics. The configuration process balances competing objectives including minimizing operator burden by handling routine cases automatically, ensuring appropriate human oversight for uncertain or high-stakes decisions, preventing automated execution of actions likely to fail, and maintaining operational efficiency without compromising safety or quality. Organizations typically calibrate these thresholds through empirical analysis of historical alert outcomes, adjusting values to achieve target distributions across the three disposition paths.

The high confidence condition 530 is satisfied when the posterior mean exceeds the auto-mitigation threshold, formally \hat{p}_{π}>θₐᵤₜₒ. In typical configurations, this threshold is set at θₐᵤₜₒ=0.85, meaning that alerts with estimated success probability greater than 85% qualify for automatic resolution. This threshold reflects a balance between confidence and efficiency, setting the bar high enough to ensure reliability while still capturing a meaningful fraction of alerts that can be handled without human intervention. Different operational contexts may adjust this threshold based on consequence severity, with safety-critical systems potentially requiring θₐᵤₜₒ=0.95 for automated actions while routine administrative systems might accept θₐᵤₜₒ=0.75 to maximize automation benefits.

The auto-mitigation action sequence 531 executes when high confidence conditions are met, implementing fully automated alert resolution. The sequence begins by executing the recommended mitigation policy π, translating the high-level strategy defined in M₂ into specific control actions. These control actions are projected back to fast manifold M₁ through the immersion operator ι₂→₁ described in FIG. 3, ensuring that all physical interventions remain grounded in sensor-level evidence and respect geometric constraints derived from the latent manifold structure. For example, if the alert involves mechanical anomalies and policy π prescribes load reduction, the immersion operator converts this into specific motor speed commands, valve position adjustments, or process flow modifications appropriate for the physical system.

The action sequence monitors execution outcomes in real-time, tracking whether control actions achieve their intended effects and whether the alert state evolves toward the success basin S or unexpectedly moves toward failure basins. This monitoring provides immediate feedback about mitigation effectiveness, enabling the system to detect execution failures quickly and trigger fallback procedures if automated mitigation does not proceed as predicted. The sequence suppresses operator notification, meaning that no alert card is displayed and no human interruption occurs, recognizing that high confidence in success makes human oversight unnecessary for routine resolution. However, all execution details are comprehensively logged, recording the alert state, applied policy, intermediate system responses, and final outcomes. These logs support subsequent analysis, enable quality assurance audits, and provide training data for continuous system improvement.

The suppressed outcome 532 represents the terminal state for alerts resolved through auto-mitigation. From the operator's perspective, these alerts never appear on monitoring displays, allowing human attention to remain focused on cases requiring judgment rather than being distracted by routine issues that the system handles competently. The alert is considered resolved without human intervention, though automated monitoring continues to ensure that the mitigation achieved lasting effect rather than temporary symptom suppression. If post-mitigation monitoring detects recurring anomalies or delayed failures, the system can generate follow-up alerts that may route to human escalation paths, ensuring that unsuccessful automated attempts eventually receive appropriate review.

The moderate confidence condition 540 is satisfied when the posterior mean falls between the two thresholds, formally θhᵤₘₐₙ≤\hat{p}_{π}≤θₐᵤₜₒ. Using exemplary threshold values, this corresponds to the range 0.50≤\hat{p}_{π}≤0.85, representing cases where mitigation success is plausible but not sufficiently certain to warrant automatic execution. This middle regime captures alerts exhibiting meaningful ambiguity, where geometric analysis, rollout simulations, and historical evidence provide mixed signals or where uncertainty bounds remain wide despite fusion of multiple information sources. These cases benefit from human judgment, pattern recognition, contextual knowledge, and decision-making capabilities that complement the quantitative probability estimates.

The human escalation action sequence 541 presents alerts to operators through structured alert cards that provide comprehensive decision support while preserving human agency. The sequence generates an alert card displaying the posterior mean \hat{p}π prominently, ensuring that operators immediately see the estimated success probability. This probability is presented not as a deterministic prediction but as a probabilistic assessment acknowledging inherent uncertainty. The card displays the credible interval bounds, typically showing both a central probability bar indicating the mean and shaded regions or numerical ranges showing the 90% credible interval. This presentation helps operators understand not just what the system predicts but how confident that prediction is, enabling risk-appropriate decision-making.

The alert card shows contributing evidence from all three estimation methods described herein. The geometric feasibility prior, rollout success rate, and historical success rate are presented individually, allowing operators to understand why the overall estimate reached its particular value and whether the different evidence sources agree or conflict. For example, an alert with \hat{p}_{π}=0.65 might show geometric feasibility of 0.45, rollout success of 0.68, and historical success of 0.72, immediately revealing that geometric analysis is more pessimistic than simulation or history suggests. This breakdown enables operators to apply their domain expertise in interpreting the evidence, potentially recognizing that geometric pessimism reflects outdated manifold structure or that historical optimism reflects changed operational conditions.

The card presents reasoning pathways generated during alert enrichment (FIG. 3), showing the primary hypothesis about alert causes and mitigation mechanisms, alternative hypotheses with their associated probabilities, counterfactual scenarios explaining what would happen without mitigation or with delayed action, and sensitivity analyses indicating which factors most influence success probability. This reasoning transparency enables operators to evaluate whether the system's logic aligns with their understanding of the physical situation and whether any important factors have been overlooked. The alert card awaits operator decision, implementing a synchronous interaction model where the alert remains displayed until the operator explicitly approves the recommended mitigation, selects an alternative approach, or requests additional information or consultation.

Once the operator makes a decision, the system executes the approved action following the same control projection mechanisms used in auto-mitigation but with explicit human authorization. The operator's decision, including any modifications to the recommended policy and the reasoning behind the choice, is logged alongside the alert data for future analysis. This human-in-the-loop process ensures that moderately uncertain cases receive appropriate oversight while providing operators with sophisticated analytical support that enhances rather than replaces human judgment.

The operator decision outcome 532 represents the terminal state for human-escalated alerts, where resolution occurs through collaborative human-machine decision-making. The operator has reviewed evidence, considered system recommendations, applied personal expertise and contextual knowledge, and made an informed choice about how to proceed. This outcome ensures that neither human intuition nor machine calculation dominates inappropriately; instead, each contributes its strengths to produce better decisions than either could achieve independently. The logged operator decisions also provide valuable training signal for system improvement, as patterns in human overrides or modifications to system recommendations can reveal systematic biases or blind spots in the automated prediction methods.

The low confidence condition 550 is satisfied when the posterior mean falls below the human escalation threshold, formally \hat{p}_{π}<θₕᵤₘₐₙ. With typical configuration θₕᵤₘₐₙ=0.50, this corresponds to cases where the estimated success probability is less than 50%, indicating that available evidence suggests the recommended mitigation is more likely to fail than succeed. This regime captures genuinely difficult situations where the system lacks confidence in its ability to resolve the alert through standard procedures. These cases require not just human involvement but urgent, high-level attention, as they represent scenarios where inadequate response could lead to significant adverse consequences.

The immediate escalation action sequence 551 implements priority notification protocols that ensure rapid engagement of appropriate expertise. The sequence routes the alert to supervisory personnel rather than general operators, recognizing that low-confidence scenarios may require decision authority, specialized knowledge, or resource allocation beyond typical operator scope. Priority notification bypasses normal queue processing, potentially triggering audible alerts, highlighted displays, or direct communication channels to ensure immediate awareness. For safety-critical or security-sensitive alerts, the sequence may simultaneously notify multiple individuals or teams, enabling parallel analysis and coordinated response.

The action sequence displays full diagnostic data rather than simplified alert cards, providing supervisors with comprehensive information for evaluating complex situations. This diagnostic display includes complete trajectory visualizations showing how the alert state evolved through the latent manifold, detailed breakdowns of all three probability estimates with their underlying calculations and assumptions, complete provenance chains tracing the alert from raw sensor inputs through encoding and enrichment, and all reasoning pathways including those assigned low probabilities but potentially relevant for understanding failure modes. The goal is to provide supervisors with sufficient information to independently assess the situation rather than relying solely on system recommendations.

The sequence flags high failure risk prominently, ensuring that supervisors immediately understand they are dealing with a scenario where standard approaches are unlikely to succeed. This flagging prevents supervisors from casually approving system recommendations without careful evaluation. The sequence suggests alternative policies beyond the primary recommendation, drawing on the policy library to identify approaches that might offer better success probability or different risk profiles. These alternatives might include more conservative strategies accepting suboptimal performance to ensure safety, experimental approaches for novel situations where historical data provides little guidance, or escalation to emergency protocols designed for worst-case scenarios.

The action sequence prompts consideration of fail-safe actions that mitigate consequences even if primary mitigation fails. For mechanical systems, fail-safe options might include activating backup equipment, isolating affected subsystems, or transitioning to degraded operational modes. For cybersecurity alerts, fail-safe actions might include network segmentation, credential rotation, or activating additional monitoring. For safety-critical scenarios, fail-safe options might include personnel evacuation, automated shutdown sequences, or activation of containment systems. The explicit prompt to consider fail-safe measures ensures that risk mitigation occurs even when primary resolution proves infeasible.

The sequence enables multi-operator review for particularly challenging cases, facilitating collaboration among multiple subject matter experts. This might involve synchronous video conferencing for urgent situations or asynchronous review workflows for complex problems requiring detailed analysis. Multi-operator review distributes decision responsibility, reduces the risk of single-point errors, and brings diverse perspectives to difficult problems. The collaborative review process is logged and time-stamped, providing accountability and enabling post-incident analysis of decision-making processes.

The senior review outcome 552 represents the terminal state for immediately escalated alerts, where resolution occurs through expert evaluation of high-risk scenarios. Supervisors have assessed the situation using comprehensive diagnostic information, considered multiple response options including fail-safe alternatives, and made decisions appropriate for the risk level and operational context. This outcome ensures that the most difficult and dangerous situations receive appropriate human attention and decision authority, preventing automated systems from attempting resolutions likely to fail or escalate problems further.

All three disposition paths converge to the outcome recording and archive update process at step 560, which implements the feedback loop enabling continuous system improvement. This processor logs complete information about each alert including the initial state x₀ in the mesoscale manifold, the mitigation policy π that was applied (whether automatically, through operator selection, or via supervisor decision), and the binary outcome y∈{0, 1} indicating ultimate success or failure in resolving the alert condition. Success is defined as achieving transition to the success basin S with sustained stability, while failure indicates either transition to a failure basin or recurring anomalies despite mitigation attempts.

The step updates the historical archive A by adding the new tuple (x₀, π, y) to the collection of past cases. This continuously growing archive directly improves historical kernel estimator 430, providing ever more comprehensive evidence for future probability estimates. As the archive grows, predictions become more reliable for common alert types and operational regimes while also enabling detection of emerging patterns or changing system behaviors that invalidate historical assumptions.

The method computes actual success and failure metrics by aggregating outcomes across different alert types, confidence regimes, and operational contexts. These metrics reveal whether the system's probability estimates are well-calibrated (meaning that alerts assigned 70% success probability actually succeed approximately 70% of the time), whether specific categories of alerts exhibit systematic prediction biases, and whether temporal trends indicate changing system behavior requiring model updates. The processor updates prediction accuracy statistics that quantify overall system performance, such as false positive and false negative rates for each confidence regime, average posterior probability for successful versus failed mitigations, and calibration curves plotting predicted versus actual success rates.

Based on these statistics, the step triggers threshold recalibration if systematic deviations from target performance metrics are detected. For example, if auto-mitigated alerts (those exceeding θₐᵤₜₒ) exhibit success rates substantially below the threshold value, indicating that the system is overconfident in its predictions, the processor may recommend increasing θₐᵤₜₒ to restore appropriate conservatism. Conversely, if human-escalated alerts (those between θₕᵤₘₐₙ and θₐᵤₜₒ) succeed at rates consistently exceeding 0.90, the system may recommend raising θₐᵤₜₒ to capture more cases for automatic handling, reducing operator burden without compromising reliability. This adaptive threshold adjustment ensures that the gating logic remains well-tuned to actual system performance rather than relying on fixed thresholds that may become inappropriate as operational conditions evolve.

A terminal endpoint marks the completion of the alert lifecycle. The alert has been evaluated, routed to an appropriate disposition path, processed through either automatic mitigation or human review, and ultimately resolved with outcomes recorded for system learning. The clean termination ensures that system resources are released and that attention can shift to subsequent alerts requiring evaluation. The end state does not imply that monitoring ceases; rather, it indicates that the immediate alert lifecycle is complete, though ongoing surveillance may detect delayed failures or recurring issues that trigger new alert instances.

According to some embodiments, the auto-mitigation threshold θₐᵤₜₒ has a typical value of 0.85 (85% confidence), meaning that policies estimated to succeed with greater than 85% probability qualify for automatic execution. This threshold is configured based on multiple factors including organizational risk tolerance for automated decision-making, the consequence severity of potential mitigation failures, regulatory requirements that may mandate human oversight for certain types of actions, and operator workload considerations that motivate maximizing automation to preserve human attention for cases requiring judgment. High-risk domains such as nuclear power or aviation may set θₐᵤₜₒ=0.95 or higher, accepting reduced automation in exchange for enhanced safety assurance. Lower-risk domains such as network traffic optimization or routine IT operations may set θₐᵤₜₒ=0.75, accepting slightly higher failure rates to maximize operational efficiency.

The human escalation threshold θₕᵤₘₐₙ has a typical value of 0.50 (50% confidence), establishing the boundary between cases requiring standard operator review and those demanding immediate supervisory attention. This threshold is configured based on domain expertise availability (whether sufficient qualified operators are available to handle moderate-volume escalations), false positive cost (the burden of presenting operators with alerts that ultimately prove benign or easily resolved), and failure consequence severity (whether failed mitigations in the moderate confidence range pose acceptable risks or require more aggressive escalation). Domains with abundant operator expertise and moderate consequence severity may set θₕᵤₘₐₙ=0.40, accepting more human escalations to catch a broader range of uncertain cases. Domains with limited personnel or severe failure consequences may set θₕᵤₘₐₙ=0.60, narrowing the human escalation band to ensure that only genuinely ambiguous cases undergo operator review while clearly difficult cases escalate immediately to expert supervision.

The hysteresis band Δθ introduces a buffer zone around threshold boundaries to prevent oscillatory behavior where alerts near threshold values might repeatedly cross boundaries due to minor variations in probability estimates. A typical hysteresis band of 0.05 (5%) means that once an alert is assigned to a particular disposition path, subsequent minor updates to the posterior probability do not trigger reclassification unless the probability changes by at least 5 percentage points. This stability prevents disruptive rapid switching between disposition modes and provides operators with consistent alert presentations even when underlying probabilities fluctuate slightly as additional evidence arrives. The hysteresis band is particularly important during online learning scenarios where threshold values themselves may shift gradually over time; the buffer ensures that these gradual adjustments do not cause large numbers of alerts to suddenly switch disposition regimes, which could overwhelm operators with unexpected alert volume changes.

The configuration factors described herein are to guide practitioners in selecting appropriate threshold values for their specific deployment contexts. These factors are not rigid rules but rather considerations that organizations weigh collectively to arrive at threshold configurations that balance automation benefits, human oversight needs, safety requirements, and operational efficiency. Periodic review and adjustment of these thresholds based on accumulated performance data ensures that the gating logic remains appropriately tuned as systems evolve, operational procedures change, and organizational priorities shift.

Through this comprehensive gating logic, the system implements intelligent alert disposition that automatically handles high-confidence routine cases, engages human operators for moderately uncertain situations requiring judgment, and escalates low-confidence high-risk scenarios to expert supervision.

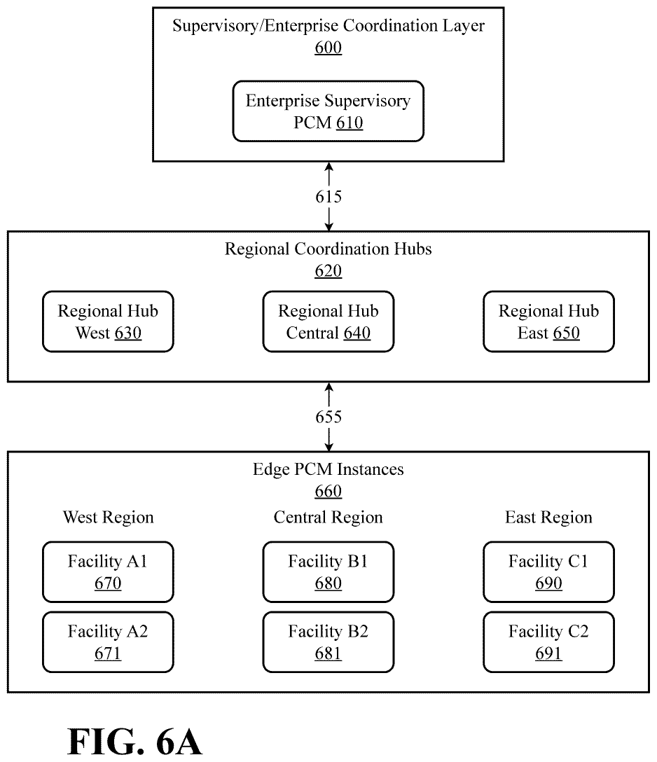

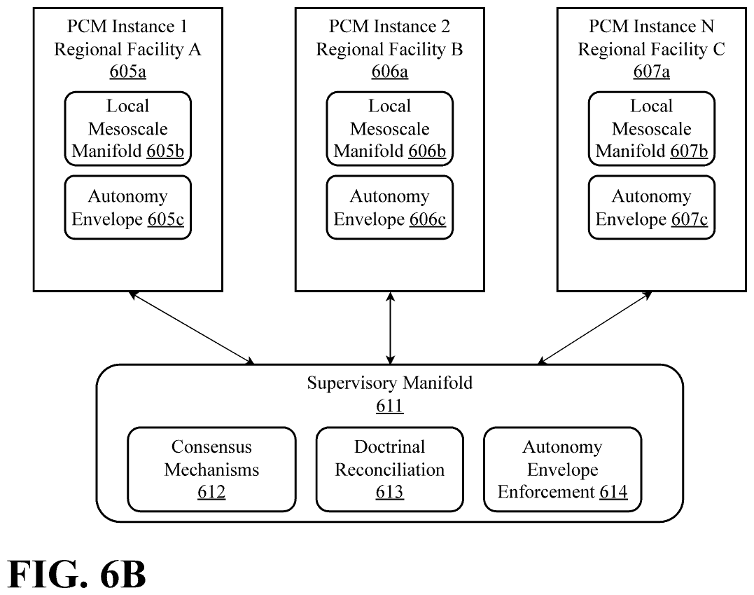

FIG. 6A is a block diagram illustrating an exemplary high-level federated PCM architecture and deployment topology, according to an embodiment. The exemplary implementation demonstrates how multiple PCM instances are organized in a hierarchical multi-layer structure spanning edge facilities, regional coordination hubs, and enterprise-wide supervisory control, enabling scalable alert management across geographically distributed infrastructure while maintaining local autonomy and coordinated response capabilities.

The federated PCM architecture implements a multi-tier hierarchical organization that balances local autonomy with coordinated oversight. This structure enables individual facilities to process sensor data and respond to alerts in real-time while providing mechanisms for regional correlation of related events and enterprise-wide strategic coordination when patterns span multiple sites. The hierarchy reflects both physical deployment topology and logical information flow, with each layer operating at characteristic timescales and serving distinct functional roles within the overall system.

A supervisory layer 600 comprises the highest level of the federated architecture, providing enterprise-wide coordination and strategic oversight across all regional hubs and edge instances. This layer operates at the slowest timescale, typically processing information and making decisions over intervals (e.g., 100-500 milliseconds), which is appropriate for strategic analysis and policy distribution but too slow for real-time sensor response.

The enterprise supervisory PCM 610 serves as the apex coordinator for the entire federated network. This instance maintains a comprehensive view of alert patterns across all facilities, enabling detection of coordinated threats, systematic failures, or enterprise-wide trends that would be invisible to individual facilities or regional hubs. The supervisory PCM may implement federated consensus coordination by managing the collective divergence functional described in FIG. 6B, ensuring that alert semantics remain consistent across the federation even as local instances evolve independently. Doctrinal policy enforcement occurs at this level, where enterprise security policies, regulatory requirements, and operational standards are translated into constraint manifolds that govern alert handling across all subordinate instances.

Cross-regional threat correlation represents a critical capability of the supervisory layer, identifying patterns where seemingly unrelated alerts at different facilities actually represent coordinated adversarial activity or cascading system failures. For example, if multiple facilities across different regions simultaneously detect unusual network traffic patterns, the supervisory PCM correlates these observations and determines whether they represent independent local issues or a coordinated enterprise-wide cyber intrusion. Strategic alert aggregation consolidates high-level summaries of operational status, enabling executive oversight without overwhelming decision-makers with facility-level detail. Autonomy envelope governance establishes and adjusts the divergence thresholds that determine when local instances must escalate decisions to higher authority, balancing operational efficiency with appropriate oversight.

The supervisory PCM is typically deployed in cloud infrastructure or enterprise data centers where computational resources, network connectivity, and redundancy meet requirements for strategic coordination. The 100-500 millisecond latency budget reflects both network propagation delays from geographically distributed facilities and the computational complexity of enterprise-wide analysis. Coverage spans the entire multi-site enterprise, potentially encompassing dozens of regional hubs and hundreds of edge instances across national or global operations.

The vertical communication pathways 615 implement bidirectional information flow between the supervisory layer and regional coordination hubs. Alert escalation flows upward when regional hubs detect patterns requiring enterprise-level coordination, such as cross-regional threats or situations exceeding regional autonomy envelopes. The escalation includes, but is not limited to, not raw sensor data but structured alert objects with posterior probabilities, contextual tags, and divergence metrics, preserving privacy while enabling effective coordination. Policy distribution flows downward as the supervisory PCM propagates doctrinal updates, threshold adjustments, or threat intelligence to regional hubs, which then cascade these updates to their associated edge instances. This bidirectional flow ensures that local operations remain aligned with enterprise strategy while enterprise decisions remain informed by operational realities.

A regional coordination layer 620 provides intermediate aggregation and correlation across groups of edge facilities within geographic or organizational regions. This layer operates at moderate timescales (e.g., 20-100 milliseconds), enabling real-time coordination among facilities while maintaining responsiveness for regional decision-making.

Regional Hub West 630 coordinates operations for 8-12 edge facilities in the western geographic region. The hub performs regional alert correlation, identifying patterns where multiple facilities within the region experience related anomalies suggesting common causes or coordinated events. For instance, if several ports along a coastline simultaneously detect unusual vessel traffic patterns, the regional hub correlates these observations to determine whether they represent independent commercial activity or coordinated suspicious behavior. Intermediate federation occurs as the hub manages fiber map alignment and divergence calculations among its associated edge instances, maintaining semantic consistency without requiring constant supervisory oversight. Load balancing distributes computational tasks among edge facilities based on current workload and resource availability, preventing any single facility from becoming overwhelmed while others remain underutilized.

Regional Hub Central 640 performs analogous coordination for facilities in the central geographic region, maintaining the same functional capabilities while adapting to the specific operational characteristics and threat profiles of its coverage area. Regional Hub East 650 coordinates eastern region facilities, completing the three-region coverage pattern illustrated in this exemplary architecture. The specific number of regional hubs is configurable based on enterprise size, geographic distribution, and operational requirements, with some deployments using more or fewer hubs depending on need.

Regional hubs are typically deployed in regional data centers providing lower latency to associated edge facilities than enterprise cloud infrastructure while offering greater computational resources and connectivity than edge deployments. The 20-100 millisecond latency budget enables rapid coordination among facilities while remaining responsive enough for time-sensitive regional decisions. Each hub covers 8-12 facilities, balancing management overhead against coordination effectiveness. Smaller coverage areas provide tighter coordination but require more hubs, while larger coverage areas improve efficiency but may sacrifice responsiveness.

The regional-edge communication pathways 655 implement bidirectional information flow between regional hubs and their associated edge PCM instances. Local alerts flow upward as edge instances detect anomalies requiring regional correlation or exceeding local autonomy envelopes. The alerts include posterior probability distributions, provenance metadata, and geometric position information enabling the regional hub to perform correlation analysis and divergence calculations. Regional directives flow downward as hubs distribute threshold updates, threat intelligence, and coordination instructions to edge facilities. For example, if the regional hub detects a coordinated cyber reconnaissance pattern, it issues defensive guidance to all associated edge instances even if only some have detected direct threats.

An edge PCM layer 660 comprises facility-level instances deployed directly at operational sites where sensors generate data and physical systems require monitoring and control. This layer operates at the fastest timescales, processing sensor inputs and generating control outputs with latencies under 5 milliseconds for example, enabling real-time response to rapidly evolving conditions.

Facility A1 670 represents a port terminal edge instance operating with full local autonomy. The PCM processes acoustic, optical, thermal, seismic, and cyber sensors monitoring cargo handling equipment, vessel operations, security systems, and network infrastructure. Local autonomy remains active, meaning the instance can detect anomalies, generate alerts, evaluate mitigation strategies, and execute automatic responses without awaiting regional or supervisory approval for routine cases. The sub-5-millisecond sensor latency ensures that control loops remain stable and responsive, critical for applications like crane control where delayed reactions could compromise safety or efficiency.

Facility A2 671 represents a power substation edge instance with similar autonomy and latency characteristics but monitoring different physical systems. The instance processes voltage and frequency measurements, transformer temperatures, breaker status indicators, and network traffic related to SCADA systems. The local autonomy enables rapid response to electrical transients or grid instabilities that require sub-second intervention to prevent cascading failures. Additional facilities within the West region, indicated as “plus 6-10 more sites,” extend coverage across the regional operational footprint.

Facility B1 680 represents a manufacturing plant edge instance in the Central region, monitoring production lines, robotic systems, quality control sensors, and facility automation networks. The local PCM detects equipment degradation, process deviations, and potential safety hazards, executing preventive interventions before failures occur. Facility B2 681 represents a data center edge instance monitoring server temperatures, power consumption, cooling system performance, and network security. The local autonomy enables rapid response to thermal excursions or security events without the delays inherent in remote coordination. Additional Central region facilities extend coverage across the region's operational sites.

Facility C1 690 represents a chemical plant edge instance in the East region, monitoring reactor conditions, pressure vessels, temperature gradients, flow rates, and safety systems. The criticality of chemical process control makes local autonomy and low latency essential, as hazardous conditions may develop within seconds and require immediate intervention. Facility C2 691 represents a distribution center monitoring logistics automation, warehouse climate control, security systems, and transportation fleet connectivity. Additional East region facilities complete the regional coverage.

The edge layer deployment employs embedded controllers or industrial computing platforms located physically at each facility, ensuring minimal network latency between sensors and processing. The real-time processing capability enables predictive maintenance, automatic fault response, and safety intervention at timescales matching physical system dynamics. Local sensor fusion combines multiple modalities before transmitting alerts to regional hubs, reducing network bandwidth requirements while preserving information content through geometric encoding.

The regional layer employs three coordination hubs in this three-region example, though enterprises may deploy more or fewer hubs based on geographic span and organizational structure. Regional servers provide greater computational resources than edge controllers, supporting alert correlation, divergence calculation, and federated consensus participation. Alert aggregation and pattern correlation at this layer reduce the information volume reaching the supervisory layer while preserving strategic insights.

The supervisory layer operates a single enterprise coordinator deployed on cloud infrastructure or enterprise data centers with substantial computational resources, redundancy, and connectivity. Strategic oversight and policy distribution at this layer enable enterprise-wide coherence without micromanaging facility operations. The hierarchical resource distribution achieves scalability by processing information at the lowest appropriate layer, escalating only when local or regional capabilities prove insufficient.

Various use case scenarios are imagined which illustrate how the hierarchical architecture adapts to different operational contexts, demonstrating the versatility of the federated PCM approach across diverse industries and mission requirements.

An exemplary maritime port security scenario deploys edge PCM instances at individual port terminals, each monitoring cargo operations, vessel traffic, access control systems, and cybersecurity infrastructure. Regional coordination spans harbor-wide operations, correlating events across 3-5 terminals to detect coordinated threats such as smuggling operations using multiple entry points or reconnaissance activities targeting multiple facilities. The supervisory layer connects to a national port security network, enabling threat intelligence sharing and coordinated response to threats spanning multiple ports or coastal regions. Federation enables detection of patterns invisible to individual terminals, such as adversaries systematically probing security across multiple ports to identify vulnerabilities.

An exemplary electric grid monitoring scenario positions edge instances at substations and generation facilities, monitoring equipment health, power quality, and cybersecurity. Regional coordination corresponds to transmission operators managing 8-12 substations within a geographic area, detecting localized grid instabilities and coordinating load balancing. The supervisory layer operates as the Independent System Operator overseeing the entire regional grid, detecting potential cascade failures and coordinating emergency response. Federation enables grid stability analysis that considers interactions among substations, preventing localized faults from propagating into widespread blackouts.

An exemplary industrial manufacturing scenario deploys edge PCM instances on production lines and major equipment, detecting quality deviations, equipment degradation, and process anomalies. Regional coordination operates at the plant level, correlating events across multiple production lines to identify systematic issues or supply chain problems. The supervisory layer resides in the corporate operations center, tracking manufacturing efficiency and quality across multiple plants, enabling best practice sharing and strategic resource allocation. Federation enables enterprise-wide quality management and predictive maintenance optimization.

An exemplary defense network operations scenario positions edge instances at forward operating bases and mobile platforms, monitoring threats, equipment status, and communications security. Regional coordination occurs at theater command centers, fusing intelligence from multiple forward positions to develop operational situational awareness. The supervisory layer operates at joint operations command, coordinating multi-theater operations and distributing strategic intelligence. Federation enables coordinated defense against sophisticated adversaries conducting operations across multiple geographic areas or targeting multiple installations simultaneously.

These scenarios demonstrate that while the technical architecture remains consistent across domains, the specific deployment scale, latency requirements, autonomy boundaries, and escalation criteria adapt to mission-specific needs. Maritime security emphasizes cross-facility threat correlation, electric grids prioritize cascade prevention, manufacturing focuses on quality and efficiency, and defense operations stress coordinated response to sophisticated threats. The federated PCM architecture accommodates these diverse requirements through configurable thresholds, adaptable autonomy envelopes, and domain-specific doctrinal policies while maintaining the underlying geometric framework and hierarchical coordination structure.

Through this multi-layer architecture, the federated PCM system enables scalability from small deployments with a handful of facilities to large enterprises with hundreds of sites, maintains local responsiveness while enabling coordinated oversight, preserves facility autonomy while ensuring doctrinal compliance, optimizes network bandwidth through hierarchical aggregation, and adapts to diverse operational domains through configurable policies and thresholds. The architecture transforms isolated facility monitoring into an integrated enterprise capability where local intelligence and strategic coordination combine to detect threats, prevent failures, and optimize operations across complex distributed infrastructure.

FIG. 6B is a block diagram illustrating some detailed mechanisms of federated PCM fabric coordination, according to an embodiment. This exemplary implementation demonstrates how fiber maps transport alert semantics between instances, divergence indices quantify alignment consistency, and autonomy envelopes govern when local instances require supervisory reconciliation.

PCM Instance 1 605a represents a regional facility maintaining its own mesoscale manifold M₂ⁱ 605b for local alert processing. The manifold contains alert objects positioned geometrically based on their semantic characteristics. Alert Am1ⁱ represents a pump vibration anomaly with state x₁ⁱ and contextual tags indicating mechanical issues requiring preventive action. Alert Am2ⁱ represents a network traffic spike with cyber monitoring tags. The autonomy envelope εᵢ 605c defines local decision authority boundaries, specifying that the instance can operate autonomously provided divergence with federated partners remains below 0.35, beyond which supervisory override is required.

PCM Instance 2 606a operates similarly at a different regional facility, maintaining manifold M₂^{j} 606b with its own alert objects. Alert Am1^{j} shows a similar vibration pattern, suggesting potential correlation with Instance i's mechanical alert. Alert Am2^{j} detects coordinated port scanning, indicating adversarial activity. The autonomy envelope εⱼ 606c establishes comparable decision boundaries.

PCM Instance N 607a represents a third facility with manifold M₂^{k} 607b. Alert Am1^{k} detects APT reconnaissance with critical security tags, potentially related to Instance j's cyber observations. The autonomy envelope εₖ 607c governs local authority.

A plurality of fiber maps implement the mathematical transformations that transport alert objects between PCM instances while preserving semantic structure. Fiber map transports alerts from Instance 2's manifold M₂^{j} to Instance 1's manifold M₂ⁱ. This transformation is not a simple coordinate translation but a structure-preserving map that accounts for differences in how each instance's manifold has evolved through local experience. The fiber map ensures that when Instance 1 receives alert information from Instance 2, it can interpret that information within its own geometric framework without loss of semantic meaning.

A divergence index table may be present and used to quantify how well alert semantics align across federated instances. For each instance pair, the table shows the fiber map used, which alerts are correlated, the computed divergence Dᵢⱼ, the autonomy envelope threshold εᵢⱼ, and the resulting alignment status.

The Instance 1 to 2 comparison shows divergence Dᵢⱼ=0.12 for mechanically similar alerts, well below the threshold of 0.35, resulting in ALIGNED status. This indicates both instances interpret similar pump vibration patterns consistently. The Instance 2 to N comparison shows divergence Dⱼₖ=0.28 for cyber alerts, approaching but still below the 0.35 threshold, resulting in MONITORING status. This elevated divergence suggests the instances are detecting related but not identical cyber patterns, warranting continued observation. The Instance 1 to N comparison shows divergence Dᵢₖ=0.08 for cross-domain alerts, indicating strong alignment even across different alert types.

Divergence is calculated as Dᵢⱼ(A)=dM₂ⁱ(Fᵢⱼ(A^{j}), Aⁱ), measuring the geodesic distance in Instance i's manifold between the fiber-mapped alert from Instance j and Instance i's own alert. Lower divergence indicates better semantic alignment, suggesting the instances have developed compatible geometric representations through shared experience or coordinated training.

The supervisory manifold M₃ 611 operates at a slower timescale than the regional instances, providing strategic coordination without micromanaging local operations. This layer implements three key governance mechanisms.

The federated consensus mechanism 612 minimizes collective divergence across all instance pairs by solving Cf_{ed}=Σ(i,j)wᵢⱼ·Dᵢⱼ (A)², where weights wᵢⱼ reflect the importance of alignment between specific instance pairs. The optimization uses distributed gradient descent where each instance locally updates its alert representations according to Am\hat{ }i←Am\hat{ }i−η∇C_{fed}, gradually converging toward consistent semantics across the federation without requiring centralized control.

Doctrinal reconciliation 613 addresses situations where divergence approaches or exceeds autonomy envelope thresholds. The example shows cyber alerts Am2^{j} and Am1^{k} with divergence Dⱼₖ=0.28 approaching the threshold εⱼₖ=0.35. The supervisor projects these alerts onto doctrinal constraint manifold C, enforcing the policy that “coordinated cyber threats require federated response.” This reconciliation coordinates Instances 2 and N to implement defensive measures despite their slightly different interpretations of the threat.

Autonomy envelope enforcement 614 implements the governance rule that divergence exceeding thresholds triggers escalation to supervisory reconciliation. The current monitoring shows all divergence indices below thresholds, allowing local instances to maintain autonomous operation. However, Dⱼₖ=0.28 at 80% of threshold triggers continued monitoring. If this divergence increases beyond 0.35, automatic escalation would require supervisory intervention to reconcile the conflicting interpretations before either instance takes independent action.

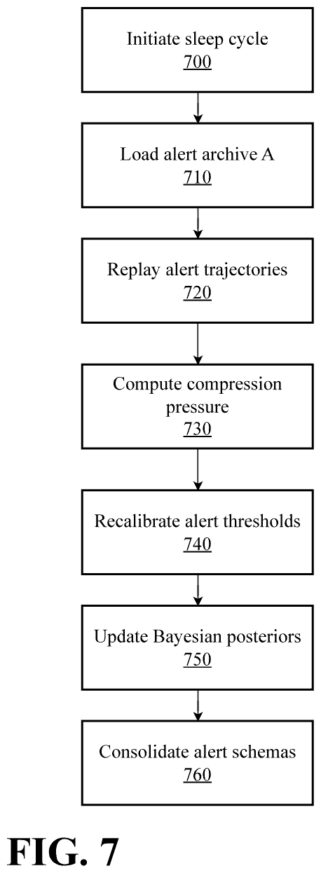

FIG. 7 is a flow diagram illustrating an exemplary method for implementing sleep-state recalibration of alert thresholds and priors through replay of archived alert trajectories, compression pressure analysis, and schema consolidation steps.

In a first step 700, the federated PCM systems initiates a sleep cycle for alert system recalibration. This sleep cycle may be triggered by multiple conditions including compression pressure spikes indicating manifold over-saturation, scheduled periodic recalibration cycles to maintain long-term adaptation, operator demand for system optimization, or detection of doctrinal drift across federated PCM instances. The sleep cycle represents a departure from real-time operational processing, enabling the system to perform computationally intensive analysis and optimization without latency constraints. Unlike wake-state operations that must complete within strict timing budgets (typically less than 100 milliseconds per alert cycle), sleep-state processing can extend across seconds, minutes, or hours depending on archive size and recalibration objectives. This temporal flexibility enables thorough geometric analysis, extensive trajectory replay, and comprehensive schema formation that would be impractical during operational alerting.

In a step 710, load the alert archive A comprising historical alert events with their complete trajectories, objects, and resolution outcomes. The archive is structured as A={(xₜ, Aₘ, y)}, where xₜ∈M₂ represents the alert state at time t within the mesoscale manifold, Aₘ denotes the enriched alert object including doctrinal tags, provenance vectors, and reasoning pathways, and y∈{0,1} indicates the resolution outcome with y=1 representing successful mitigation or natural resolution and y=0 indicating escalation, failure, or unresolved status. Each archived event preserves the complete semantic context of the alert including the sensor evidence lineage from which it originated, the geometric trajectory through M₂ during its lifecycle, any applied mitigation policies and their effects, operator interventions and doctrinal overrides, and final disposition with temporal resolution characteristics. The archive may span operational periods ranging from days to years, potentially containing thousands to millions of alert events depending on system scale and sensor density. Loading operations leverage the landmark graph structure G=(V,E) where vertices represent cached alert states and edges encode geodesic distances, curvature penalties, and compression costs, enabling efficient retrieval through O(log n) queries rather than linear scans.

In a step 720, replay archived alert trajectories by computing geodesically minimal summaries. For each archived alert with onset state x₀ and resolution state x_{T}, the replay process computes the geodesic path. This geodesic computation identifies the most direct path through semantic space connecting alert onset to resolution, factoring out meandering fluctuations and transient perturbations that characterized the actual historical trajectory. The geodesically minimal summaries condense alert dynamics into their essential geometric structure, revealing core patterns such as whether alerts followed stable attractors toward natural resolution, whether they required policy-driven guidance to reach success basins, whether they exhibited chaotic wandering indicating poor mitigation strategies, or whether they were pulled inexorably toward failure basins despite intervention attempts. Replay operates in compressed latent space rather than full sensor resolution, enabling rapid processing of extensive archives. GPU-accelerated geodesic approximations leverage parallel computation to process multiple trajectories simultaneously, with landmark graph structures providing efficient nearest-neighbor queries for path initialization and refinement.

In a step 730, compute compression pressure across regions of the mesoscale manifold. For a region U⊂M₂, the compression cost may be calculated as C(U)=integral over U of div_g₂(Σ_j \dot{x}_j/∥\dot{x}_j∥) dμ, where the sum ranges over all alert trajectories j passing through region U, \dot{x}_j represents the velocity vector of trajectory j, ∥\dot{x}_j∥ is its magnitude, and μ denotes the measure induced by manifold volume. The divergence operator div_g₂ computes how the normalized trajectory flow expands or contracts at each point, with positive divergence indicating trajectory dispersion (alerts spreading apart as they pass through the region) and negative divergence indicating compression (alerts converging together). High compression pressure regions with large negative divergence indicate semantic bottlenecks where many diverse alert trajectories are forced through narrow manifold channels, suggesting over-sensitive triggering that generates excessive alerts for semantically similar conditions. Low compression regions with sparse trajectory density but high local curvature indicate under-triggered areas where significant manifold structure exists but few alerts are being generated, suggesting missed detections or insufficient sensitivity. The compression pressure analysis identifies spatial patterns across the manifold including hot zones with alert over-saturation requiring threshold elevation, cold zones with potential under-detection requiring increased sensitivity, gradient regions where compression transitions rapidly indicating manifold boundaries or semantic discontinuities, and stable zones where alert density matches manifold structure appropriately. Compression calculations leverage the landmark graph representation for efficient regional integration, with each landmark vertex accumulating local compression contributions from nearby trajectories.

In a step 740, recalibrate alert onset thresholds based on compression pressure patterns. For regions exhibiting excessive compression (high C(U) values), the system raises alert formation thresholds including ρ_{crit}, the critical density threshold for proto-alert clustering in the fast manifold M₁, and Δₐₗₑᵣₜ, the minimum divergence from baseline attractors required to trigger proto-alert formation. Threshold elevation in over-compressed regions reduces alert sensitivity, requiring stronger evidence or larger deviations to generate proto-alerts, thereby decreasing the rate of alert formation and relieving semantic congestion. Conversely, for under-triggered regions characterized by low alert density despite high manifold curvature, the system lowers thresholds ρ_{crit} and Δₐₗₑᵣₜ, increasing sensitivity and enabling proto-alert formation from subtler anomalies or smaller baseline deviations. The recalibration operates locally rather than globally, adjusting thresholds as continuous functions over M₁ and M₂ such that threshold values vary smoothly across manifold regions according to local compression characteristics. This spatially adaptive approach ensures that alert sensitivity matches the semantic density and operational importance of different manifold zones. Threshold updates may be computed as ρ_{crit}(x)←ρ_{crit}(x)·(1+α·C(x)) and Δₐₗₑᵣₜ(X)←Δₐₗₑᵣₜ(x)·(1+β·C(x)), where α and β are learning rate parameters controlling adaptation speed, and C(x) is the normalized compression pressure at position x. The recalibration process maintains stability through damping mechanisms that prevent oscillatory threshold adjustments and through validation checks ensuring thresholds remain within operationally acceptable bounds.

In a step 750, update Bayesian posterior parameters for alert triage using archived resolution outcomes. The posterior distribution parameters (α,β) for each manifold region or alert category are incrementally updated according to α←α+Σ_(x,A,y)∈A w(x,A)·y and β←β+Σ_(x,A,y)∈A w(x,A)·(1−y), where the sum ranges over all archived alert events, y represents the resolution outcome (1 for success, 0 for failure), and w(x,A) denotes a weight derived from geodesic similarity between the archived alert context and current operational conditions. The weight function w(x,A)=K_geom(x,x_current)·K_policy(A,A_current) combines geometric kernel K_geom measuring manifold distance between historical and current states with policy kernel K_policy assessing similarity of alert characteristics and applied mitigations. Higher weights are assigned to archived events that closely resemble current operational contexts, ensuring that posterior updates appropriately reflect relevant historical experience rather than distant or inapplicable cases. The Bayesian updates ensure that posterior distributions over alert resolution probabilities capture long-run outcome frequencies while adapting to evolving operational environments and changing threat landscapes. As the archive grows over extended operation, posterior distributions become increasingly concentrated around true success probabilities, providing higher confidence estimates for alert triage decisions. The update process maintains separate posterior parameters for different alert categories, sensor modalities, operational contexts, and mitigation policies, enabling fine-grained probabilistic reasoning that accounts for context-specific success rates. Posterior updates are computed using efficient incremental algorithms that avoid reprocessing the entire archive, instead updating running statistics with contributions from newly archived events.

In a step 760, consolidate recurrent alert motifs into doctrinal schemas within the slow manifold M₃. At the slow manifold scale representing long-term patterns and strategic abstractions, the system identifies alert trajectories that repeatedly exhibit similar geometric structures, semantic features, and resolution pathways. These recurrent motifs are consolidated into schemas Σ defined as Σ=integral over A of K(x,x′) dμ(x′), where A represents a cluster of structurally similar alert trajectories, K(x,x′) is a kernel function weighting similarity between alert states x and x′, and μ is the manifold measure. Each schema represents an archetypal alert pattern with characteristic features such as typical sensor signatures that initiate the alert type, expected trajectory through the mesoscale manifold, effective mitigation strategies and their success probabilities, common failure modes and escalation triggers, and doctrinal classifications and handling requirements. For example, repeated proto-alerts involving combined acoustic signatures and vibration anomalies following specific geometric trajectories may consolidate into a schema Σ_{cavitation} corresponding to “incipient pump cavitation,” capturing the characteristic manifold pattern of this failure mode. Similarly, patterns of thermal and seismic correlation with particular temporal dynamics may form a schema representing “bearing degradation,” while specific cyber telemetry configurations may consolidate into schemas for network intrusion attempts. Schema formation employs clustering algorithms operating on trajectory shapes within M₂, identifying groups of alerts with high mutual kernel similarity K(x,x′). The consolidation process extracts prototypical trajectories representing schema centroids, computes characteristic basins and barriers defining schema boundaries, derives optimal mitigation policies for each schema type, and establishes doctrinal mappings linking schemas to operational procedures and response protocols. Schemas provide multiple benefits including faster alert recognition through template matching, improved mitigation effectiveness via schema-specific policies, enhanced explainability by categorizing alerts into understood types, and facilitated doctrinal reconciliation across federated deployments through shared schema vocabularies. Schema information is persisted in the landmark graph with schema nodes at the M₃ level linked to constituent alert instances at M₂, enabling bidirectional navigation between strategic abstractions and tactical details.

The recalibration process concludes by committing all threshold adjustments, posterior updates, and schema consolidations to persistent storage, ensuring that the optimized parameters will govern subsequent alert processing during wake-state operation. The system performs validation checks including verification that updated thresholds remain within operational bounds, confirmation that posterior distributions maintain proper normalization, validation that schema structures exhibit appropriate geometric coherence, and testing that federated synchronization can successfully propagate updates across distributed PCM instances. Upon successful validation, the sleep cycle terminates and the system resumes real-time operational processing with enhanced alert sensitivity tuned to current operational conditions, improved triage accuracy informed by expanded historical evidence, and enriched schema structures enabling more effective pattern recognition and mitigation. The recalibration cycle may be scheduled adaptively based on system metrics, with more frequent sleep cycles during periods of rapid environmental change or high alert volumes, and less frequent recalibration during stable operational phases. Federated deployments coordinate sleep cycles across PCM instances to maintain consistency, exchanging posterior parameter deltas (α,β) and schema updates rather than raw alert archives, thereby reducing bandwidth requirements while preserving privacy. The complete recalibration workflow ensures that the multimodal alert generation system remains responsive to evolving threats, adaptable to changing operational contexts, and continuously optimized for effective alert management through geometric learning and probabilistic reasoning.

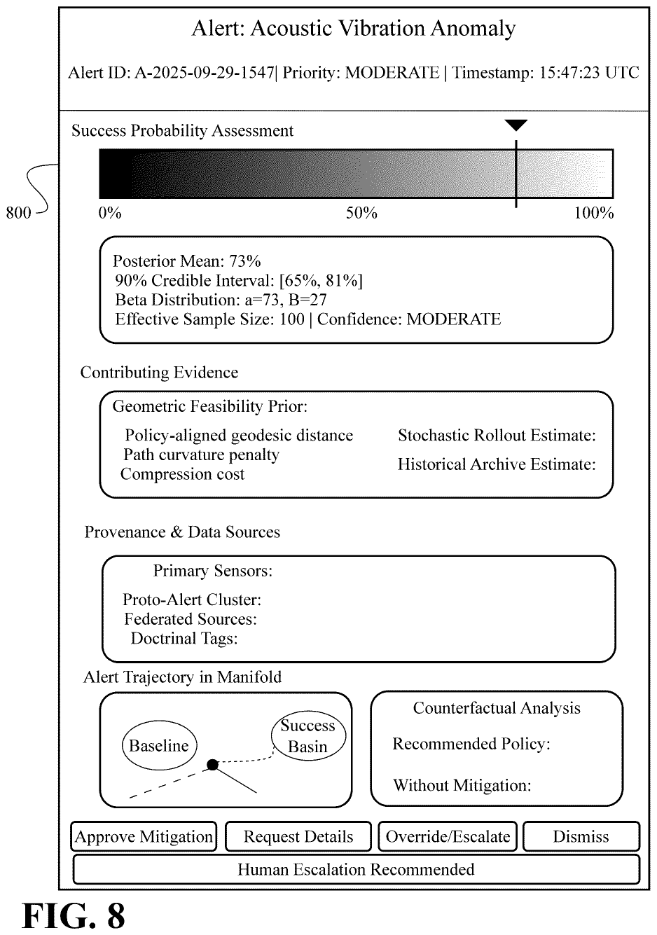

FIG. 8 is a diagram illustrating an exemplary human-facing alert card with probability bars, credible intervals, provenance traces, and counterfactual explainability, according to an embodiment. The alert card represents the interface through which escalated alerts may be presented to human operators, transforming complex geometric and probabilistic reasoning into an interpretable, actionable display that supports informed decision-making while maintaining transparency about uncertainty and evidence sources.

The alert card structure 800 comprises multiple integrated sections designed to provide comprehensive situational awareness. At the top of the card, a header section displays critical alert metadata including a unique alert identifier (e.g., “A-2025-09-29-1547”), alert type or category derived from manifold clustering and schema matching (e.g., “Acoustic-Vibration Anomaly”), priority classification determined by doctrinal policy evaluation (e.g., “MODERATE,” “HIGH,” or “CRITICAL”), and timestamp indicating when the proto-alert first exceeded divergence thresholds in the fast manifold M₁. This header information enables operators to quickly assess alert significance and temporal context, supporting efficient triage when multiple alerts require attention simultaneously. The alert type reflects consolidated understanding from the slow manifold M₃ schemas, mapping the geometric pattern to recognized operational categories such as “incipient pump cavitation,” “bearing degradation,” “thermal runaway,” or domain-specific failure modes learned through historical consolidation.

A success probability assessment section provides the central probabilistic reasoning output that governs alert disposition. This section displays a horizontal probability bar implementing a continuous gradient visualization from red (representing 0% success probability or certain failure) through yellow(50% moderate uncertainty) to green (100% or certain success). The gradient provides intuitive visual encoding that leverages universal color associations while remaining accessible through supplementary numerical displays for operators with color vision deficiencies. Overlaid on this gradient bar, the posterior mean marker appears as a vertical line or arrow indicator positioned at the expected success probability computed through Bayesian fusion of geometric, rollout, and historical evidence. For the exemplary alert illustrated, this marker appears at 73%, indicating that the system estimates a 73% probability that the recommended mitigation policy will successfully resolve the alert condition.

The credible interval band is rendered as a semi-transparent shaded region overlaying the probability gradient, extending from the 5th percentile to the 95th percentile of the Beta posterior distribution. This 90% credible interval communicates epistemic uncertainty explicitly to the operator, distinguishing between high-confidence predictions with narrow intervals (e.g., [71%, 75%]) and low-confidence estimates with wide intervals (e.g., [45%, 92%]). The interval width provides immediate visual feedback about the strength of available evidence, with narrow intervals indicating convergent agreement among geometric analysis, stochastic rollouts, and historical precedents, while wide intervals signal conflicting evidence sources or sparse historical data requiring cautious interpretation. The exemplary alert shows a credible interval of [65%, 81%], with a 16-percentage-point width indicating moderate uncertainty appropriate for human escalation rather than automatic mitigation or immediate critical escalation.

Beneath the probability bar, a probability metrics panel displays quantitative details of the posterior distribution using precise numerical values and statistical parameters. This panel presents the posterior mean expressed both as a percentage (73%) and as a probability (0.73), the 90% credible interval bounds [65%, 81%] or equivalently [0.65, 0.81], the Beta distribution parameters α and β (exemplarily α=73, β=27) which completely specify the posterior and enable reconstruction of the full distribution if needed, and the effective sample size α+β (exemplarily 100) indicating the total amount of pseudo-evidence incorporated through geometric initialization, rollout updates, and historical contributions. The panel may also display confidence classification (e.g., “HIGH,” “MODERATE,” “LOW”) based on credible interval width or posterior standard deviation with narrow distributions classified as high confidence and wide distributions as low confidence. This quantitative detail supports operators who prefer numerical precision over visual interpretation and enables precise communication in verbal or written reports.

A contributing evidence breakdown section decomposes the posterior probability into its three constituent sources, providing transparency about how the final estimate was derived and enabling operators to evaluate the reasoning process critically. This section presents the geometric feasibility prior with its computed value (exemplarily φ_{π}(x₀)=0.68 or 68%) along with the underlying geometric factors that determined this prior: the policy-aligned geodesic distance d_{π} quantifying how far the current alert state x₀ lies from the success basin S through the manifold M₂, the path curvature penalty k measuring how sharply the mitigation trajectory must turn to reach resolution, and the compression cost C(x₀) indicating semantic density and cognitive effort required to navigate through the alert's manifold region. For the exemplary alert, these factors might be d_{π}=2.4 (moderate distance), κ=0.18 (low curvature, relatively straight path), and C(x₀)=0.31 (low compression, sparse manifold region), yielding an overall geometric feasibility of 68% through the logistic function σ(α·d_{π}+β·κ+γ·C).

The stochastic rollout estimate is presented as a success rate derived from parallel GPU-executed trajectory simulations, displayed both numerically (e.g., 75%) and visually through a horizontal bar chart showing the proportion of successful rollout outcomes. For example, the display might show “75/100 successes=75%” with a bar filled to 75% of its width, immediately conveying that three-quarters of the simulated trajectories reached the success basin S within the rollout horizon H. This visualization enables operators to understand the rollout contribution intuitively, seeing that despite geometric feasibility of 68%, actual simulated execution succeeded more frequently at 75%, suggesting that dynamic effects or favorable noise realizations improve prospects beyond static geometric analysis alone.

The historical archive estimate 826 presents the success rate from retrieved similar cases, showing both the computed probability (e.g., 71%) and the number of relevant historical alerts that contributed to this estimate (e.g., “47 similar cases”). The display might include a bar visualization similar to the rollout estimate, or it might present a weighted average representation showing how historical outcomes clustered around success or failure. The number of similar cases provides important context about the reliability of the historical estimate: 47 cases represents substantial evidence lending high confidence to the 71% estimate, while fewer cases (e.g., 5-10) would indicate sparser evidence requiring greater caution. For novel alert types or unprecedented manifold regions, the historical component might display “insufficient data” or default to a neutral 50% estimate, explicitly signaling to operators that past precedent provides little guidance for the current situation.

This evidence breakdown serves multiple critical functions. First, it enables operators to identify consensus or conflict among the three independent estimation methods. An alert where all three sources cluster around 70-75% (as in the example) demonstrates convergent evidence supporting the overall 73% posterior mean, increasing operator confidence in the system's reasoning. Conversely, an alert showing geometric feasibility of 45%, rollout success of 68%, and historical success of 72% would reveal that geometric analysis is pessimistic compared to simulation and history, potentially indicating that the manifold representation has not yet captured recently improved mitigation techniques or that geometric penalties are over-weighted. Such divergence invites operator scrutiny and application of domain expertise to determine which evidence source most accurately reflects current operational reality. Second, the breakdown supports learning and calibration by enabling post-hoc analysis of which evidence sources proved most predictive, informing future parameter adjustments. Third, it facilitates explainability and trust by showing operators exactly how the system reached its conclusion rather than presenting an opaque “black box” prediction.

A provenance and data sources section provides complete traceability from raw sensor inputs through alert generation, enrichment, and triage, ensuring that operators understand the evidential basis for the alert and can assess data quality and reliability. This section lists the primary sensor streams that contributed to proto-alert formation in the fast manifold M₁, identifying each sensor by name or identifier (e.g., “Acoustic-A7,” “Vibration-V3,” “Thermal-T2”) along with its quality-of-evidence score qᵢ∈[0,1]. Quality scores quantify sensor reliability based on reconstruction error from encoder training, signal-to-noise ratios, and temporal consistency, with higher scores indicating more trustworthy inputs. For the exemplary alert, quality scores might be q(Acoustic-A7)=0.94, q(Vibration-V3)=0.89, and q(Thermal-T2)=0.76, showing that all contributing sensors provide reliable evidence with acoustic and vibration sensors particularly high-quality and thermal sensor still acceptably above typical confidence thresholds (e.g., 0.6 or 0.7).

The provenance section displays proto-alert clustering information identifying where in the fast manifold M₁ the alert originated, specified either as latent coordinates (e.g., [2.3, −1.4, 0.8] in a three-dimensional projection for visualization purposes) or as proximity to landmark vertices in the landmark graph G. The section also presents the divergence magnitude Δ=∥Z(t)−μ_{B}(Z(t))∥_{g₁} quantifying how far the sensor fusion output departed from its nearest baseline attractor, expressed either in absolute units or as multiples of the baseline standard deviation OB (e.g., “Δ=0.42 above baseline” or “δ=4.2σ_{B}”). This divergence metric indicates alert strength, with larger values suggesting more pronounced anomalies and smaller values indicating subtle deviations that might warrant cautious interpretation.

For federated deployments, the provenance section identifies contributing PCM instances, listing which federated nodes provided evidence, correlation, or contextual information for the alert. For example, “PCM-Alpha (primary), PCM-Beta (correlation), PCM-Gamma (context)” indicates that PCM instance Alpha detected the proto-alert initially, PCM instance Beta provided corroborating evidence through its own sensor streams in geometrically aligned manifold regions, and PCM instance Gamma contributed contextual schemas or historical precedents. This federated provenance enables operators to assess geographic or logical distribution of evidence and to recognize when alerts reflect localized phenomena versus distributed patterns spanning multiple systems. The section may also display divergence indices Dᵢⱼ quantifying semantic drift between federated alert representations, alerting operators when federated instances disagree about alert interpretation or severity.

Doctrinal tags inherited from policy ontologies during alert enrichment are displayed prominently, providing categorical annotations that govern handling requirements and operational constraints. Exemplary tags include “SAFETY-CRITICAL” indicating personnel risk or potential for injury requiring immediate attention and possibly mandatory human review regardless of confidence levels, “MAINTENANCE-REQUIRED” signaling that resolution necessitates physical intervention rather than purely software-based mitigation, “AUTO-MITIGATE-APPROVED” confirming that doctrinal policy permits automated resolution for this alert category if confidence thresholds are met, “ADVERSARY-POSSIBLE” flagging potential malicious causation requiring security-conscious handling, “LOW-CONFIDENCE” denoting sparse evidence or conflicting information, and domain-specific tags like “MECHANICAL,” “THERMAL,” “CYBER,” or “ENVIRONMENTAL” classifying the alert into operational categories. These tags provide instant recognition of special handling requirements and enable operators to apply appropriate response protocols defined in organizational procedures.

An alert trajectory visualization section presents a simplified two-dimensional projection of the alert's geometric path through the mesoscale manifold M₂, enabling operators to understand alert evolution spatially and to evaluate the plausibility of recommended mitigation strategies. The visualization depicts the baseline attractor region as a shaded ellipse or bounded area representing normal operational states where no alerts exist, the success basin S as a target region representing resolved alert conditions where system operation has returned to acceptable parameters, and the current alert position x₀ prominently marked (e.g., as a red dot or highlighted marker) showing where the alert currently resides in the manifold. This spatial layout immediately communicates whether the alert lies close to baseline (suggesting minor deviation easily corrected) or far from baseline and success regions (indicating substantial displacement requiring significant intervention).

The recommended mitigation path appears as a curved trajectory connecting the current alert position x₀ to the success basin S, representing the geodesic or policy-aligned path under the recommended mitigation policy π*. This path visualization may be rendered as a solid line colored distinctively (e.g., blue) to distinguish it from other trajectories, with thickness or styling indicating confidence in the path. The path shape reveals geometric characteristics including whether it follows a relatively direct route suggesting straightforward resolution, whether it curves sharply indicating complex maneuvering through manifold regions, whether it passes through compressed high-curvature zones suggesting difficult navigation, or whether it follows established channels suggesting well-understood mitigation procedures. Operators can assess intuitively whether the recommended path seems reasonable given their understanding of the physical system and operational context.

Counterfactual trajectories illustrate alternative futures under different scenarios, providing “what-if” explainability that helps operators understand the consequences of different choices. A no-mitigation counterfactual shows the predicted evolution if no intervention occurs, typically depicted as a dashed or dotted line (e.g., orange or red) diverging from the current alert position toward failure regions or escalation zones. This trajectory answers the critical question “what happens if we do nothing?” and demonstrates the necessity and urgency of intervention. For example, the trajectory might show steady drift away from the success basin toward a failure boundary, with annotations indicating expected failure time or escalation probability. An alternative policy counterfactual illustrates the projected trajectory under a different mitigation strategy π′ that was considered but not selected as optimal, rendered in another distinctive style (e.g., purple dashed line). This comparison enables operators to understand why π* was chosen over π′ by seeing that π* provides a shorter, straighter, or lower-risk path to resolution. Multiple alternative counterfactuals may be displayed when several plausible policies exist, supporting operator exploration of different response strategies.

The trajectory visualization implements geometric continuations represents perturbations in the tangent space, computed through short-horizon rollouts or geodesic extrapolations. These continuations maintain manifold consistency while exploring nearby possibilities, ensuring that counterfactuals represent geometrically plausible futures rather than arbitrary speculations. The visualization preserves topological relationships from the full high-dimensional manifold M₂ while projecting to two dimensions for display, typically using principal geodesic analysis or other dimensionality reduction techniques that prioritize preservation of distances and basin structures most relevant to the current alert context.

A counterfactual explainability panel provides detailed textual and quantitative description of mitigation options and their predicted outcomes, complementing the visual trajectory display with precise operational details. For the recommended policy π*, panel lists specific actions comprising the mitigation strategy, expressed in domain-appropriate terminology that operators can directly implement or authorize. For an industrial system, these might include “Reduce pump speed by 15%,” “Increase coolant flow to 120%,” and “Monitor for 300 seconds,” providing actionable instructions with concrete parameter values. For a cyber domain, actions might specify firewall rules, service restarts, or traffic rerouting. The recommended policy display includes the associated success probability (e.g., “Success Probability: 73%”) prominently shown and styled distinctively (e.g., bold, colored green), reinforcing the connection between the policy description and the probability visualizations presented earlier in the card.

The panel presents without-mitigation consequences describing the predicted outcome if no intervention occurs, typically highlighting adverse effects to emphasize urgency and necessity of action. For example, “89% probability of escalation” quantifies the likelihood that the alert condition will worsen beyond recoverable thresholds if unaddressed, while “Expected failure time: 12-18 minutes” provides temporal context indicating how much time remains before likely failure. These consequences are typically styled with warning colors (e.g., red text) to draw attention and create appropriate urgency without inducing panic. The information derives from rollout simulations and historical precedents where similar alerts went unaddressed, providing data-driven rather than speculative projections.

For alternative policies, if displayed, the panel may briefly summarize why alternatives were not selected, such as “Alternative policy π′ (coolant only): 58% success probability, does not address acoustic signature,” explaining that considering coolant adjustment alone without pump speed reduction yielded lower predicted success and failed to target all observed anomalies. This comparative information supports operator understanding of the recommendation's rationale and builds trust through transparency about considered alternatives.

A sensitivity measure Δ_{π}(x₀) quantifies the alert's vulnerability to perturbations, model uncertainty, or adversarial manipulation, providing a risk assessment beyond point probability estimates. This metric, typically computed as the maximum deviation in posterior probability resulting from bounded perturbations to geometric parameters, rollout conditions, or historical weights, appears as a numerical value (e.g., “Δ_{π}(x₀)=0.34”) with interpretive classification (e.g., “moderate sensitivity”). Low sensitivity values (e.g., <0.2) indicate robust predictions where small changes in evidence or assumptions produce minimal impact on the estimated success probability, increasing operator confidence in the recommendation. High sensitivity values (e.g., >0.5) signal fragile predictions highly dependent on specific assumptions, warranting caution and potentially suggesting that additional evidence gathering or expert consultation would be prudent before committing to action. Moderate sensitivity (e.g., 0.2-0.5) indicates reasonable robustness with some uncertainty, consistent with the alert falling in the moderate-confidence escalation regime.

A system recommendation section synthesizes all preceding information into a clear, actionable guidance statement, explicitly stating the system's conclusion about how the alert should be handled. For the exemplary moderate-confidence alert illustrated, this section displays “HUMAN ESCALATION RECOMMENDED—Moderate confidence mitigation available for operator approval,” clearly indicating that the system's confidence (73%) falls between the automatic mitigation threshold (e.g., 85%) and the immediate critical escalation threshold (e.g., 50%), placing the alert in the regime where human judgment should augment machine reasoning. The recommendation text is styled for high visibility using bold or emphasized fonts and may be color-coded (e.g., orange or yellow background) to match the alert's confidence level, distinguishing moderate-confidence escalations from high-confidence recommendations or low-confidence critical alerts that might use different colors and more urgent language.

The recommendation section is accompanied by action buttons providing operators with explicit interaction options for responding to the alert. These buttons implement the human-PCM interaction loop, enabling operators to confirm, override, or request additional information about the system's analysis. An “Approve Mitigation” button allows operators to authorize execution of the recommended policy π* if they concur with the system's assessment, triggering the immersion operator ι_{2→1} to project the policy back to fast manifold control fields and execute the specified actions. This button may be styled with affirmative coloring (e.g., green) and positioned prominently when the system recommends approval. A “Request Details” button enables operators to access deeper diagnostic information not shown on the primary alert card, such as complete rollout distributions, full historical case details, raw sensor time series, or intermediate geometric calculations, supporting operators who need additional context before making decisions. This button provides a pathway for operators to investigate thoroughly without cluttering the primary interface with excessive detail.

An “Override/Escalate” button allows operators to reject the system's recommendation and either implement an alternative response strategy or escalate the alert to supervisory personnel with greater authority or specialized expertise. This option preserves human agency and judgment, recognizing that operators may possess contextual knowledge, recent operational changes, or domain expertise not captured in the system's manifold representation and that system recommendations may occasionally reflect outdated assumptions or model limitations. The button may open a dialog enabling operators to specify their chosen alternative and rationale, ensuring that human overrides are logged with explanation for subsequent analysis. A “Dismiss” or “Suppress” button provides operators with the option to acknowledge the alert without taking action, appropriate when operators determine through independent assessment that the alert represents a false positive, benign condition, or situation already addressed through other means. Dismissal actions are logged to prevent silent failures and enable calibration of alert thresholds during sleep-state recalibration.

The complete alert card structure ensures that operators receive comprehensive, transparent, and actionable information supporting effective decision-making. By presenting posterior probabilities with credible intervals, decomposing evidence sources, providing complete provenance, visualizing geometric trajectories, and explaining counterfactual scenarios, the alert card transforms opaque alarms into structured cognitive objects that operators can understand, evaluate, and act upon confidently. The integration of probabilistic reasoning, geometric intuition, and operational details bridges the gap between machine intelligence and human judgment, enabling collaborative human-PCM decision-making where each contributes its strengths. The alert card interface can be generated in real time from PCM persistence layers using landmark graph embeddings for trajectory visualization and additive Bayesian updates for posterior calculations, meeting latency budgets of less than 50 milliseconds for escalation display to ensure responsive operator experience. Federated deployments preserve provenance by including cryptographic hashes of contributing PCM instances, enabling verifiable explainability in multi-actor environments where trust and accountability span organizational boundaries. Through these mechanisms, the human-facing alert card embodies the principle that effective alerting requires not just notification but explanation, not just prediction but transparency, and not just automation but meaningful human-machine collaboration.

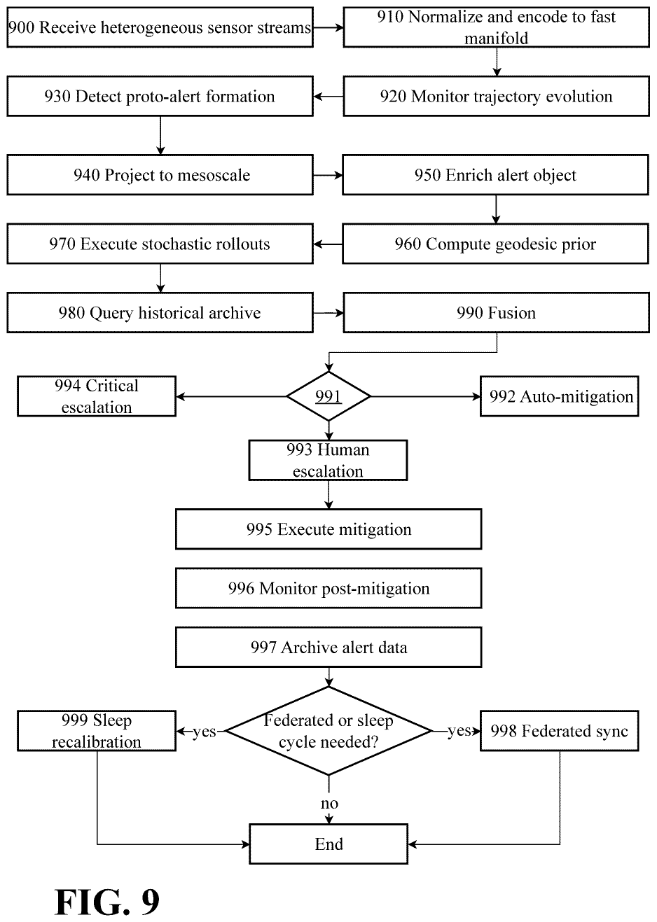

FIG. 9 is a flow diagram illustrating an exemplary method for end-to-end multimodal alert generation, triage, and resolution through federated latent sensor streams within a Persistent Cognitive Machine architecture, according to an embodiment. This comprehensive method integrates sensor-level data acquisition, manifold-based alert formation, prediction-driven triage, and closed-loop resolution with archival learning, demonstrating the complete operational cycle from raw heterogeneous telemetry through final alert disposition and system adaptation.

In a first step 900, the federated PCM system receives heterogeneous sensor streams from multiple modalities. The system continuously ingests asynchronous telemetry from diverse sensor types operating at varying sampling rates, with disparate physical units, and exhibiting different noise characteristics and reliability profiles. Representative sensor modalities include acoustic sensors measuring sound pressure levels, frequency spectra, and transient signatures; optical sensors capturing visual imagery, infrared thermal profiles, or spectral characteristics; vibration sensors detecting mechanical oscillations, harmonic content, and structural resonances; thermal sensors monitoring temperature distributions, heat flux, and thermal gradients; seismic sensors measuring ground motion, structural vibrations, and propagating disturbances; electromagnetic sensors detecting radio-frequency emissions, magnetic field variations, and electrical signatures; and cyber sensors monitoring network traffic patterns, system logs, authentication events, and process behaviors. Each sensor stream arrives as a time-series signal with domain-specific encoding, potentially including scalar measurements, vector quantities, spectral decompositions, or structured event logs. The reception process implements buffering mechanisms to accommodate asynchronous arrival times, time-stamping to establish temporal alignment across modalities, quality checks to detect sensor failures or anomalous readings, and rate adaptation to normalize disparate sampling frequencies. The diversity of sensor types and their complementary information content enables comprehensive situational awareness, with cross-modal correlation providing robustness against single-sensor failures and resistance to adversarial manipulation of individual channels.

In a step 910, normalize sensor streams and encode into latent manifold M₁. This step transforms raw heterogeneous telemetry into a unified geometric representation suitable for cognitive processing. Each sensor stream undergoes normalization through an adapter that implements domain-specific preprocessing including unit conversion to standardized scales, temporal resampling to common time bases, outlier rejection to remove spurious measurements, and spectral filtering to isolate relevant frequency bands. The normalized stream is then processed by an encoder that maps sensor-specific inputs into d-dimensional latent embeddings. These encoders are trained through correlation-preserving objectives that ensure semantically related phenomena across different modalities map to geometrically proximate regions in the latent space, enabling natural fusion of multimodal evidence. Each latent embedding is accompanied by a quality-of-evidence score computed from encoder reconstruction error measuring how well the encoder can reconstruct the original signal from its latent representation, signal-to-noise ratio quantifying measurement reliability, and temporal consistency evaluating smoothness and predictability of the sensor stream. The quality scores weight each modality's contribution to downstream proto-alert formation, ensuring that unreliable or degraded sensor inputs contribute proportionally less to alert decisions. The joint latent representation aggregates weighted embeddings from all modalities into a unified point within the fast manifold M₁, where geometric proximity reflects semantic similarity and temporal evolution traces cognitive trajectories through the space of possible system states.

In a step 920, monitor trajectory evolution and compute divergence from baseline attractors. Within the fast manifold M₁, the latent embeddings form temporal trajectories that characterize normal and anomalous system behavior. The monitoring process maintains a library of baseline attractors representing typical operational states, learned through unsupervised clustering of historical latent trajectories during normal operation. For each incoming latent state, the system computes the divergence measuring how far the current state has departed from the nearest baseline attractor using geodesic distance under the fast manifold metric. This divergence quantifies how far the current system state has departed from normal operational patterns, with larger values indicating more pronounced anomalies. The metric incorporates learned geometric structure that reflects semantic relationships, ensuring that divergence measurements align with operational significance rather than arbitrary Euclidean distances. The monitoring process tracks not only instantaneous divergence but also trajectory characteristics including velocity indicating rate of change, acceleration measuring how rapidly the system is departing from or returning to baseline, and trajectory curvature revealing whether evolution follows smooth predictable paths or exhibits erratic discontinuous behavior. These dynamic features provide early warning of developing anomalies before they reach critical thresholds, enabling proactive rather than reactive alerting. The baseline attractors are continuously updated during sleep cycles to accommodate gradual operational drift, seasonal variations, and evolving mission profiles, ensuring that the system adapts to changing normal conditions without generating spurious alerts.

In a step 930, detect proto-alert formation when density and divergence thresholds are exceeded. This step implements the phase transition from passive monitoring to active alert generation. Proto-alert formation occurs when two conditions are simultaneously satisfied: first, the local density computed using a kernel function measuring similarity between points exceeds a critical threshold; second, the minimum distance to any baseline attractor exceeds the alert threshold. The density criterion ensures that proto-alerts represent coherent, sustained anomalies rather than transient noise spikes, requiring convergence of multiple recent observations or multimodal evidence toward anomalous regions. The divergence criterion ensures that detected patterns genuinely deviate from normal operation rather than representing expected variability within baseline attractors. The thresholds are calibrated through operational experience and adjusted during sleep-state recalibration to balance sensitivity against false positive rates, with domain-specific tuning reflecting risk tolerance, consequence severity, and operator workload constraints. When both conditions are met, a proto-alert cluster is formed comprising all recent latent points within the dense anomalous region, capturing the multimodal evidence supporting the alert and providing context for subsequent enrichment. The proto-alert includes temporal extent indicating onset time and duration, contributing modalities identifying which sensors detected the anomaly, geometric centroid representing the alert's position in M₁, and divergence magnitude quantifying severity. Proto-alerts at this stage remain low-level sensor-space objects requiring elevation to semantic understanding before human presentation or policy-driven action.

In a step 940, project proto-alert to mesoscale manifold M₂ via submersion operator. This projection elevates the proto-alert from sensor-level representation in the fast manifold M₁ to semantic-level representation in the mesoscale manifold M₂ where reasoning, prediction, and policy application occur. The submersion operator implements structured fiber mappings that preserve essential geometric relationships while abstracting away sensor-specific details. The projection process transforms the raw proto-alert cluster into an enriched alert object embedded within M₂, where proximity reflects semantic similarity of alert types rather than sensor correlations. The submersion preserves topological relationships including neighborhood structures ensuring nearby proto-alerts in M₁ map to nearby alert objects in M₂, geodesic distances maintaining semantic separation proportional to operational distinctions, and attractor relationships ensuring that resolution basins in M₂ connect meaningfully to sensor-space basins in M₁. The projection mechanism leverages learned mappings trained to align sensor patterns with operational outcomes, enabling the mesoscale manifold to organize alerts according to appropriate mitigation strategies, doctrinal categories, and risk profiles. The fiber structure implements a many-to-one mapping where multiple distinct sensor configurations can produce semantically equivalent alerts, providing robustness against sensor degradation and adversarial evasion attempts that manipulate individual channels while leaving operational signatures intact.

In a step 950, enrich alert object with doctrinal tags, provenance vectors, and reasoning pathways. Within the mesoscale manifold M₂, the alert object undergoes semantic enrichment that transforms it from a geometric abstraction into an operationally meaningful cognitive entity. The enrichment process adds doctrinal tags representing categorical annotations drawn from organizational policy ontologies, including safety classifications such as “SAFETY-CRITICAL,” “PERSONNEL-RISK,” or “ENVIRONMENTAL-HAZARD,” operational categories like “MECHANICAL,” “THERMAL,” “CYBER,” or “ADVERSARIAL,” urgency levels such as “IMMEDIATE,” “PROMPT,” or “ROUTINE,” and authorization constraints like “AUTO-MITIGATE-APPROVED,” “REQUIRES-SUPERVISOR,” or “EXECUTIVE-DECISION.” These tags govern subsequent handling, determining escalation pathways, approval requirements, and documentation obligations. The provenance vector captures the complete evidential lineage including contributing sensor encoders, their quality scores, temporal evolution of the proto-alert, federated sources if multiple PCM instances contributed evidence, and intermediate processing steps. This provenance enables operators to trace alerts back to original sensor inputs, assess data quality, identify potential sensor failures or adversarial manipulation, and understand why the system generated the alert. The reasoning pathways provide structured explanations of alert causation including primary hypotheses about underlying phenomena (e.g., “bearing degradation,” “thermal runaway,” “network intrusion”), alternative explanations with associated probabilities reflecting uncertainty in causal attribution, supporting evidence linking sensor patterns to hypotheses, and counterfactual scenarios describing expected evolution under different conditions or without intervention. These reasoning structures enable operators to evaluate alert validity, assess urgency, and select appropriate responses based on transparent causal understanding rather than opaque algorithmic outputs.

In a step 960, compute geometric feasibility prior for candidate mitigation policies. This step initiates the prediction-driven triage process by evaluating how geometrically tractable each potential mitigation strategy appears within the manifold structure. For the current alert state and each candidate policy, the system computes the geometric feasibility prior that quantifies whether the policy can guide the alert toward resolution based purely on manifold geometry. The computation integrates three geometric factors: policy-aligned geodesic distance measuring how far the current state lies from the success basin through the manifold following the policy's prescribed direction; path curvature penalty quantifying how sharply the trajectory must turn to reach resolution while following the policy; and compression cost indicating semantic density and cognitive complexity at the current alert state. These factors combine through a learned logistic function where weights are tuned to reflect operational experience about which geometric configurations predict successful mitigation. The geometric prior provides a model-free, interpretable assessment of mitigation feasibility based on the learned structure of the manifold, independent of dynamic simulations or historical precedent, enabling rapid initial screening of policy options even for novel alert types where rollout models or historical data may be unavailable or unreliable.

In a step 970, execute stochastic rollouts to estimate success probabilities through simulation. This step implements GPU-accelerated parallel trajectory simulations that project how the alert state would likely evolve under each candidate mitigation policy, providing dynamic evidence complementing the static geometric prior. The rollout engine generates parallel trajectories by numerically integrating a stochastic differential equation where a lightweight dynamics operator projects evolution, a control field induced by the policy guides the trajectory, and stochastic perturbations model measurement noise, unmodeled dynamics, and adversarial disturbances. Each trajectory runs forward from the current alert state for a short horizon, with each GPU thread handling one independent trajectory to maximize parallelism. Trajectories are classified as successful if they reach the success basin defined by operational metrics like “parameters returned to normal ranges,” “anomaly resolved without escalation,” or “system restored to stable operation,” and as failed if they enter failure regions corresponding to escalation conditions, safety violations, or unrecoverable states. The rollout success rate provides an empirical estimate of mitigation effectiveness that accounts for dynamic effects, nonlinear interactions, and stochastic variability not captured by static geometric analysis. The parallel GPU implementation leverages warp-level operations for importance weight accumulation, enabling completion of hundreds of rollouts within milliseconds to meet real-time latency budgets. Rollouts incorporate adversarial bias terms when doctrinal tags indicate possible hostile causation, ensuring that success estimates account for adaptive adversaries who may modify their behavior in response to mitigation attempts.

In a step 980, query historical archive to retrieve analogous alert cases. This step leverages operational experience by identifying past alerts that resembled the current situation and examining their outcomes under similar mitigation strategies. The historical query searches the alert archive where each entry records alert state at time t, the alert object, applied policy, and success or failure outcome. The query implements kernel-weighted similarity search computing geometric proximity in the manifold and policy similarity through doctrinal tags, action profiles, and control characteristics. Cases with high combined similarity receive greater weight in outcome aggregation. The search leverages the landmark graph structure for efficient nearest-neighbor queries, avoiding linear scans through potentially millions of archived alerts. The historical estimate computes a weighted average success rate among similar historical cases, providing data-driven evidence about mitigation effectiveness grounded in actual operational outcomes rather than models or simulations. The number of retrieved similar cases provides confidence information, with larger values indicating substantial precedent and smaller values suggesting novel situations where historical evidence offers limited guidance. For unprecedented alert types or rapidly evolving operational environments, the historical component may default to neutral uninformative priors, explicitly signaling uncertainty rather than providing spuriously precise estimates based on irrelevant precedents.

In a step 990, perform Bayesian fusion to synthesize geometric, rollout, and historical estimates into posterior distribution. This step integrates the three independent probability estimates from geometric feasibility, stochastic rollouts, and historical precedent into a unified posterior distribution that quantifies both expected success probability and epistemic uncertainty. The fusion process uses the Beta-Bernoulli conjugate family enabling closed-form updates and intuitive interpretation. The posterior distribution is initialized by converting the geometric prior into pseudo-counts where a strength parameter controls how strongly the geometric prior influences final estimates. Rollout evidence updates the parameters by counting successful and failed trajectories. Historical evidence contributes through weighted updates where kernel weights and a tuning parameter control archive influence. The resulting posterior provides complete probabilistic characterization enabling computation of posterior mean representing expected success probability, posterior variance quantifying uncertainty, credible intervals bounding plausible success probabilities with specified confidence, and effective sample size indicating total evidence strength. The Bayesian approach provides principled uncertainty quantification distinguishing high-confidence predictions from uncertain estimates, enables coherent evidence integration respecting differing reliabilities of geometric, dynamic, and historical information, and supports risk-sensitive decision-making through explicit probability distributions rather than point estimates.

In a step 991, compare posterior mean against triage thresholds to determine disposition. This decision point implements the gating logic that routes alerts to one of three handling regimes based on estimated mitigation success probability. The comparison evaluates the posterior mean against two configured thresholds: one defining the minimum confidence for automatic mitigation (typically 85%), and another establishing the boundary between human escalation and immediate critical escalation (typically 50%). The thresholds are organizationally configured based on risk tolerance, consequence severity, regulatory requirements, and operator availability, with safety-critical domains setting higher thresholds to favor conservative escalation and efficiency-focused domains accepting lower thresholds to maximize automation. The three-way comparison produces distinct outcomes: if the posterior mean exceeds the auto threshold, the alert qualifies for auto-mitigation indicating high confidence that the recommended policy will succeed; if the posterior mean falls between the human and auto thresholds, the alert routes to human escalation reflecting moderate confidence requiring operator judgment; if the posterior mean falls below the human threshold, the alert triggers immediate critical escalation indicating low confidence or high risk demanding urgent expert attention. The comparison may incorporate hysteresis bands preventing oscillation for alerts near threshold boundaries, doctrinal overrides forcing specific disposition paths regardless of probabilities when tags mandate human review, and credible interval checks ensuring that uncertainty bands do not span multiple disposition regions.

In a step 992, execute auto-mitigation for high-confidence alerts. This branch handles alerts where posterior probability exceeds the auto threshold, indicating sufficient confidence for autonomous resolution without human intervention. The auto-mitigation process translates the recommended policy from mesoscale strategic description to fast-manifold control actions through an immersion operator that projects the policy back to sensor-level actuation. The immersion ensures that all physical interventions remain grounded in sensor-level evidence and respect geometric constraints, preventing overreach beyond observational support. The execution monitors outcomes in real-time, tracking whether the alert state evolves toward the success basin or unexpectedly moves toward failure regions, enabling rapid detection of execution failures and triggering fallback procedures if automated mitigation proves ineffective. Critically, the system suppresses operator notification during successful auto-mitigation, preventing alert fatigue and allowing human attention to focus on genuinely ambiguous cases requiring judgment. However, all execution details are comprehensively logged including alert state, applied policy, intermediate responses, and final outcomes, supporting subsequent analysis, quality assurance audits, and continuous learning. If post-mitigation monitoring detects recurring anomalies or delayed failures suggesting unsuccessful resolution, the system generates follow-up alerts that may route to human escalation paths.

In a step 993, escalate alert to human operator for moderate-confidence cases. This branch handles alerts where posterior probability falls between the human and auto thresholds, indicating plausible but uncertain mitigation success requiring human judgment to complement machine reasoning. The escalation process generates a structured alert card presenting comprehensive decision support including posterior mean displayed prominently, credible interval bounds visualizing uncertainty, decomposed evidence showing contributions from geometric, rollout, and historical sources, provenance traces identifying sensor origins and data quality, trajectory visualizations projecting alert evolution in M₂, counterfactual scenarios explaining consequences of different choices, and recommended policy with associated probability and sensitivity analysis. The alert card awaits explicit operator decision implementing synchronous interaction where the alert remains displayed until the operator approves the recommended mitigation, selects an alternative approach, requests additional diagnostic information, or escalates further to supervisory personnel. This human-in-the-loop process ensures moderately uncertain cases receive appropriate oversight while providing operators with sophisticated analytical support that enhances rather than replaces human judgment. The operator's decision including any modifications to recommended policy and rationale for the choice is logged alongside alert data for future analysis.

In a step 994, implement immediate critical escalation for low-confidence alerts. This branch handles alerts where posterior probability falls below the human threshold, indicating that available evidence suggests mitigation is more likely to fail than succeed or that uncertainty is too great for confident action. Critical escalation implements priority notification protocols bypassing normal alert queues and potentially triggering audible alarms, highlighted displays, or direct communication channels to ensure immediate awareness. The system routes alerts to supervisory personnel with appropriate decision authority, specialized knowledge, or resource allocation capability rather than general operators. The escalation displays full diagnostic data rather than simplified alert cards, providing complete trajectory visualizations, detailed probability decompositions, comprehensive provenance chains, and all reasoning pathways including low-probability hypotheses that might illuminate complex failure modes. For safety-critical or security-sensitive alerts, simultaneous notification of multiple individuals or teams enables parallel analysis and coordinated response.

In a step 995, execute mitigation through immersion to fast manifold controls. This step represents the convergence point where all three disposition paths ultimately apply the selected policy, whether that policy was autonomously chosen, operator-approved, or supervisor-directed.

The execution employs an immersion operator that projects the mesoscale policy defined over alert objects in M₂ back to control fields operating on sensor-level states in M₁. The immersion process translates high-level strategic directives like “isolate affected subsystem,” “reduce operational tempo,” or “increase monitoring sensitivity” into concrete sensor-aligned actions such as valve position commands, motor speed adjustments, process flow modifications, network traffic routing changes, or sensor reconfiguration sequences. The projection maintains geometric consistency ensuring that commanded actions remain within autonomy envelopes defined by available sensor evidence. The execution implements rate limiting to prevent abrupt changes that might induce additional instabilities, trajectory smoothing to ensure commanded profiles remain within actuator capabilities, and safety interlocks enforcing hard constraints from doctrinal policies.

In a step 996, monitor post-mitigation outcomes to verify successful resolution. This step implements closed-loop verification tracking whether applied mitigations achieve intended effects and whether the alert state evolves as predicted toward the success basin. The monitoring continues the latent trajectory tracking, observing whether divergence from baseline decreases toward zero, whether sensor readings return to normal ranges, whether the alert object in M₂ moves toward resolution attractors, and whether system behavior stabilizes without recurring anomalies. The monitoring establishes success criteria that may include sustained return to baseline for specified duration, absence of secondary anomalies that might indicate incomplete resolution, operator confirmation for human-escalated cases, and automated performance metrics showing restoration of operational objectives. If monitoring detects successful resolution, the alert lifecycle terminates normally with appropriate logging. However, if monitoring reveals persistent anomalies, delayed failures, secondary problems, or unexpected evolution toward failure basins, the system generates follow-up alerts that route to human escalation or critical escalation paths depending on severity.

In a step 997, archive alert data for future learning and system improvement. This step captures the complete alert lifecycle in persistent storage, recording all information necessary for sleep-state recalibration, operator training, system auditing, and continuous performance enhancement. The archived record includes alert state trajectory documenting evolution through M₂ from onset through resolution, alert object with all enrichment including doctrinal tags, provenance, and reasoning pathways, applied policy whether auto-selected, operator-approved, or supervisor-directed, mitigation outcomes indicating success or failure with associated timing and resolution path, evidence decomposition showing geometric, rollout, and historical contributions to the posterior, operator interactions capturing human decisions, rationale, and any overrides, and computational metadata recording processing times, resource utilization, and any system anomalies during alert handling. The archival process updates the landmark graph adding the alert state as a new vertex or reinforcing edges to nearby existing vertices, annotating connections with geodesic distances, curvature characteristics, and resolution pathways that future queries will leverage. The archive grows continuously throughout operation, accumulating institutional knowledge that improves prediction accuracy, enables identification of recurring patterns, supports calibration of thresholds and priors, and provides training data for refining encoders, dynamics models, and policy optimizers.

Following archival, the method evaluates whether optional federated synchronization or sleep-state recalibration are needed. In optional step 998, perform federated synchronization to exchange alert semantics across PCM instances. This step applies in distributed deployments where multiple PCM instances operate on different physical systems, geographic locations, or organizational entities but require coordinated alert management. Rather than exchanging raw sensor data which would be bandwidth-intensive and potentially sensitive, the federated protocol exchanges alert objects at the M₂ semantic level using fiber maps that transport alert structures between instances while preserving geometric relationships. Each PCM broadcasts alert summaries including posterior parameters rather than full probability distributions, doctrinal tags and provenance metadata, divergence indices quantifying semantic drift between federated interpretations, and resolution outcomes enabling distributed learning. The receiving PCM instances update their local manifold structures to incorporate federated evidence. Autonomy envelopes define acceptable divergence thresholds beyond which instances must escalate to supervisory reconciliation rather than operating independently. The federated exchange preserves privacy by transmitting only semantic summaries without reconstructible sensor data, maintains doctrinal compliance by including cryptographic signatures verifying organizational authorization, and supports verifiable explainability through provenance chains.

In optional step 999, trigger sleep-state recalibration if compression pressure or drift metrics exceed thresholds. This step detects conditions warranting offline system optimization and initiates the sleep cycle process. Trigger conditions include compression pressure spikes indicating excessive alert density suggesting over-sensitive thresholds, temporal drift when baseline attractors no longer align with recent normal operations, calibration degradation when posterior probability estimates systematically diverge from observed outcomes, operator override patterns when humans frequently reject system recommendations, and scheduled maintenance when operational tempo permits routine optimization. When triggered, the system initiates sleep-state processing that replays archived alert trajectories, computes compression pressure across M₂, recalibrates alert thresholds locally by manifold region, updates Bayesian posterior parameters using weighted historical outcomes, and consolidates recurrent alert motifs into doctrinal schemas at the slow manifold M₃ level. The sleep cycle may be scheduled during low-activity periods or triggered urgently when severe drift indicates imminent performance degradation. Federated deployments coordinate sleep cycles across instances to maintain consistency.

Upon completion of optional federated synchronization and sleep recalibration, the method reaches its terminal state indicating that the alert lifecycle is complete. The system has processed heterogeneous sensor streams through geometric latent representations, detected anomalous patterns through density-driven proto-alert formation, elevated sensor-level observations to semantic alert objects through manifold projection, predicted mitigation success through geometric, dynamic, and historical analysis fused in Bayesian inference, routed alerts to appropriate disposition paths balancing automation with human oversight, executed mitigation strategies grounded in sensor-level evidence, monitored outcomes to verify successful resolution, archived complete lifecycle data for continuous learning, and optionally synchronized with federated instances and recalibrated system parameters during sleep cycles. This end-to-end method transforms passive monitoring into proactive cognitive alerting, replacing threshold-based alarm floods with geometrically-structured, probabilistically-reasoned, and doctrine-constrained alert management.

### Exemplary Computing Environment

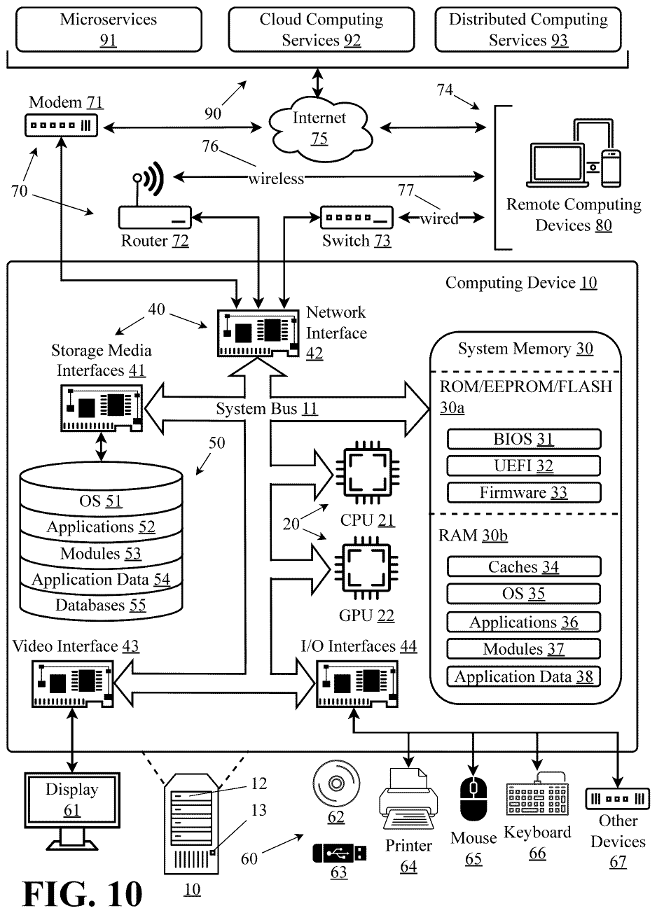

FIG. 10 illustrates an exemplary computing environment (also referred to herein as a computing system) on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 12 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions based on technologies like complex instruction set computer (CISC) or reduced instruction set computer (RISC). Further, computing device 10 may comprise one or more specialized processors such as a graphics processing unit (GPU) 22 configured to accelerate processing of computer graphics and images via a large array of specialized processing cores arranged in parallel. Further computing device 10 may be comprised of one or more specialized processes such as Intelligent Processing Units, field-programmable gate arrays or application-specific integrated circuits for specific tasks or types of tasks. The term processor may further include: neural processing units (NPUs) or neural computing units optimized for machine learning and artificial intelligence workloads using specialized architectures and data paths; tensor processing units (TPUs) designed to efficiently perform matrix multiplication and convolution operations used heavily in neural networks and deep learning applications; application-specific integrated circuits (ASICs) implementing custom logic for domain-specific tasks; application-specific instruction set processors (ASIPs) with instruction sets tailored for particular applications; field-programmable gate arrays (FPGAs) providing reconfigurable logic fabric that can be customized for specific processing tasks; processors operating on emerging computing paradigms such as quantum computing, optical computing, mechanical computing (e.g., using nanotechnology entities to transfer data), and so forth. Depending on configuration, computing device 10 may comprise one or more of any of the above types of processors in order to efficiently handle a variety of general purpose and specialized computing tasks. The specific processor configuration may be selected based on performance, power, cost, or other design constraints relevant to the intended application of computing device 10.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random-access memory (RAM), and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance.

There are several types of computer memory, each with its own characteristics and use cases. System memory 30 may be configured in one or more of the several types described herein, including high bandwidth memory (HBM) and advanced packaging technologies like chip-on-wafer-on-substrate (CoWoS). Static random access memory (SRAM) provides fast, low-latency memory used for cache memory in processors, but is more expensive and consumes more power compared to dynamic random access memory (DRAM). SRAM retains data as long as power is supplied. DRAM is the main memory in most computer systems and is slower than SRAM but cheaper and more dense. DRAM requires periodic refresh to retain data. NAND flash is a type of non-volatile memory used for storage in solid state drives (SSDs) and mobile devices and provides high density and lower cost per bit compared to DRAM with the trade-off of slower write speeds and limited write endurance. HBM is an emerging memory technology that provides high bandwidth and low power consumption which stacks multiple DRAM dies vertically, connected by through-silicon vias (TSVs). HBM offers much higher bandwidth (up to 1 TB/s) compared to traditional DRAM and may be used in high-performance graphics cards, AI accelerators, and edge computing devices. Advanced packaging and CoWoS are technologies that enable the integration of multiple chips or dies into a single package. CoWoS is a 2.5D packaging technology that interconnects multiple dies side-by-side on a silicon interposer and allows for higher bandwidth, lower latency, and reduced power consumption compared to traditional PCB-based packaging. This technology enables the integration of heterogeneous dies (e.g., CPU, GPU, HBM) in a single package and may be used in high-performance computing, AI accelerators, and edge computing devices.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10 to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. In some high-performance computing systems, multiple GPUs may be connected using NVLink bridges, which provide high-bandwidth, low-latency interconnects between GPUs. NVLink bridges enable faster data transfer between GPUs, allowing for more efficient parallel processing and improved performance in applications such as machine learning, scientific simulations, and graphics rendering. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, object oriented databases, NoSQL databases, vector databases, key-value databases, document oriented data stores, and graph databases.

Applications (also known as computer software or software applications) are sets of programming instructions designed to perform specific tasks or provide specific functionality on a computer or other computing devices. Applications are typically written in high-level programming languages such as C, C++, Scala, Erlang, GoLang, Java, Scala, Rust, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems facilitated by specifications such as containerd.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network or optical transmitters (e.g., lasers). Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers or networking functions may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices or intermediate networking equipment (e.g., for deep packet inspection).

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90.

In an implementation, the disclosed systems and methods may utilize, at least in part, containerization techniques to execute one or more processes and/or steps disclosed herein. Containerization is a lightweight and efficient virtualization technique that allows you to package and run applications and their dependencies in isolated environments called containers. One of the most popular containerization platforms is containerd, which is widely used in software development and deployment. Containerization, particularly with open-source technologies like Docker and container orchestration systems like Kubernetes, is a common approach for deploying and managing applications. Containers are created from images, which are lightweight, standalone, and executable packages that include application code, libraries, dependencies, and runtime. Images are often built from a Dockerfile or similar, which contains instructions for assembling the image. Dockerfiles are configuration files that specify how to build a Docker image. Systems like Kubernetes also support containerd or CRI-O. They include commands for installing dependencies, copying files, setting environment variables, and defining runtime configurations. Docker images are stored in repositories, which can be public or private. Docker Hub is an exemplary public registry, and organizations often set up private registries for security and version control using tools such as Hub, JFrog Artifactory and Bintray, Gitlab, Github Packages or Container registries. Containers can communicate with each other and the external world through networking. Docker provides a bridge network by default, but can be used with custom networks. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, mainframe computers, network nodes, virtual reality or augmented reality devices and wearables, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are serverless logic apps, microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP, protobuffers, gRPC or message queues such as Kafka. Microservices 91 can be combined to perform more complex or distributed processing tasks. In an embodiment, Kubernetes clusters with containerd resources is used for operational packaging of system.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over public or private networks or the Internet on a subscription or alternative licensing basis, or consumption or ad-hoc marketplace basis, or combination thereof.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power or support for highly dynamic compute, transport or storage resource variance over time requiring scaling up and down of constituent system resources. These services enable parallel processing, fault tolerance, and scalability by distributing tasks across multiple nodes.

Although described above as a physical device, computing device 10 can be a virtual computing device, in which case the functionality of the physical components herein described, such as processors 20, system memory 30, network interfaces 40, NVLink or other GPU-to-GPU high bandwidth communications links and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

The skilled person will be aware of a range of possible modifications of the various aspects described above. Accordingly, the present invention is defined by the claims and their equivalents.

What is claimed is:

1. A computing system for multimodal alert generation and triage comprising:
a processor;
a memory operatively connected to the processor;
a plurality of encoders configured to transform heterogeneous sensor streams into latent embeddings within a geometric manifold representation;
an alert detector operatively connected to the plurality of encoders and configured to generate alerts based on geometric divergence of the latent embeddings from baseline patterns within the geometric manifold representation;
a triage processor operatively connected to the alert detector and configured to:
estimate a mitigation success probability by fusing multiple independent probability estimates comprising at least a geometric estimate based on manifold structure, a simulation-based estimate, and a historical precedent estimate;
generate a posterior probability distribution representing uncertainty in the mitigation success probability; and
route alerts to different disposition pathways based on the posterior probability distribution.

2. The computing system of claim 1, wherein the heterogeneous sensor streams comprise at least two sensor modalities selected from the group consisting of: acoustic sensors, optical sensors, thermal sensors, seismic sensors, vibration sensors, and cyber sensors.

3. The computing system of claim 1, wherein each encoder is further configured to compute a quality-of-evidence score for the latent embedding based on at least one of reconstruction error, signal-to-noise ratio, and temporal consistency.

4. The computing system of claim 1, wherein the alert detector is configured to compute the geometric divergence as a geodesic distance between a trajectory of the latent embeddings and a nearest baseline attractor.

5. The computing system of claim 1, wherein the geometric estimate is computed based on policy-aligned geodesic distance, path curvature penalty, and compression cost within the geometric manifold representation.

6. The computing system of claim 1, wherein the simulation-based estimate is generated by executing stochastic rollout simulations incorporating adversarial perturbations to estimate trajectory success rates.

7. The computing system of claim 1, wherein the triage processor is configured to fuse the multiple independent probability estimates using Bayesian inference with Beta-Bernoulli conjugate updating.

8. The computing system of claim 1, wherein the different disposition pathways comprise an auto-mitigation pathway for alerts exceeding a first confidence threshold, a human escalation pathway for alerts between the first confidence threshold and a second confidence threshold, and an immediate escalation pathway for alerts below the second confidence threshold.

9. The computing system of claim 1, further comprising a submersion operator configured to project alerts from a fast manifold to a mesoscale manifold and enrich alerts with contextual tags, provenance metadata, and reasoning pathways.

10. The computing system of claim 1, further comprising an archive processor configured to record alert lifecycle data and trigger recalibration of alert thresholds when performance metrics deviate from target values.

11. A computer-implemented method for multimodal alert generation and triage comprising the steps of:
transforming, by a plurality of encoders, heterogeneous sensor streams into latent embeddings within a geometric manifold representation;
generating, by an alert detector operatively connected to the plurality of encoders, alerts based on geometric divergence of the latent embeddings from baseline patterns within the geometric manifold representation;
estimating, by a triage processor operatively connected to the alert detector, a mitigation success probability by fusing multiple independent probability estimates comprising at least a geometric estimate based on manifold structure, a simulation-based estimate, and a historical precedent estimate;
generating, by the triage processor, a posterior probability distribution representing uncertainty in the mitigation success probability; and
routing, by the triage processor, alerts to different disposition pathways based on the posterior probability distribution.

12. The computer-implemented method of claim 11, wherein the heterogeneous sensor streams comprise at least two sensor modalities selected from the group consisting of: acoustic sensors, optical sensors, thermal sensors, seismic sensors, vibration sensors, and cyber sensors.

13. The computer-implemented method of claim 11, further comprising computing, by each encoder, a quality-of-evidence score for the latent embedding based on at least one of reconstruction error, signal-to-noise ratio, and temporal consistency.

14. The computer-implemented method of claim 11, wherein generating alerts comprises computing the geometric divergence as a geodesic distance between a trajectory of the latent embeddings and a nearest baseline attractor.

15. The computer-implemented method of claim 11, wherein the geometric estimate is computed based on policy-aligned geodesic distance, path curvature penalty, and compression cost within the geometric manifold representation.

16. The computer-implemented method of claim 11, wherein the simulation-based estimate is generated by executing stochastic rollout simulations incorporating adversarial perturbations to estimate trajectory success rates.

17. The computer-implemented method of claim 11, wherein fusing the multiple independent probability estimates comprises applying Bayesian inference with Beta-Bernoulli conjugate updating.

18. The computer-implemented method of claim 11, wherein routing alerts comprises:
routing alerts to an auto-mitigation pathway when the alerts exceed a first confidence threshold;
routing alerts to a human escalation pathway when the alerts are between the first confidence threshold and a second confidence threshold; and
routing alerts to an immediate escalation pathway when the alerts are below the second confidence threshold.

19. The computer-implemented method of claim 11, further comprising projecting, by a submersion operator, alerts from a fast manifold to a mesoscale manifold and enriching alerts with contextual tags, provenance metadata, and reasoning pathways.

20. The computer-implemented method of claim 11, further comprising the steps of:
recording, by an archive processor, alert lifecycle data; and
triggering recalibration of alert thresholds when performance metrics deviate from target values.
